(19) United States
(12) Patent Application Publication
(10) Pub. No.: US 2004/0236660 A1
(43) Pub. Date: Nov. 25, 2004

(54) Multiparty transaction system

(76) Inventors: T. Randal Thomas, Brooklyn, NY (US); Zoe J. boza, New York, NY (US)

Correspondence Address: PROSKAUER ROSE LLP, PATENT DEPARTMENT, 1585 BROADWAY, NEW YORK, NY, 10036-8299, US

(21) Appl. No.: 10/364,742

(22) Filed: May 19, 2003

(51) Int. Cl. G06F 17/60

(52) U.S. Cl. 705/37; 705/36

(57) ABSTRACT

A multiparty transaction system for managing the payment of invoices where approval of multiple parties are involved. The system may permit the participation of third party beneficiaries and the management of invoices and payments by a third party intermediary among sellers, obligors, and beneficiaries. The division of invoice payment responsibility is enabled by a convenient mechanism. Various user interface elements that are particularly applicable to the complex environment of three party transactions. The system is described in detail in the context of soft dollar payments for vendor services supplied to securities brokers on behalf of the soft dollars of fund managers.

### BACKGROUND

Management of payments, receivables, vendors, creditors, and the like via centralized server-processor applications has a long history. One veteran genre is management information systems (MIS) of institutions that maintain their own databases of information. More recently, small businesses and consumers are able to have bills sent to a surrogate who will enter the bills in an Internet server and permit customers to pay their bills online. Such systems present bill information on a computer terminal connected to the Internet and accept instructions for paying them.

Software systems also exist for allowing collaboration among multiple parties. These allow workgroups to share information and documents to allow virtual workgroups to work together and make simultaneous contributions to documents and databases. Another class, called version management software, allows many editors of documents, including software source code, to make contributions to documents without interfering with each other and allowing managers to see the contributions of different parties. Threaded forum software supports online discussions between parties.

More complex software has been proposed to allow multiple parties to develop agreements online. Parties can request and share information as in collaboration-ware, make and accept offers, and otherwise establish and memorialize agreements. Much of the complexity in such systems arises in the context of filtering information so that only authorized parties can see certain information. This is a common feature of many systems that support collaboration. Another feature that adds to complexity is authentication of users and verification of the validity of data.

Prior art systems lack the ability to handle some types of transactions and also lack certain features that promote user convenience and efficiency and reduce risk as well as various other advantages in the context of financial transactions and others via software systems.

In the following description, an example of an environment where complex transactions must be managed is given. The example, the soft dollar industry, is provided only for illustration of certain interaction design issues that are addressed by the present invention. Thus, the particulars of the example are not intended to limit the scope of the invention. The following is a description of the soft dollar industry as it operates presently. In the following sections, improvements directed at this industry are described which may, as an embodiment, for portions of the inventive user interface features claimed below.

FIG. 1 illustrates an abstraction of the institutional agency soft dollar industry showing the principal parties involved: One or more Investment Managers 1 (hereafter “Manager”), one or more Agency Broker/Dealers 2 (hereafter “Broker”), one or more Vendors 3 (hereafter “Vendor”), and The U.S. Securities and Exchange Commission 4 (hereafter “SEC”). Although referred to in the singular, these entities are presumed to include one or more instances of the same class of entity, except where otherwise clear from the context. The SEC 4 provides an oversight role. The principle active participants in the industry define a triangular relationship that is referred herein as the “Soft Dollar Triangle.” Each Manager 1, Broker 2, and Vendor 3, in the industry plays a unique role and has a relationship with the other two parties in the triangle. Again, although the diagram shows one symbol for each party, it is possible that there may be multiple entities in the form of individuals or institutions corresponding to each.

Manager 1 is responsible for the portfolio performance of its clients such as large municipal, state and labor pension and health funds, college endowments, high net worth individuals, etc. In order to insure that the Managers 1 have the adequate means to investment-related information, the managers 1 are allowed to pass on their investment-related expenses to their client base by having their brokers charge higher commissions than they would otherwise. This avoids the need for managers 1 to use their own funds for these expenses. The rationale for the expense is that the improved investment returns more than compensates the funds for the commission surcharges. In terms of payment for services, the manager 1 can be said to be the beneficiary. A discretionary manager 1 requests these research services from a broker 2 in addition to transaction executions in exchange for the brokerage commissions from transactions. The broker 2 may produce this research “in house” or obtain it from third parties.

Broker 2 executes the Managers' 1 trades at a negotiated commission in order to accumulate a soft dollar balance for soft dollar-eligible investment-related expenses. In effect, each soft dollar Broker 2 maintains an individual flexible spending account for each Manager 1 client choosing to use that Broker 2 for soft dollars. Usually the investment-related services are not provided from that broker, as was the norm prior to 1975 when “full service broker/dealers” predominated. Instead, the predominant “agency broker/dealers” maintain these soft dollar flexible spending accounts to pay for third party investment-related services. In terms of payment for services, the Broker 2 can be said to be the payer. Prior to the deregulation of fixed commission rates in 1975, much of the competition for brokerage business was based on the provision of proprietary, in-house research services as well as the quality of overall execution. With the proliferation of agency brokerage today, the focus of competition is more on the quality of execution.

Vendors 3 provide a diverse range of services that the manager 1 has deemed to be investment-related and therefore eligible for soft dollar use. Because the services provided to the managers 1 are paid from the broker-maintained soft dollar accounts, it is the broker 2 and not the manager 1 that is billed for the manager services and it is the broker 2 who is contractually or verbally liable for these payments. In terms of payment for services, the vendor 3 can be said to be the payee.

To use an analogy, a medical savings flexible spending account can only be used for medical related expenses and is therefore overseen by an administrative body to insure compliance. In a similar manner, the SEC 4 oversees this industry to insure as well as it can that these soft dollar funds are used solely for investment-related expenses. Through SEC 4 audits of the manager 1, adherence to the SEC Guidelines is maintained. Additionally, managers 1 must regularly provide a report of their soft dollar usage to the SEC 4 via a “Form ADV” and broker 2 must provide a FOCUS report of their expenditures.

The soft dollar industry has evolved to over a $1 Billion industry. But its administration is expensive and inefficient. Complex administrative burdens exist at all levels in the businesses of all the entities involved. Examples of inefficiency are numerous. A broker 2 must receive varying degrees of approval from the manager 1 in order to pay an invoice even though the broker 2 is the party contractually liable for the invoice. Phone, fax and email are sometimes needed to gain this approval based on the level of control the manager 1 wants. The manager 1 often wishes to see the details of an invoice before approving it. The manager 1 must send an annual Form ADV report to the SEC 4 on its soft dollar activity. Additionally, the manager 1 needs to manage the use of soft dollar assets located across multiple broker 2. Manually-intensive information gathering is needed for both of these requirements and aggregating the activity across multiple brokers 2 complicates it. The delays caused by mail and misrouting inhere in the job of working with many paper invoices across multiple broker 2 mailrooms since the vendor 3 submits the invoice to the broker 2 for the benefit of the manager 1 using a service. To find and begin using a service, the manager 1 relies on internal organizational systems that are often unreliable and invariably ad hoc. Three-way agreements between the vendor, manager 1 and broker 2 needed to contract for service create opportunities for error and confusion as well as delay.

### SUMMARY OF THE INVENTION

Briefly, A multiparty transaction system manages the payment of invoices where approval of multiple parties are involved. The system may permit the participation of third party beneficiaries and the management of invoices and payments by a third party intermediary among sellers, obligors, and beneficiaries. The division of invoice payment responsibility is enabled by a convenient mechanism. Various user interface elements that are particularly applicable to the complex environment of three party transactions. The system is described in detail in the context of soft dollar payments for vendor services supplied to securities brokers on behalf of the soft dollars of fund managers.

According to an embodiment, the inventions include a computer program comprising program code for implementing steps of a process when the program is run a computer system, the process being one for managing payments to sellers by obligors and providing for the automated sharing and updating of data, acceptance and management of approvals, via interconnected computers and computer terminals, the steps comprising: presenting, at a user terminal, contract data, stored on a computer data store, at least partially defining a sales contract between sellers and obligors, presenting, at a user terminal, invoice data, stored on a computer data store, reflecting transactions between the sellers and the obligors, prompting for and accepting, at a user terminal configured to permit access to a first obligor, an offer command to present terms defined by a first sales contract defined in the contract data the first contract being one between a first seller and the first obligor to a second seller, prompting for and accepting, at a user terminal configured for access by the second seller, an acceptance command to accept the terms, modifying the contract data, stored on a computer data store, such that the terms correspond to a contract between the first obligor and the second seller responsively to the first and second steps of accepting and storing a result of the step of modifying on a data store.

According to another embodiment, the inventions include a computer program comprising program code for implementing steps of a process when the program is run a computer system, the process being one for managing payments to sellers by obligors and providing for the automated sharing and updating of data, acceptance and management of approvals, via interconnected computers and computer terminals, the steps comprising: inputting detail invoice data reflecting transactions between the sellers and the obligors data from sellers and storing the invoice data in a computer readable data store, presenting, at a user terminal, display invoice data responsive to the detail invoice data, presenting, at a user terminal configured to provide access to the first obligor, selected display invoice data relating to the invoices and prompting for and accepting, at a user terminal configured to permit access to the first obligor, a first command indicating approval to pay one or more of the invoices, prompting for and accepting, at a user terminal, selection commands to select payable invoices of the invoices, prompting for and accepting, at a user terminal, payment commands to pay selected ones of the invoices, prompting for and accepting, at a user terminal, challenge data effective to block payment of the selected ones of the invoices, the display invoice data including high level group data resulting from a first grouping of invoices, the high level group data further including challenge display data responsive to the challenge data.

According to yet another embodiment, the inventions include a computer program comprising program code for implementing steps of a process when the program is run a computer system, the process being one for managing payments to sellers by obligors, the steps comprising: inputting detail invoice data reflecting transactions between the sellers and the obligors data from sellers and storing the invoice data in a computer readable data store, presenting, at a user terminal, display invoice data responsive to the detail invoice data, presenting, at a user terminal configured to provide access to the first obligor, selected display invoice data relating to the invoices and prompting for and accepting, at a user terminal configured to permit access to the first obligor, a first command indicating approval to pay one or more of the invoices, prompting for and accepting, at a user terminal, selection commands to select payable invoices of the invoices, prompting for and accepting, at a user terminal, payment commands to pay selected ones of the invoices, the display invoice data including high level group data resulting from a first grouping of invoices, the high level group data further including accuracy verification data, wherein the step of presenting selected display invoice data includes generating a list including high level grouping data and lower level detail data, the lower level detail data including further invoice data including the accuracy verification data.

According to yet another embodiment, the inventions include a computer program comprising program code for implementing steps of a process when the program is run a computer system, the process being one for managing payments to sellers by obligors and providing for the automated sharing and updating of data, acceptance and management of approvals, via interconnected computers and computer terminals, where payments being at least in part for the benefit of beneficiaries, the steps comprising: inputting detail invoice data reflecting transactions between the sellers and the obligors data from sellers and storing the invoice data in a computer readable data store, presenting, at a user terminal, display invoice data responsive to the detail invoice data, presenting, at a user terminal configured to provide access to the first obligor, selected display invoice data relating to the invoices and prompting for and accepting, at a user terminal configured to permit access to the first obligor, a first command indicating approval to pay one or more of the invoices, prompting for and accepting, at a user terminal, selection commands to select payable invoices of the invoices, prompting for and accepting, at a user terminal, payment commands to pay selected ones of the invoices, storing beneficiary-obligor pairs, the detail invoice data relating to corresponding ones of the beneficiary obligor pairs, at least one of the steps of presenting and prompting for and accepting, at a user terminal, being responsive to the beneficiary-obligor pairs.

According to yet another embodiment, the inventions include a computer program comprising program code for implementing steps of a process when the program is run a computer system, the process being one for managing payments to sellers by obligors and providing for the automated sharing and updating of data, acceptance and management of approvals, via interconnected computers and computer terminals, where payments are at least partly for the benefit of certain beneficiaries, the steps comprising: presenting, at a user terminal, contract data, stored in a computer data store, at least partially defining a sales contract between the sellers and the obligors, presenting, at a user terminal, invoice data reflecting transactions between the sellers and the obligors and relating to the beneficiaries, prompting for and accepting, at a user terminal configured to permit access to a first obligor, an offer command to present terms defined by a first sales contract between a first seller and the first obligor to a second seller, prompting for and accepting, at a user terminal configured for access by the second seller, an acceptance command to accept the terms, modifying the contract data, stored in a computer data store, such that the terms correspond to a contract between the first obligor and the second seller responsively to the first and second steps of accepting.

According to yet another embodiment, the inventions include a computer program comprising program code for implementing steps of a process when the program is run a computer system, the process being one for managing payments to sellers by obligors and providing for the automated sharing and updating of data, acceptance and management of approvals, via interconnected computers and computer terminals, where payments are at least partly for the benefit of certain beneficiaries, the method being implemented on a server accessible for administration by a third party payment supervisor other than either of the sellers and obligors, the steps comprising: (a) at a terminal configured for limited access by users including the service provider, inputting detail invoice data reflecting transactions between the sellers and the obligors data from sellers and storing the invoice data in a computer readable data store, (b) at a terminal configured for limited access by users including at least one of the sellers, the obligors, and the beneficiaries, presenting, at a user terminal, display invoice data responsive to the detail invoice data, (c) at a terminal configured for limited access by users including at least one of the sellers, the obligors, and the beneficiaries, presenting, at a user terminal configured to provide access to the first obligor, selected display invoice data relating to the invoices and prompting for and accepting, at a user terminal configured to permit access to the first obligor, a first command indicating approval to pay one or more of the invoices, (d) at a terminal configured for limited access by users including at least one of the sellers, the obligors, and the beneficiaries, accepting selection commands to select payable invoices of the invoices, (e) at a terminal configured for limited access by users including at least one of the sellers, the obligors, and the beneficiaries, accepting payment commands to pay selected ones of the invoices.

According to yet another embodiment, the inventions include a computer implemented process as defined in claim 40, wherein the service provider is neither a securities broker nor a fund manager.

According to yet another embodiment, the inventions include a computer program comprising program code for implementing steps of a process when the program is run a computer system, the process being one for managing payments to sellers by obligors, where payments are at least partly for the benefit of certain beneficiaries, the method being implemented by a payment service provider, the steps comprising: (a) inputting detail invoice data reflecting transactions between the sellers and the obligors data from sellers and storing the invoice data in a computer readable data store managed by the service provider, (b) at a terminal configured for limited access by users including at least one of the sellers, the obligors, and the beneficiaries, presenting display invoice data responsive to the detail invoice data, (c) at a terminal configured for limited access by users including at least one of the sellers, the obligors, and the beneficiaries, presenting selected display invoice data relating to the invoices to a first obligor and accepting a first command indicating approval by the first obligor to pay one or more of the invoices, (d) at a terminal configured for limited access by users including at least one of the sellers, the obligors, and the beneficiaries, accepting selection commands to select payable invoices of the invoices, (e) at a terminal configured for limited access by users including at least one of the sellers, the obligors, and the beneficiaries, accepting payment commands to pay selected ones of the invoices, (f) storing beneficiary-obligor pairs, the detail invoice data relating to corresponding ones of the beneficiary obligor pairs, at least one of the steps of presenting and accepting being responsive to the beneficiary-obligor pairs.

According to yet another embodiment, the inventions include a computer program comprising program code for implementing steps of a process when the program is run a computer system, the process being one for managing payments to sellers by obligors, where payments are at least partly for the benefit of certain beneficiaries, the steps comprising: accepting detail invoice data reflecting transactions between the sellers and the obligors data from sellers and storing the invoice data in a computer readable data store, presenting, at a user terminal, display invoice data responsive to the detail invoice data, presenting, at a user terminal configured to provide access to the first obligor, selected display invoice data relating to the invoices and prompting for and accepting, at a user terminal configured to permit access to the first obligor, a first command indicating approval to pay one or more of the invoices, prompting for and accepting, at a user terminal, selection commands to select payable invoices of the invoices, prompting for and accepting, at a user terminal configured to permit access by the beneficiaries, payment commands to pay selected ones of the invoices.

According to yet another embodiment, the inventions include a computer program comprising program code for implementing steps of a process when the program is run a computer system, the process being one for managing payments to sellers by obligors, where payments are at least partly for the benefit of certain beneficiaries, the steps comprising: inputting detail invoice data reflecting transactions between the sellers and the obligors data from sellers and storing the invoice data in a computer readable data store, presenting display invoice data responsive to the detail invoice data at a terminal respective to a given one of the sellers, obligors, and beneficiaries, the display invoice data being restricted responsively to an identity of the given one, presenting selected display invoice data of the display invoice data at the terminal, prompting for and accepting, at a user terminal, selection commands to select payable invoices of the invoices, prompting for and accepting, at a user terminal, payment commands to pay selected ones of the invoices.

According to yet another embodiment, the inventions include a computer program comprising program code for implementing steps of a process when the program is run a computer system, the process being one for managing payments to sellers by obligors, where payments are at least partly for the benefit of certain beneficiaries, the steps comprising: inputting detail invoice data reflecting transactions between the sellers and the obligors data from sellers and storing the invoice data in a computer readable data store, presenting display invoice data responsive to the detail invoice data at a terminal respective to a given one of the sellers, obligors, and beneficiaries, at least some of the display invoice data being restricted responsively to an identity of the given one, presenting selected display invoice data of the display invoice data at the terminal, prompting for and accepting, at a user terminal, selection commands to select payable invoices of the invoices, prompting for and accepting, at a user terminal configured to permit access by at least one of the beneficiaries, payment commands to pay selected ones of the invoices.

According to yet another embodiment, the inventions include a computer program comprising program code for implementing steps of a process when the program is run a computer system, the process being one for managing payments to sellers by obligors, where payments are at least partly for the benefit of certain beneficiaries, the steps comprising: at a terminal configured for limited access by users including an intermediary, inputting detail invoice data reflecting transactions between the sellers and the obligors data from sellers and storing the invoice data in a computer readable data store, the data store being controlled by the intermediary, at a terminal a terminal respective to a given one of the sellers, obligors, and beneficiaries, filtering the detail invoice data to derive a set of display invoice data related to the given one, presenting selected display invoice data of the display invoice data at the terminal, prompting for and accepting, at a user terminal, selection commands to select payable invoices of the invoices, prompting for and accepting, at a user terminal configured to permit access by at least one of the beneficiaries, payment commands to pay selected ones of the invoices.

According to yet another embodiment, the inventions include a computer program comprising program code for implementing steps of a process when the program is run a computer system, the process being one for managing payments to sellers by obligors, the steps comprising: inputting detail invoice data reflecting transactions between the sellers and the obligors data from sellers and storing the invoice data in a computer readable data store, presenting, at a user terminal, display invoice data responsive to the detail invoice data, presenting, at a user terminal configured to provide access to the first obligor, selected display invoice data relating to the invoices and prompting for and accepting, at a user terminal configured to permit access to the first obligor, a first command indicating approval to pay one or more of the invoices, prompting for and accepting, at a user terminal, selection commands to select payable invoices of the invoices, prompting for and accepting, at a user terminal, payment commands to pay selected ones of the invoices, prompting for and accepting, at a user terminal, challenge data indicating data requesting a response, the second step of presenting including presenting, at a user terminal, data responsive to the challenge data.

According to yet another embodiment, the inventions include a computer program comprising program code for implementing steps of a process when the program is run a computer system, the process being one for managing payments to sellers by obligors, the steps comprising: inputting detail invoice data reflecting transactions between the sellers and the obligors data from sellers and storing the invoice data in a computer readable data store, presenting, at a user terminal, display invoice data responsive to the detail invoice data, presenting, at a user terminal configured to provide access to the first obligor, selected display invoice data relating to the invoices and prompting for and accepting, at a user terminal configured to permit access to the first obligor, a first command indicating approval to pay one or more of the invoices, prompting for and accepting, at a user terminal, selection commands to select payable invoices of the invoices, prompting for and accepting, at a user terminal, payment commands to pay selected ones of the invoices, prompting for and accepting, at a user terminal, challenge data and indicating data requesting a response, prompting for and accepting, at a user terminal, response data, prompting for and accepting, at a user terminal, commands to terminate selected requests for responses resulting from the step of accepting challenge data whereby selected challenges are closed, the second step of presenting including presenting, at a user terminal, indications of data responsive to the challenge data and a result of the step of accepting commands to terminate selected requests.

According to yet another embodiment, the inventions include a computer program comprising program code for implementing steps of a process when the program is run a computer system, the process being one for managing payments to sellers by obligors, the steps comprising: prompting for and accepting, at a user terminal, invoice data and promotional data describing the products or services of the sellers, presenting, at a user terminal, contract data, stored in a computer data store, at least partially defining a sales contract between sellers and obligors, presenting, at a user terminal, the invoice data, the invoice data reflecting transactions between the sellers and the obligors, presenting, at a user terminal, the promotional data responsively to requests by one or more of the obligors, prompting for and accepting, at a user terminal configured to permit access to a first obligor, an offer command to present terms defined by a first sales contract between a first seller and the first obligor to a second seller.

According to yet another embodiment, the inventions include a computer program comprising program code for implementing steps of a process when the program is run a computer system, the process being one for managing payments to sellers by obligors, the steps comprising: storing detail invoice data reflecting transactions between the sellers and the obligors, presenting, at a user terminal, the invoice data, presenting, at a user terminal, display invoice data responsive to the detail invoice data, presenting, at a user terminal configured to provide access to the first obligor, selected display invoice data relating to the invoices and prompting for and accepting, at a user terminal configured to permit access to the first obligor, a first command indicating approval to pay one or more of the invoices, prompting for and accepting, at a user terminal, selection commands to select payable invoices of the invoices, prompting for and accepting, at a user terminal, payment commands to pay selected ones of the invoices, the display invoice data including high level group data resulting from a first grouping of invoices by one of a seller of the sellers and an obligor of the obligors.

According to yet another embodiment, the inventions include a computer program comprising program code for implementing steps of a process when the program is run a computer system, the process being one for managing payments to sellers by obligors, the steps comprising: inputting detail invoice data reflecting transactions between the sellers and the obligors data from sellers and storing the invoice data in a computer readable data store, presenting, at a user terminal, display invoice data responsive to the detail invoice data, presenting, at a user terminal configured to provide access to the first obligor, selected display invoice data relating to the invoices and prompting for and accepting, at a user terminal configured to permit access to the first obligor, a first command indicating approval to pay one or more of the invoices, prompting for and accepting, at a user terminal, selection commands to select payable invoices of the invoices, prompting for and accepting, at a user terminal, payment commands to pay selected ones of the invoices, prompting for and accepting, at a user terminal, responsibility division commands indicating respective fractions of invoices to be eligible for payment by respective monies and storing responsibility division data resulting therefrom, the steps of presenting being responsive to the responsibility division data.

### BRIEF DESCRIPTION OF THE FIGURES

FIG. 1 illustrates an abstraction of the institutional soft dollar industry showing the principal parties involved.

FIG. 2 illustrates, in overview fashion, a mechanism for overcoming the above inefficiencies and others.

FIG. 3 illustrates an embodiment of the mechanics surrounding outsourced broker reporting to clients.

FIG. 4 illustrates a high-level modularization of the soft dollar invoice process and showing the various service levels possible from the NBSI.

FIG. 5 illustrates an embodiment of a mechanism for implementing technical features of the NBSI 5 process assuming a complete outsourcing of the invoice process.

FIG. 6 is a variant of FIG. 5 that illustrates an embodiment of a mechanism for implementing technical features of the NBSI 5 process assuming a payer using only the workflow approval process and minimal outsourcing.

FIG. 7 illustrates a soft dollar process at a typical broker and how an NBSI 5 can create meaningful efficiencies for a participating broker.

FIG. 8 illustrates the general flow of screens for a Non Broker Service Intermediary User Logon.

FIG. 9 illustrates the general flow of screens for Manager User Logon.

FIG. 10 illustrates the general flow of screens for Broker User Logon.

FIG. 11 illustrates the general flow of screens for Vendor User Logon.

FIGS. 12-15 illustrate various service environments for use with various embodiments of the invention.

FIGS. 12-15 illustrate various service environments for use with various embodiments of the invention.

FIG. 16 illustrates a process for contract and invoice processing.

FIGS. 17 and 18 illustrate screen shots for a user interface used for viewing and processing invoices.

FIG. 19 illustrates a process for handling challenges which may form a part of invoice and/or contract processing.

FIGS. 20-34 illustrate screen shots for invoice processing user interface.

FIG. 35 illustrates control flow for managing client data.

FIGS. 36-44 illustrate various screen shots for handling payment, contract, and other data.

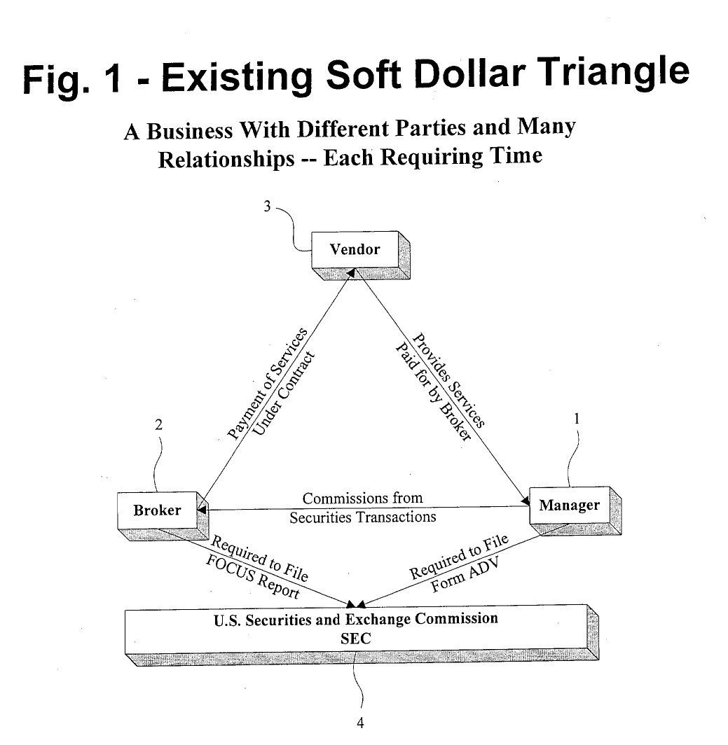

### DISCLOSURE OF INVENTION

The following example of a software system to support the soft dollar industry is provided only for illustration of certain interaction design issues that are addressed by the present invention. Thus, the particulars of the example are not intended to limit the scope of the invention. In the following sections, improvements directed at this industry are described which may, as an embodiment, for portions of the inventive user interface features claimed below.

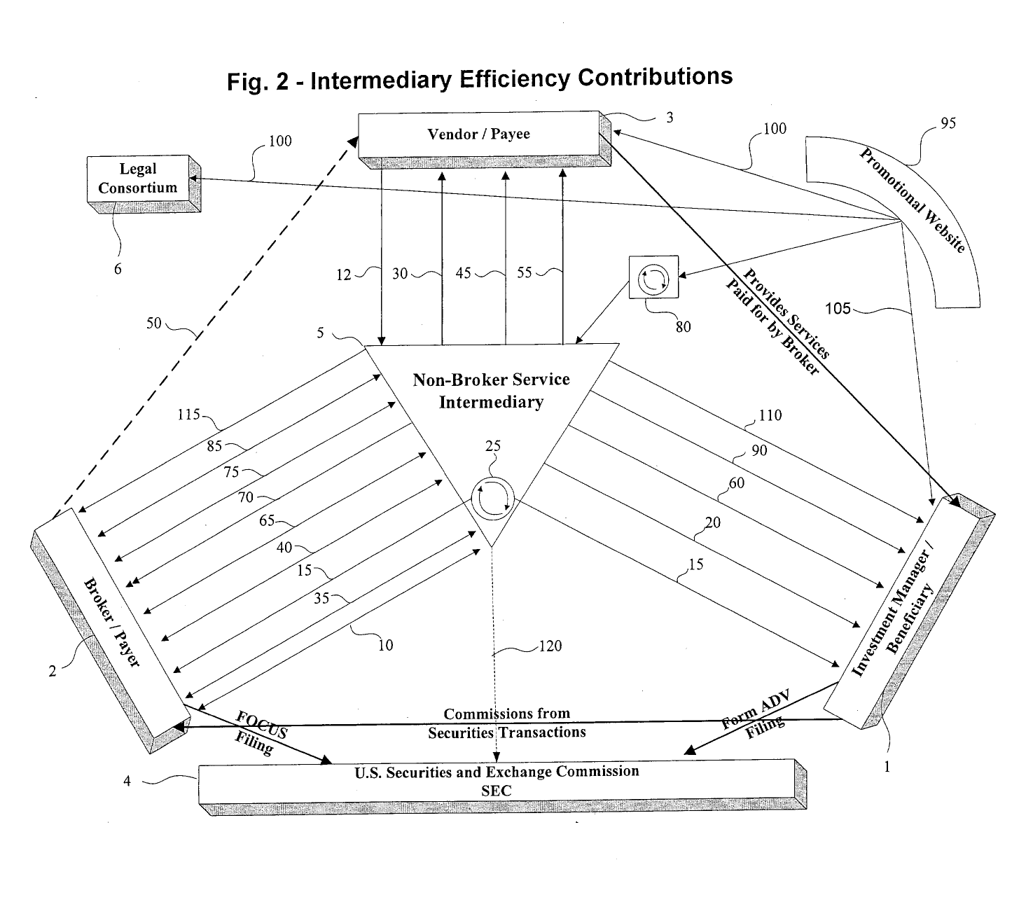

FIG. 2 illustrates a model for management of soft dollars that leverages an intermediary here identified as a Non-Broker Service Intermediary 5 (hereafter “NBSI”). Because the NBSI 5 is not a broker, it can provide for back office payment and processing by multiple parties. Broker 2 presently must employ a staff to perform data entry and administration of soft dollar invoices. Lacking any significant consolidation, economies of scale cannot be realized by broker 2. Additionally, managers 1 are presented with informational “silos” whereby all information in each silo is broker-specific. In order to view a manager's entire soft dollar activity, the manager 1 needed to consolidate this information in-house manually.

The NBSI 5 may serve as a foundation for realization of, not only economies of scale and outsourcing of broker 2 non-core competencies, but also a large range of other services that streamline the industry as will be described here below.

The NBSI 5 may provide for the data entry portion of soft dollar administration via various means to eliminate the staffing and real-estate costs associated with this department as well as reducing the information technology demands of such a department at the broker 2. For example, a broker 2 may change the billing address of its soft dollar invoices to that of an individual postal lockbox that the NBSI 5 can access. As such, the invoices may be addressed to the broker 2 as in prior art methods, but the address, city, state and zip would be for the postal lockbox. The NBSI 5 may collect the mail for this broker, bring it to the NBSI's offices where the invoice may be scanned in order to have an electronic image file, the relevant data from the invoice may be entered into the NBSI's computer system, and finally the image file may be matched with the just-entered data record. This information may then be available for viewing by the broker 2 as well as the relevant manager 1 and vendor 3.

Broker 2 may fax the invoice to the NBSI 5. While output of the faxed invoice in paper format, so as to permit the invoice to be treated in the same manner as a mailed invoice, may be possible, receiving the faxed invoice as an image file viewable directly within the NBSI's system preferably eliminates steps. The image may then be used for the input of the data record before being matched up with the data record eliminating the step for scanning.

Invoices may be submitted in an email document for example in the format of HyperText Markup Language (HTML). This serves to transmit the viewable invoice without the postage and paper costs as well as the time delay associated with mailing. This eliminates the vendor-related costs of invoice submission. Unfortunately, it does nothing for creating efficiencies at the broker 2. An HTML document is unstructured data that may need to be input at the broker 2 (or now the NBSI 5) in the same manner as a paper or faxed document. Alternatively a separate process may be used to convert the HTML document (e.g., by field parsing) to machine-readable form. Otherwise, it may be converted to the same graphical file format as faxed or scanned invoices; the process may thus be identical to the second means of faxed invoices.

Optical character recognition (OCR) can be employed with the previously-described means for reducing data entry work. OCR is not a preferred component of these processes as it may be error-prone and the technology investment required to make OCR reliable may not yield the necessary long-term savings in light of the impending technology changes from other means.

A preferred means for transmission of invoices from the vendor 3 to the broker 2 (or now the NBSI 5) is to tag the data using some sort of tagging or data file structure, for example, extensible Markup Language (XML) or a variant thereof. In this way, the invoice may be viewable in an Internet browser not unlike an HTML document but also coded to be read and input directly to a database without manual entry. XML documents also allow hierarchical data to be sent in a single document. Many soft dollar invoices are complex in nature and the data within is hierarchical. The savings to be achieved from XML adoption in this industry may be enjoyed by the vendors 3 as well as the broker 2. The NBSI 5 may enjoy a concentration of these savings. It is estimated that were the top 20 soft dollar invoice generators in the industry to adopt XML, up to 80 percent of the industry's invoices may be converted to electronic format.

Broker Specific Areas Provided as “Plug-Ins” 10

Where possible, areas within the NBSI system user interface whereby information is provided to the manager 1 that is specific to a particular broker are also available for integration within a broker's existing website domain. With integration with the security logon procedure within that broker's website, the NBSI information for that broker/manager combination can be provided as if it originates from the broker 2 itself. This maintains the individual brand identities of the brokers at the same time as maintaining the beneficial multi-broker centralization of information.

Vendor ASP Invoice Generation 12

Using electronic forms and standardized invoice templates, vendor 3 may electronically generate an invoice online and route this invoice to the appropriate broker 2. Preferably, an intelligent routing system is used. In an example of the present embodiment, the vendor 3 may be given the following options: 1) choosing the broker 2 from a listing of brokers having commitments/contracts in the system for that vendor 3, 2) choosing a manager 1 within broker 2 that also has commitments/contracts for that vendor 3, and finally 3) choosing the account number where the receivable needs to be applied. The vendor 3 may also be provided with an account number selection control to make it possible to simply select the account number directly from the NBSI system in which case the system may automatically enter the associated broker/manager combination for that account number. The automatic display of the broker/manager combination may also assist the vendor 3 in picking the correct account number to generate the invoice by confirming the correct parties. Picking from a sorted listing of account numbers can lead to a wide variety of broker/manager combinations. Therefore, the accidental pick of an account number just above or below the correct number would most probably lead to a different broker/manager combination. It is unlikely that an incorrect account number selection would yield the intended broker/manager combination. Other surrogates may be used for displaying such a selection list such as short identifiers programmed by the user, account names, owners, etc.

Once the vendor has completed generating the invoice, it may instantly enter the workflow process without the NBSI 5 intervention at all. Given that the vendor 3 has already used the commitment/contract level data in order to find the intended account number, invoice failure to reach the workflow process may be due to missing information in parent database tables as is possible with XML bills as depicted in FIG. 5 Item 101 is not possible with this methodology. If the parent tables lack the information for a particular account, the vendor may be unable to generate an invoice for that account number in this fashion until the requisite information is present.

Collaborative, Documented Invoice Approval Process Among Manager, Broker Customer Service Representative and Broker Controller 15

Arrows 15 and 30 represent invoices that are presented to the relevant broker 2, manager 1 and vendor 3 both as the entered data as well as a scanned representation (or visual representation of vendor's choosing if XML). According to the proposed process, an invoice has a workflow lifecycle that is streamlined as follows: The manager 1, as the beneficiary of the service billed, should see and approve the invoice. With or without the manager's approval, the broker 2 can pay the invoice for which the broker 2 is contractually or verbally liable.

The user at the manager 1 may be provided with permission to log into a secure conduit to the NBSI system. The user identification (and authentication confirmation), time and date of approval may be logged as part of the invoice record. The second person in the invoice lifecycle is the customer service representative at the broker 2 (Broker CSR). The Broker CSR may logon and review the invoice information and manager approval status before setting a suggested payment date within the NBSI system. The last person in the workflow is the controller at the broker 2. The controller can see all detail associated with the invoice including the suggested payment date. The controller has the ability to override the payment date as well as the amount paid. Combining the invoice information with a sortable view of the broker's checking register, the controller may have the ultimate ability to schedule invoice payments to maximize cash flow while meeting payment deadlines within the NBSI system.

Another collaborative element of this process, which is described in greater detail in connection with element 25, is the ability for the manager 1 and broker 2 to attach documented discussions to individual invoices. For recurring invoices that managers 1 feel do not need individual approval, the manager 1 can elect to set up, within the NBSI system, such an invoice may either be automatically approved by the manager 1, preferably contingent on the amount remaining unchanged, or be automatically approved regardless of the invoice amount.

Features 15 and 25 may also be made available on a broker-specific basis to be used as a “plug-in” in a broker's 2 existing website 10. This enhances a manager's 1 usage of a participating broker's 2 website. It improves the functionality of a broker's website and therefore its product offering while still allowing the outsourcing of soft dollar manual labor and insuring that the information, while displayed on disparate websites, is centralized on the intermediary's system. Optimally, this plug-in 10 would adopt the color scheme and brand logos of the broker 2 to enhance brand identity of the broker 2 client of the NBSI 5.

Displays to Managers Scanned and Data Entered Invoices from Multiple Brokers 20

Managers may be provided with the ability to see all relevant invoices from all broker 2 participating with the NBSI 5 as described in 15 via appropriate software capabilities.

Documented Discussions on Individual Invoice and Contract Records 25

As mentioned in above, each invoice and contract data record may have attached logged discussions. To provide this, a broker 2 or manager 1 may initiate a discussion on an invoice or contract. Upon logging of the first discussion message by a manager, for example, the broker 2 may see the count of active discussions increase as this discussion is added to an “action items” area in the broker logon. Additionally, each contract and invoice has a graphical icon representing the discussion in the visible data record. When there is a discussion, the icon changes to alert the user that the data record has one or more discussions associated with it. Once the discussion comes to a resolution, the initiator of the discussion can close the discussion, reducing the count of active discussions for the relevant broker 2 and manager 1. Other individuals within the broker 2 environment interested in documented discussions may include be sales and trading individuals as well as compliance personnel to track discussions and annual reviews of contracts discussing the handling of soft dollars. Invoices having unresolved discussions marked as open by the initiator organization are halted from progressing in status in the system until the initiating organization closes the discussion.

Displays to Vendor All Invoices and Their Lifecycle Status 30

Vendors 3 are able to view and search for all relevant invoices and by payment status. This allows a vendor 3 to see where a particular invoice is in the payment lifecycle. This eliminates a constant uncertainty that forces vendors 3 to repeatedly contact broker 2 to research an invoice's payment status. It reduces managers 1 having their services terminated due to mistakenly assumed non-payment.

Outsourced Payment of Checks and Wires to Vendors 35

The NBSI 5 or a banking affiliate(s) may generate the payments to the vendors 3 from individual banking accounts maintained by the broker 2. The broker 2, despite third-party execution by the NBSI 5 or banking affiliate(s), may ultimately control such payments.

Ability for Broker 2 to Schedule Future Payments to Maximize Cash Flow Planning 40

Broker 2 may have the ability to schedule its future vendor payments and arrange the dates of such payments to maximize its cash flow. The ability for a broker's controller to view the broker's 2 banking register in electronic format and sort by different criteria (e.g., scheduled pay date, input date, invoice date, payee, cleared date, etc.) may be added to facilitate this ability.

Scheduled Future Payments Allow Vendor Cash Flow Planning 45

Once the broker's controller has scheduled the payment to a vendor 3, this future payment can be used for cash flow planning by the vendor 3. This replaces the otherwise extant uncertainty with information that allows vendors 3 to manage finances with greater ease.

Outsourced Payment of Services Under Contract from Third-Party Accessible Broker Account 50

The Payment of Services Under Contract from Third-Party Accessible Broker Account 50 is a significant departure from the current conduct of business in the soft dollar triangle. The NBSI 5 performs the payments for the broker 2 as described in 35. Thus, this aspect of the triangle may be described as being outsourced.

The NBSI 5 works with the vendor 3 to insure that payment is made in vendor-preferred format (e.g., check, wire, etc.) 55.

Manager Ineligible and Mixed-Usage Invoice Capability for Complete Manager Invoice Payment 60

The NBSI 5 is capable of handling non-28 (e) (soft dollar ineligible) invoices as well as partially eligible (mixed-use) invoices. Tracking which party (broker 2 or manager 1) pays the ineligible portion is also made available. By outsourcing its entire ineligible invoices, a manager 1 may outsource its entire bill payment to the NBSI 5 reducing the paper mail to their offices substantially.

Broker Non-Soft Dollar Invoices Capability For Complete Broker Invoice Payment 65

The NBSI 5 is capable of handling non-28 (e) (soft dollar ineligible) invoices as well as partially eligible (mixed-use) invoices. Receivable tracking for funds owed by managers 1 is possible. As such, a broker 2 could outsource their entire bill payment to the NBSI 5 reducing the paper mail to their offices substantially.

Data Feed of Outsourced Activity Back to Broker's Proprietary Systems 70

The NBSI 5 will work with the participating broker 2 to feed back to the brokers' proprietary systems a complete record of the NBSI's invoice data and payment data activity. The feed will be provided in a standard, encrypted format with all proprietary adaptation of this standard done at the broker.

Outsourced Scanning and Data Entry of Contracts 75

A broker 2 could request that the NBSI 5 store a scanned image of the soft dollar contract online for record-keeping purposes. This data is commitment-level data and could be viewable along with the commitment data in the same manner that the scanned invoice is viewable along with the invoice data. The NBSI 5 may temporarily remove from the broker 2 premises the soft dollar contracts for scanning purposes—returning them upon completion. For smaller number of contracts, these contracts could be individually faxed.

Three-Way Online Contract Creation with E-Signatures 80

Managers 1 and broker 2 have the ability to electronically create soft dollar contracts within the NBSI system. This option is available from a service's page on the promotional website 95 as well as other relevant areas in the main NBSI system. Provided that the vendor 3 has provided a contract template, managers 1 and broker 2 can initiate a contract for a service, fill in the blanks for the template provided and submit it as an action item for managers 1, broker 2 and vendors 3 to provide electronic signatures in order to make it an active contract. The contract is then viewable online in the same manner as a scanned contract. The information provided by the parties completing the contract is used to complete as much as possible the commitment data as well.

“Broker ASP” Services 85

The NBSI 5 has the ability to service start-up soft dollar desks through a “Broker ASP” service. This allows broker 2 to avoid the costly capital expense of building from scratch or buying a soft-dollar reporting system. The NBSI system allows broker 2 to upload aggregate totals of their monthly-reconciled trading activity. The broker 2 is responsible for maintaining their desired payment ratio that controls a manager's soft dollar purchasing power or alternatively a manager's cents per share credit received for trading along with any necessary journal data. Given that their payment data is already present in the system, the NBSI 5 can generate customized client statements that represent each client's credit or debit balance with the broker 2. The NBSI 5 can distribute electronic copies of these statements to the broker's clients via supplied email addresses if desired in addition to hosting these statements online and in a broker plug-in 10.

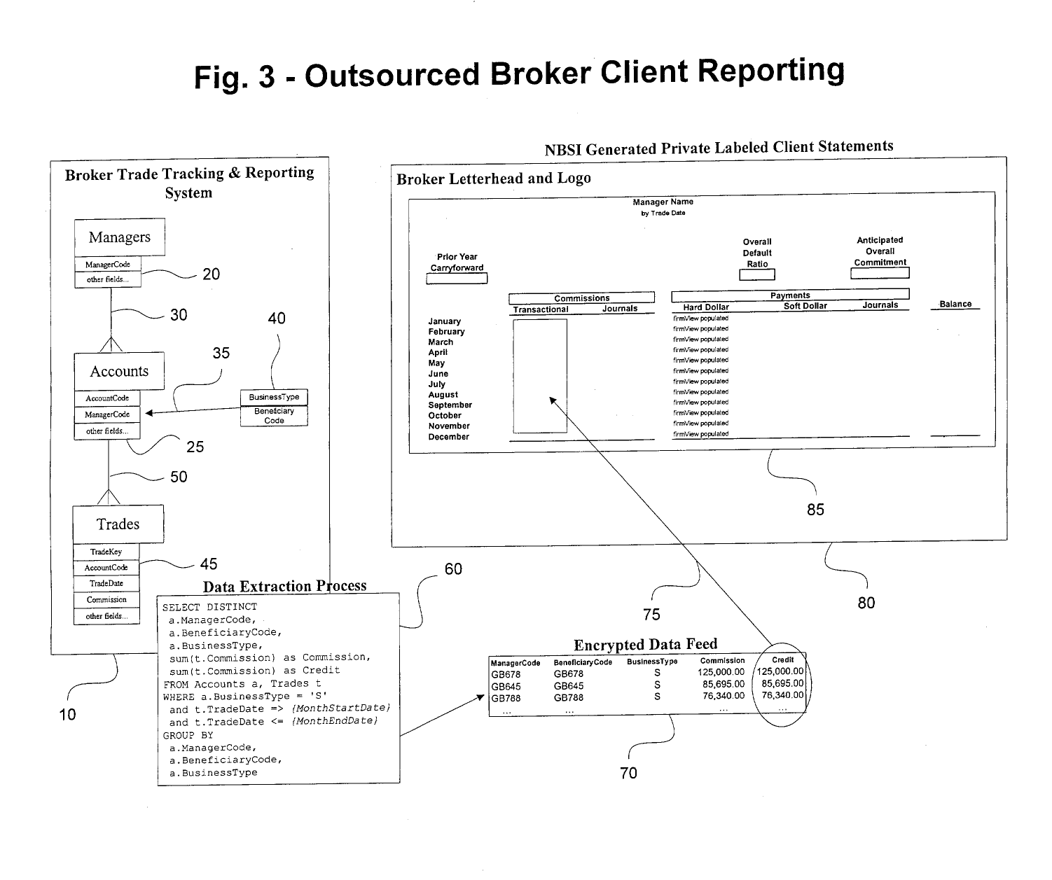

As an added benefit, broker 2 utilizing this feature allows the NBSI 5 to provide a far richer set of data for managers 1 to query and report online. This capability is discussed in greater detail in FIG. 3.

Vendor Services Classified by SEC Guideline Category and SIC Code for Improved Reporting and Product Search Capability 90

All services represented online may be categorized according to SEC 4 product categories as described in the SEC 4 “Inspection Report on the Soft Dollar Practices of Broker-Dealers, Investment Advisers and Mutual Funds” dated Sep. 22, 1998. Additionally, industry publications may be classified by US SIC codes of 2, 3 or 4-digit granularity. This enables managers 1 to view their soft dollar and non-soft dollar activity in a classified manner. Managers 1 are also able to more easily search for additional products as described in detail in 95.

Promotional Website for Vendor Services and Legal Services 95

Using the vendor and service tables, a searchable directory of vendor services is available to willing vendors 3 who wish to promote their services online. Given that all services are classified as described in 90, a manager 1 or broker 2 can search for new services in an organized fashion. Each service has a customizable page describing the service and provides a link to more information hosted by the vendor 3.

Limitations: No operational data of any kind (e.g., invoices, commitments, contracts, utilizing broker 2 or managers 1, etc.) may be available on this promotional website. The purpose is to leverage vendor service classifications to present these services to the brokerage industry on a searchable basis. Non-participating broker 2 or managers 1 that lack logon identities to the NBSI system may not be able use this searchable service listing. This insures that no part of the NBSI system—including non-operational tables—is exposed to non-secure parts of the Internet.

Given that there is a substantial effort required to insure compliance with soft dollar regulations, there is an ongoing requirement for legal opinions and services as referenced in the illustration as 6. Participating lawyers 6 with relevant specialties to the brokerage industry may also be listed in another searchable area of the promotional website 95. Again, this information is available to personnel having logons to the NBSI system.

Promotional Content and Links for Client Acquisition 100

A graphical extension to 95: The promotional website may result in a new means for clients to find vendor services and legal services.

Searchable Means of Locating New Vendors and Services 105

A graphical extension to point 95: The promotional website allows managers 1 or broker 2 searching for a particular service to have a structured means of finding these services.

Manager Data Reporting Capability for ADV Filings and Management Reports of Entire 28(e) Activity 110

All activity performed for the benefit of a manager 1 by the NBSI 5 may be available online for reporting purposes subject to stringent security guidelines to prevent unauthorized viewing. Such data can be viewed online or exported. Given that all relevant data from the broker 2 that a manager 1 uses can be available for reporting, the manual multi-broker collation presently done by managers 1 is eliminated.

Broker Data Reporting Capability for FOCUS and Management Reports Regarding Soft Dollars 115

All activity performed for a broker 2 by the NBSI 5 may be available online for reporting purposes subject to stringent security guidelines to prevent unauthorized viewing. Such data can be viewed online or exported.

Possible Eventual Outsourcing of FOCUS and Form ADV Filings 120

In the future, as the brokerage industry gains confidence in the NBSI's 5 data quality and completeness, it may become logical to offer outsourced reporting to the SEC 4 for both managers 1 and broker 2. The liabilities of such an offering need more research however it could become apparent as a logical progression.

FIG. 3: Outsourced Broker Reporting to Clients

FIG. 3 illustrates an embodiment of the mechanics surrounding outsourced broker reporting to clients. Existing broker 2 are required to supply their clients with statements that detail each client's trading activity. If the client also pays soft dollar invoices through this broker, this activity may be shown as well however this information arises from a different area within a broker's internal client activity database.

The record of trading activity is contained in an internal trade tracking and reporting system 10 at the broker. To simplify the relational structure within the database for this illustration also helps to make this simple database generic enough to apply to virtually every institutional broker 2 in existence. The idiosyncrasies of each broker's trade tracking and reporting system 10 are, with few exceptions, more complex variations of this simple database in FIG. 3.

This simple database contains 3 tables: Managers, Accounts and Trades. The fields within the Managers table 20 contain a unique “key” field identifier for each record of a Manager 1 that the Broker 2 interacts with as well as the necessary information that needs to be maintained on that Manager 1. This key field in our simple database is called “ManagerCode”. A Manager 1 trading on behalf of many clients will usually have a trading account at the Broker 2 for each of their clients for whom they execute trades at that Broker 2. The information about each of these accounts is contained in the Accounts table in multiple fields 25. The key field for each account record is “AccountCode” in our simple database. As is the basics of relational database technology, the key field of the appropriate record in the Managers table is also held in these Accounts table fields 25 to permit a database system to quickly locate all accounts belonging to a Manager 1 in this broker system. FIG. 3 Item 30 represents this join of data between these two tables. In order to implement reliable outsourced reporting, the NBSI 5 would need the presence of two fields in the Accounts table. In the rare case that these fields are not already present, the NBSI 5 would strongly suggest to the Broker 2 seeking to outsource client reporting that they be added to their system as illustrated in Item 35. These two fields “BusinessType” and “BeneficiaryCode” as represented in Item 40 allow for aggregations of not only trading activity meant to fund soft dollar payments, but also discount trading that funds no payments whatsoever as well as trading for the benefit of plans so that payments can be made to plans in an arrangement called “commission recapture”.

The trading done at a broker is performed for individual accounts. Therefore, the Trades table in our simple database holds the trading detail for each account in its fields illustrated in Item 45 in addition to the key field for the Trades table as well as the key field from the Accounts table. This allows a system to join data between the Accounts and the Trades table as represented by Item 50.

The items 10 through 50 are all prior art and serve as background for the type of system that is in common deployment throughout the industry.

In order to implement outsourced client statements, the NBSI 5 needs to work with a Broker 2 to create a custom data extraction process (Item 60) to work with the individual broker system. Via the custom data extraction process 60 the NBSI 5 is able to have sent an encrypted data feed as represented by Item 70. The data feed covers a particular time period and serves as an aggregation of trading activity for that period for each permutation of a) manager, b) beneficiary of trading credit, c) business type of trading—either discount or for credit. This feed is imported via a processing step into the NBSI system as represented as Item 75.

Once this data is contained in the NBSI system, it can be combined with the already outsourced payment activity for soft dollars. Each broker choosing to out source client statements will need to maintain the payment ratio for each of their manager clients or alternatively the cents per share trading credit their manager clients. Additionally, any balance adjustments that need to be made to a broker's client, can be effected through journal entries. The practice of combining aggregated trading data with payment activity and journal adjustments in order to maintain a balance is common practice in the industry within a single broker organization. The practice of combining trading activity from the broker with their outsourced payment activity to generate outsourced statements represents an innovation.

Statements created at the NBSI 5 for a broker 2 would have the broker letterhead and logos associated in order to protect the broker's brand identity. Item 80 represents this activity. These statements would consist of electronic file output—most probably in Adobe Acrobat format—and then subsequently emailed to the broker's clients as well as held online in the NBSI website for archival retrieval. The content of the broker statements as represented by Item 85 will be elements commonly in use in the industry. Individual customization of layout of Item 85 is not foreseen.

The statements held online for a particular broker within the NBSI will also be provided as a broker specific “plug-in” to be used in the broker's existing website. This enhances a manager's 1 usage of a participating broker's 2 website. It improves the functionality of a broker's website and therefore its product offering while still allowing the outsourcing of statement generation and insuring that the information, while displayed on disparate websites, is centralized on the intermediary's system. Optimally, this plug-in would adopt the color scheme and brand logos of the broker 2 to enhance brand identity of the broker 2 client of the NBSI 5.

Clients of this broker 2 requiring statements showing individual trading detail would need to request this type of statement directly from the broker. Typically trading detail is not requested due to its voluminous nature.

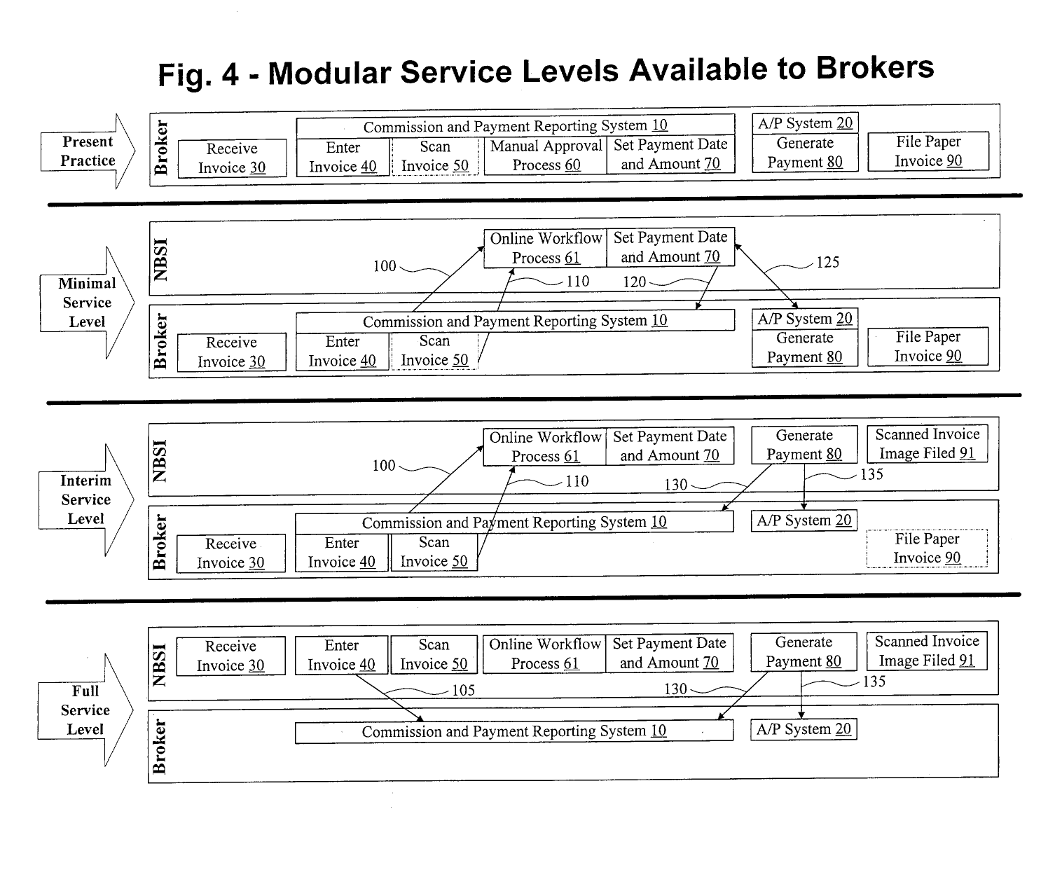

FIG. 4: Modular Tasks Allow Multiple Service Levels

FIG. 4 illustrates at a high level of functionality how the NBSI 5 can offer different levels of service to a broker 2 concerning the invoice lifecycle. Contained within FIG. 4 are three essential service levels in addition to the present soft dollar practice shown in the top frame. Items 10 and 20 are the individual systems used at a broker 2 to track and report activity. Items 30 through 91 are distinct, high-level steps in the soft dollar invoice lifecycle. Items 100 through 135 are communication steps between the NBSI system and broker systems necessary in order for the NBSI 5 to provide the various service levels.

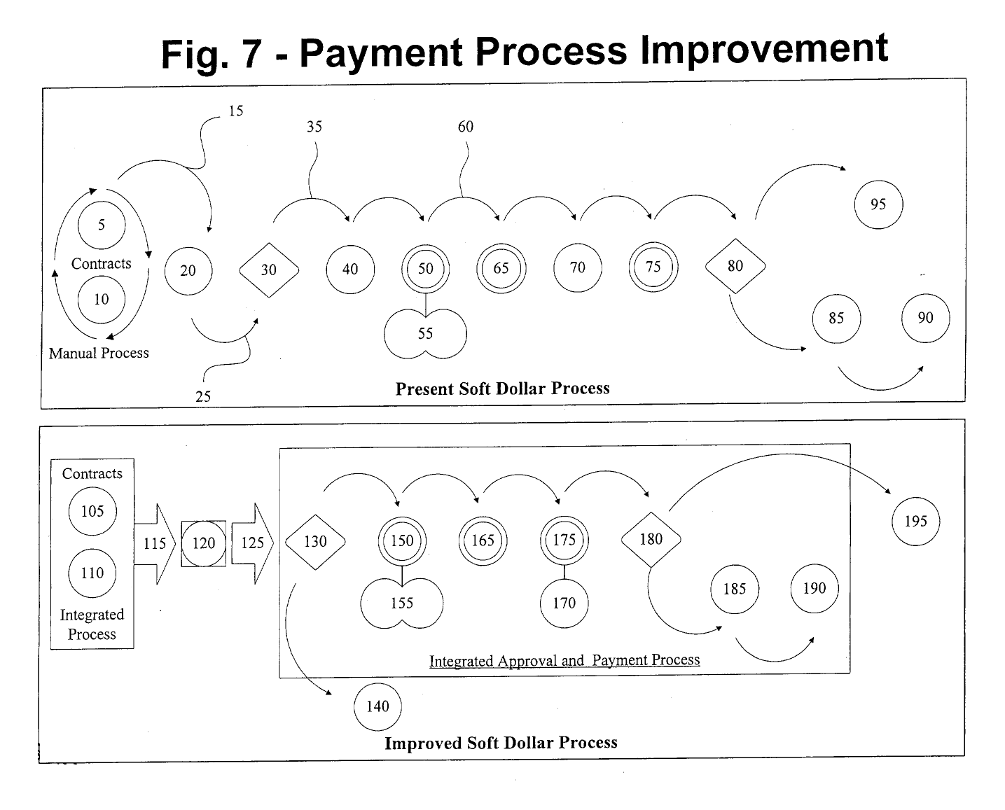

In the present practice, a broker 2 receives an invoice via mail, fax, or email 30. This invoice information must be manually entered 40 into the broker system 10 used for reporting to the broker clients. Such a reporting system 10 ranges in complexity from either a spreadsheet used at smaller brokers to elaborate database systems. With very few brokers, an additional step is employed to create a scanned representation of this paper invoice 50. This scanned invoice may be used in the invoice approval process 60. Such an approval process 60 is described in detail in FIG. 7, Items 50 through 65. Following the invoice approval 60, the invoice is scheduled for payment 70. Once payment is scheduled, this information is routed to a broker's accounts payable department whereby the payment is generated 80. In so doing, this information would be transmitted to the broker's internal accounting and bill payment system 20 unless it is reentered. Lastly, the paper invoice must be filed 90 for later reference.

FIG. 5 describes in detail the mechanism for completely removing these labor steps from the broker 2 to reside instead at the NBSI 5. In FIG. 4, the “Full Service Level” located as the bottom frame represents this mechanism. As such, when an invoice is entered into the NBSI system by whatever means 40, this information must also update the broker's reporting system 10 as shown by arrow 105. Invoice scanning 50 is part of this service. A logged online workflow process 61 replaces any manual approval process 60. Once the payment date and amount is set 70 within the NBSI system, the payment is generated 80 via a separate banking entity. This payment information would preferably be transmitted to the broker reporting system 10 as shown by arrow 130 or the broker bill payment and account system 20 as shown by arrow 135 or possibly both systems. Lastly, the careful manual filing of the paper invoice at the broker 90 is less important as a scanned representation of the invoice is stored within the NBSI system 91.

Given the modular nature of these high-level tasks, the NBSI 5 can provide a broker 2 varying levels of service. As shown in FIG. 4, the “Minimal Service Level” shown in the second frame from the top allows a broker 2 to use the online workflow process 61 whereby the broker personnel set the payment date and amount 70 within the documented environment of the NBSI system. In order to do so, a communication step to transmit the invoice information from the broker's reporting system 10 to the NBSI system as represented by arrow 100 is necessary following the entry of the invoice information 40 at the broker 2. Optionally, the broker 2 may scan the invoice 50 and transmit this information to the NBSI system as shown by arrow 110. Following the set payment date and amount, a payment instruction would be transmitted from the NBSI system either to the broker reporting system 10 as shown by arrow 120 or to the broker payment and accounting system 20 as shown by arrow 125 or to both systems. From this point, the payment is generated 80 by the broker 2. It should be noted that arrow 125 might be bi-directional. Following the payment generation 80 at the broker, it is preferable to retrieve this payment information to the NBSI system in order to be able to display and report the associated check number and check date, for example.

FIG. 5: Illustration of “Full Service Level”

FIG. 5 illustrates an embodiment of a mechanism for implementing technical features of the NBSI 5 process as a “Full Service Level” described in FIG. 4. Vendors 3 providing services to the industry first submit invoices to be paid as shown in FIG. 5 Item 10. As described earlier in FIG. 2, these invoices can come in 4 manners: a) paper/mail, b) fax, c) Unstructured text/HTML format, and d) XML/electronic format.

As shown in FIG. 5 Items 15 and 20, the invoices are sent via mail to individual postal lockboxes 25. Soft dollar invoices 15 may be sent to individual postal lockboxes Items 30 and 35 specific to each broker. Non-soft dollar-eligible (non-28 (e)) invoices 20 may be sent to individual postal lockboxes 40 specific to each broker 2 (or manager 1 if the NBSI 5 is handling a particular manager's 1 ineligible invoices).

These invoices are collected from the postal lockboxes 25 on a daily or intra-daily basis. Once in the NBSI offices 145, these invoices are setup for processing in the mailroom 45. Given that the invoices arrived to the individual broker 2 in a segregated format as described in Items 15 through 40, this segregation is maintained in the Invoice Processing and Data entry step 50. At this step, the invoices are routed to the appropriate person or persons assigned to that particular aspect of the invoice type (i.e., particular broker, soft dollar or non soft dollar). The invoice is stamped with the arrival date and the data is entered into the NBSI system front end 70 to be an invoice data record. Upon completion of this step, the paper invoice is routed to be scanned 55 to create an image file. Once the image file is available, this file needs to be coded to be associated with the data record as depicted in Item 60. Again, the NBSI system front end 70 is used to code this image file. Upon completion of that step, the paper invoice is filed 65 to be sent in bulk to the broker 2 at the end of the month unless separate arrangements are made to send the invoices directly to archival storage. Once the image file is associated with the data record, the invoice record is completed and available for viewing/workflow processing by the appropriate manager 1 and broker 2. The operational front-end client Items 75 and 80 accessible at broker 2, managers 1 and vendors 3 may be used to view this newly added invoice.

As shown in Item 85, invoices (as well as soft dollar contracts) can be sent via fax to the NBSI 5. A fax receptor 90 answers the fax lines and converts the faxed information into a graphical image in the same file format used by the scanning operations to display scanned images of invoices and contracts via Items 70, 75, and 80. This image file is displayed so that the information contained on the image can be data entered to create a data record in Item 50. Once the data record is present, the image is coded to be associated with the record in Item 60 bypassing the scanning step 55. This may complete the handling process for this type of invoice submission.

As a variant of fax invoice handling, Item 85 also illustrates HTML invoice submission. The HTML invoice may arrive at an email address. A file manipulator 90 such as Adobe Acrobat may convert the HTML document into the file format used by the scanning operations. This image file is displayed so that the information contained on the image can be data entered to create a data record in Item 50. Once the data record is present, the image is coded to be associated with the record 60 bypassing the scanning step 55. This may complete the handling process for this type of invoice submission.

As shown in Item 95, invoices can be sent via XML to the NBSI 5. These invoices may be received at an electronic mail or file transfer protocol address and routed to an XML processor 100. This processor may read the structured information contained in the XML file and process the automatic data input to the database. Additionally, the processor may read any accompanying style sheets or other information that dictate the manner of presenting a graphical representation of the invoice in a format desired by the submitting vendor 3. Once this automated processing is completed, the invoice itself is completed and ready for workflow display and processing in the manner of paper and fax invoices. Lacking human interaction, a bypass area 101 is needed to handle failed imports of XML records on an exception basis. There are multiple reasons for such failure in addition to simple corruption or malformation of the XML file. Additional reasons are usually associated with missing information/data records in parent tables of the NBSI system data model that prevent the invoice processing. Management of this bypass area 101 is a necessary step in the NBSI environment 145. The salient distinction of this manner of invoice submission is the complete elimination of all processing steps depicted by Items 25 through 65. The financial savings of widespread adoption this manner of information submission are extremely compelling not only for the NBSI 5 and non-participating broker 2 who process invoices but also for most vendors 3 who incur paper and postage costs as well as time delays of mail and processing steps.

The NBSI system front-end 70 runs on servers from the hosting environment 115 as well as an internal system of servers 105 that process most of the information manipulated within the entire NBSI system constellation. This system of multiple computer servers acts as an application and primary database server for the NBSI system front-end 70. Other tasks include information processing such as handling the XML file inputs 100, feeding back to participating broker systems 185 an electronic record of their outsourced invoice and payment activity 110. This communication with the broker environment 190 actually comprises multiple steps during the invoice lifecycle as illustrated by FIG. 4 arrows 100 through 135. As such, the broker system 185 is actually represented by a commission and payment system and an accounts payable system as discussed in FIG. 4 Items 10 and 20 respectively. Another task is to post completed invoice and image records to the hosting environment 115. Yet another function of this system is to negotiate the payment instructions with the broker 2 banking accounts for outsourced payment FIG. 2 Item 35 and FIG. 5 Items 120 through 140.

The NBSI system 105 communicates with the hosting environment 115 via a secure connection of suitable bandwidth to accommodate the necessary degree of data traffic 150. This line is terminated with the necessary devices 155 to insure high security as well as high bandwidth. A primary component of the hosting environment 115 is the primary database server 160. While this server may contain the mirrored information of the active invoice records still in the workflow process, it may also contain all previous invoice records and information for which payments have been made and no further processing is necessary—historical records for the information of the NBSI system's users. Scanned image files associated with these data records may not be located in the database server but in a disk jukebox 165 on a Write Once Read Many (WORM) basis. The application server 170 within the hosting environment 115 serves the client front-ends of Item 70, 75 and 80. In practical terms, this may be a web application server but could also be an ASP server, for example. Direct network access 175 by the NBSI environment 145 to this server(s) may be needed in order to maintain the server remotely and install software updates. As is the established norm in technology, the appropriate firewall security and communications equipment F 180 may be employed to insure the high security of the application as well as the delivery of the client front-ends 70, 75 and 80 over the network of the clients' choice (e.g., secure sockets layer (SSL), virtual private network (VPN), leased line, etc.).

Payment instructions may be sent out to a payment entity 125 that is either an accounting and banking department controlled by the NBSI 5 or to an affiliated banking institution that may outsource the payment of actual funds for the NBSI 5. To provide an operational example, a payment instruction 120 for “Broker M” is sent to the payment entity 125 where all of the payer (usually broker 2 except in the cases of ineligible payments by managers 1) banking accounts Items 130, 135, and 140 are accessible. Based on the information contained in the payment instruction, Broker M's banking account 135 may be used to generate the payment and debited that amount. The check number, check date and any other relevant information may be fed back from the payment entity 125 to the NBSI system 105 in order to generate a payment data record for display within the NBSI system front ends 70, 75, and 80.

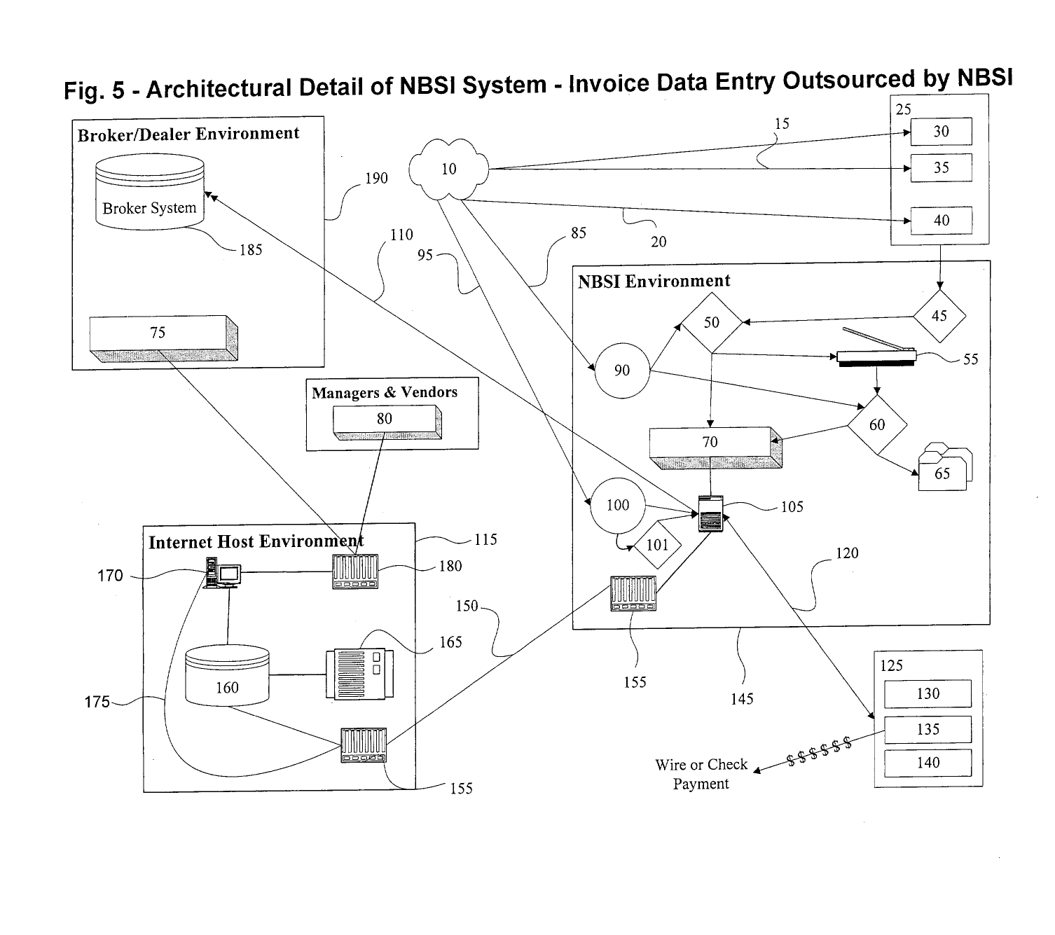

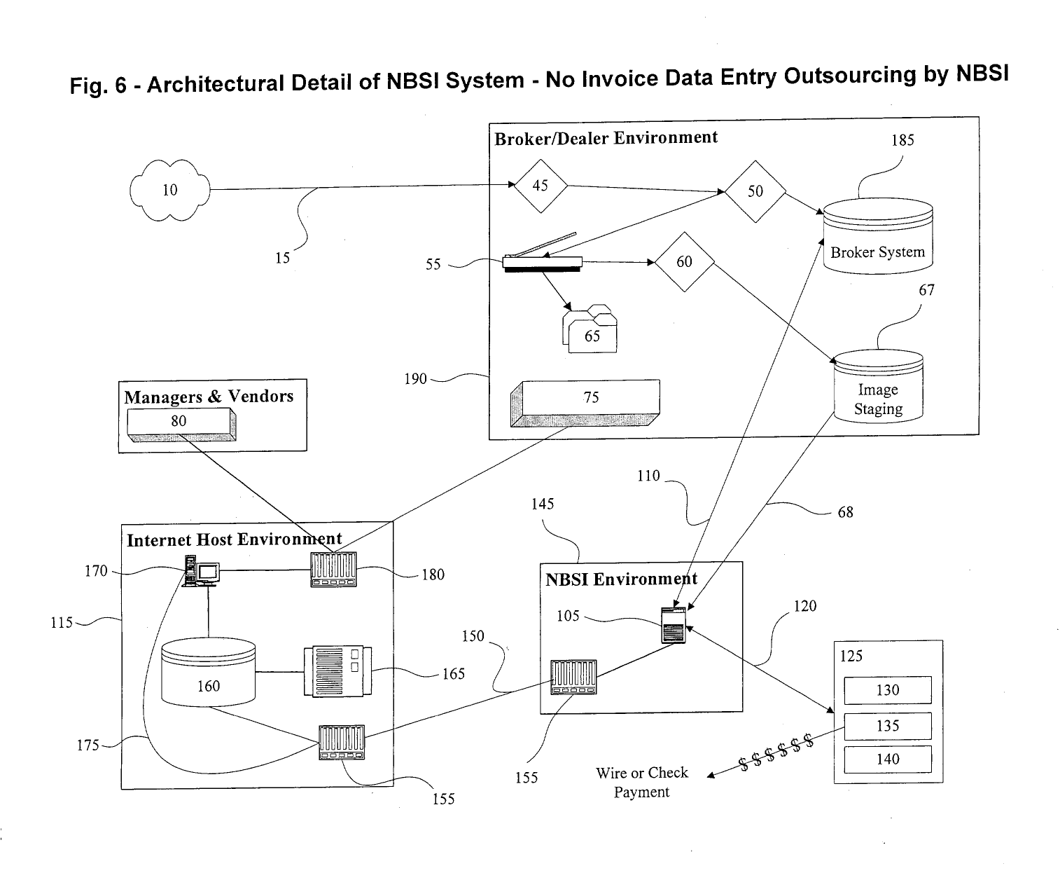

FIG. 6: Illustration of “Interim Service Level”

Using FIG. 5 as a basis, FIG. 6 illustrates the mechanism for the NBSI 5 providing a lower level of service to a broker 2 whereby the invoice handling, data entry and scanning is still retained by the broker 2. This is represented as the “Interim Service Level” in FIG. 4. This lower level of service may be preferable to a broker 2 due to cost considerations and/or to avoid operational restructuring and any perceived operational risks of the full service level. Where the same numbering exists, the same functionality exists unless mentioned otherwise. Refer to FIG. 5 for numbered items not described herein.

Arrow 15 represents sending the invoice from the vendor 3 to the broker 2. Items 45 through 65 are functionally identical to these items described in FIG. 5 except that they are performed at the broker environment 190 instead of the NBSI environment 145. The invoice archival step 65 may differ in that there is no shipping of invoices required back to the broker 2. The broker 2 may also choose to undergo more extensive filing of the paper invoice as described in FIG. 4, Item 90. The arrow 110 represents the functional descriptions of FIG. 4, arrows 100, 130, and 135. As a result, this arrow is bi-directional. In FIG. 5, arrow 110 is primarily uni-directional, as it comprises FIG. 4, arrows 105, 130 and 135.

With the scanning step 55 located at the broker 2, a means of housing the invoice image in item 67 is necessary prior to its transmission to the NBSI environment 145 as represented by arrow 68. The step of coding this image properly to the invoice record 60 resides at the broker. This step is represented in FIG. 4 as Item 50 and arrow 110.

FIG. 7: Payment Process Improvement

FIG. 7 illustrates a soft dollar process at a typical broker and how an NBSI 5 can create meaningful efficiencies for a participating broker. In the competition between brokers to get the largest order flow of executions, one of the items of competition is the number and size of soft dollar invoices from the managers. The more invoices that a broker is contracted verbally or legally to pay, the more execution orders that the manager needs to direct to that broker in order to maintain the balance of the soft dollar flexible spending account. The precursor to having the invoice directed to a broker is the soft dollar contract legally or verbally binding that broker to pay for invoices associated with that account.

Contract Setup 5

This process requires a 3-way communication between the broker, manager and vendor. This communication is presently manually done via phone, fax, mail/letter and email. Paper is often circulated between the vendor and broker for each party's signature of acceptance in order to make the contract legally binding. Often processing delays cause turnaround times for contract setup to take 2-3 months.

Inter-Broker Contract Transfer 10

The broker preferably assembles the information from the manager to create a communication to the vendor to change the billing to a different broker for a particular service. The letter from the new broker to the vendor preferably indicates the name of the service that is being provided under regulation 28(e), that it is being utilized for investment decisions, the account number if available, the terminal number if available, the contract time period, the annual dollar amount of the service, how often the service is received, the billing address, the manager name, the end user of the service and the buyout clause.

Once the phone call, e-mail, or letter from the broker to the vendor is sent with all requisite manual paperwork needed in addition to the letter, the vendor begins the process of changing the billing to the new broker usually a copy of this letter is sent to the manager for filing purposes. This is a very manual process whereby the turnaround time is approximately 2-3 months.

Often, the vendor creates an addendum to the present contract stating the new broker responsible for payment of the invoices. This allows for the account number of the transferred contract to remain unchanged.

Contract Filing 15

The paper contract is preferably held on file at the broker. It is possible that the contract can be misfiled or lost due to poor procedures. This is a management and compliance problem.

Vendor Generates Invoice 20

Vendor can create and send invoices one of three ways at present:

1) Paper invoices are preferably printed, placed in envelopes and mailed. Paper, processing and postage costs are generally incurred in addition to the costs of time delay through the postal system.

2) Some vendors send electronic invoices via e-mail. These text invoices are usually in HTML format. From the vendor perspective, it avoids the costs of paper and postal delivery however the invoices are not machine readable, leading to processing delays after reception.

3) The last means of delivery is faxed invoices. Usually this mode of delivery is for late invoices to expedite payment and a paper copy often follows for filing.

Invoice Lost During Transmission 25

There is a possibility of an invoice becoming lost before it reaches the broker. This is especially true for paper invoices that are mailed.

Invoice Received at Broker 30

1) Paper invoices are first received in the mailroom where they are routed to the soft dollar administration department. Paper invoices are then opened and stamped with the day's date to insure that if the vendor sends the invoice late, late fees are not incurred. Late fees do not qualify for soft dollar eligibility and therefore the broker is liable for late fee payments.

2) Non-machine-readable electronic invoices arrive via email. These invoices are preferably then printed out and treated as regular paper invoices from that point on.

3) Faxed invoices are printed from the fax machine and also treated as a paper invoice from this point onward.

Invoice Handling Problems Causing Delay 35

Because paper invoices arrive with all other mail for the broker, there is the possibility of misrouting this invoice to other areas in the brokerage. Other mail processing delays are possible as well. An e-mailed invoice can be delayed from continuing in the workflow process if the recipient is away from the office for any reason.

Invoice Data Added to Broker's Internal System 40

Usually the invoice information is not added to the internal broker system until manager and internal broker approval is gained. Brokers need different information to be posted onto their systems. In some cases the broker may enter it onto their system prior to the approval process. If the approval for the invoice is not met, it is deleted from the system at month end so as to not be reported to the manager as having been paid.

Manager Approval Step 50

When a manager's explicit approval is needed for an invoice, gaining this manager's approval is presently a manual process. Phone, fax or email can be used to get their approval. Usually, lacking a visual representation of the invoice, managers wish to see a faxed copy of the invoice. Often the manager's approval, once granted, can be lost when later needed for billing discussions.

Managers employ many different types of approval criteria that a broker should follow. Depending on the manager, approval may be needed: a) if the dollar amount exceeds a certain threshold, b) if it is a “one time fee” instead of a regularly occurring invoice, c) if it is a monthly bill and the dollar amount is different from prior months for that particular account number, d) for all invoices whatsoever and the broker needs to manually contact the manager on a periodic basis (i.e., daily, weekly, bi-weekly, monthly, etc.) via phone, fax or email to get approval for each invoice. Some managers request that copies of the invoices paid are included each month with the monthly statement.

Mixed Usage Ineligible Portion Payment Negotiation 55

If an invoice is partial payment due to mixed use, the manager communicates this notification to the broker via phone, letter, or e-mail.

There are two manners in which mixed usage invoices can be managed: a) the broker pays the entire amount and then creates a receivable for the ineligible portion and bills this back to the manger or b) the manager pays the ineligible portion of the invoice directly to the vendor while the broker only pays the eligible portion of the invoice. The latter type of mixed usage scenario is very difficult to manage as the vendor is receiving two checks for one invoice at different times.

There is not presently a reliable means to document which party is paying the ineligible portion. This can lead to duplicate payment or non-payment of the ineligible portion. As like all other invoices, the mixed usage approval and payment may be on a monthly, quarterly, or annual basis.

Manager 1 lack any means at present to outsource their non 28(e) eligible invoice payments in an integrated fashion with their soft dollar invoice payment.

Internal Broker Approval 65

The officer in charge of a broker's soft dollar department may require internal approvals on some or all invoices for a particular manager. These internal approvals may be based on dollar thresholds, past due amounts, the type of service used by the manager, etc. A broker's sales and compliance staff also contributes to these approval criteria as well as the accounting controller. Often this internal approval is done by the broker customer service representative having to walk around the office to seek out the necessary parties. This can easily lead to delay.

It is often the practice at brokers to enter the invoice into the internal system at this point of having obtained internal approval.

Invoice Payment Scheduled 70

The broker customer service representative schedules a desired payment date that is usually used by the accounting department. The scheduling of the payment date is often part of the broker customer service representative approval process. This payment scheduling is then subject to the internal controls of the accounting department.

Controller Approval/Accounts Payable Payment Scheduling 75

The handoff of information from a broker's soft dollar administration department to the accounting department can be delay and error prone. Accounting personnel can be absent delaying the final approval needed to have the payment generated. A difference in the dollar amount on the check versus the invoice amount due to clerical error can cause delays.

Payment Generated and Mailed 80

Including the correct invoice stub with the check is essential to enable the vendor to apply the payment correctly. Sending a check with the wrong or missing invoice stub can cause payment delays. Accounts payable may cause delays in the payment process due to: the absence of checks, changed wire information, employee turnover, vacations, external meetings or loss of the paper invoice. The payment can be lost en route to the vendor due to mailroom errors.

Invoice Filing 85

Once payment is made, the paper invoice is preferably filed for later retrieval. The broker can possibly lose the paper invoice or misfile the invoice due to procedural errors and employee turnover.

Payment Audits 90

During an audit of a manager by the SEC or a manager's internal audit, multiple invoices need to be retrieved and mailed to the manager. This manual invoice retrieval is necessary also for internal broker audits and by independent auditors. With improper invoice filing, this task is greatly complicated.

Vendor Payment Reception and Application 95

Clerical errors can be made at the vendor as well. The invoice stub can become separated from the check sent preventing the vendor from correctly applying the payment or accepting payment at all. Payment could be applied to the incorrect account.

Contract Setup Under NBSI 105

The NBSI system has a collaborative means of allowing 3-way setup of contracts through the use of prepared contract templates that the vendor has setup. As such, answering questions online completes the electronic forms. In a forms-based workflow fashion, this contract can be routed like an invoice among the involved parties for electronic signatures. This can shorten existing contract turnaround times dramatically.

Inter-Broker Contract Transfer 110

The NBSI system may have contract template forms that allow collaborative transfer of contracts from one broker to another. This allows vendors to create addendums to existing contracts as needed.

Contract Filing 115

Brokers can request the NBSI to scan into their system the existing paper-based broker contracts and associate them with the commitment level data. This may allow for an organized filing of legacy contract data.

Contracts completed via the online form templates are automatically filed in the NBSI system.

Vendor Generates and Sends Invoice 120

Vendors can create and send invoices in the three existing ways as well as two more efficient means: Existing means: 1) paper invoices, 2) non machine-readable electronic invoices, 3) faxed invoices, New means: 4) machine-readable XML-based invoices and 5) Vendor ASP directly entered invoices:

1) Paper invoices may be mailed from the vendor directly to postal lockboxes controlled and accessible by the NBSI. The NBSI is located near a postal hub eliminating postal sorting and routing delays.

2) Non-machine-readable electronic invoices may be emailed either directly from the vendor or forwarded from the broker to a broker-specific email address at the NBSI.

3) Brokers and vendors can fax invoices to the NBSI.

4) Vendors can send XML invoices to an email address at the NBSI.

5) Vendors can enter invoices directly into the system and route the invoice to the correct parties and account number.

The NBSI may work with other members in the industry to speed adoption of the latter two means of invoice generation.

Invoice Transmission 125

Transmission errors are greatly reduced or eliminated by the use of XML sent invoices as well as the intra-system generated invoices.

Invoice Received by NBSI as Outsourcer for Broker 130

An important difference in the new process is that from this point on, the labor is outsourced to the NBSI (but not the control) from the broker. The NBSI possesses advantages of economies of scale and a lower wage base.

1) Paper invoices are received in broker-specific postal lockboxes near the mail hub. All mail received to that address are invoices for a specific broker, thus there are no mailroom routing errors. Paper invoices are then opened and stamped with the day's date.

2) Non-machine-readable electronic invoices arrive in the broker specific email address either directly sent from the vendor or forwarded from the broker. The working team responsible for that broker checks the email address regularly. If originating from the broker, the same email delays are possible as described earlier. The invoice may be converted to the graphical file format used for scanned paper invoices.

3) Faxed invoices may be converted to the graphical file format used for scanned paper invoices.

4) XML invoices may arrive via a central email address. The data may be automatically loaded to the database and the visual representation of the invoice may be either represented natively in the system or be converted to the graphical file format used for scanned paper invoices.

5) Vendor entered invoices via the Vendor ASP service may be automatically loaded to the system with the attached image.

Invoice Data Entered to Broker System 140

Data Entry At NBSI: Invoice types of mail, HTML and fax require data entry by the NBSI. Mail invoices may be data entered from paper. HTML and fax invoices may be data entered from computer screens to eliminate paper. The NBSI may expend considerable effort to work with vendors to move toward XML and Vendor ASP provided invoices. Neither of these invoices requires data entry.

Data Entry At Broker: The broker has a choice to accept the NBSI invoice data onto their internal system via a data feed during different points of the workflow cycle. When the invoice is: 1) first entered into the system, 2) approved by the broker CSR, 3) scheduled for payment by the controller, 4) paid to the vendor. If the broker chooses steps prior to actual payment, provisions are preferably made to resend the invoice back to the broker after payment in order to send the check date and check number.

Manager Approval Step 150

All invoices are presented to the manager in both a sortable tabular data format, a form view of all of the invoice information as well as the graphical image of the invoice. This presents to the manager all information possibly needed on the invoice. Discussions concerning the invoice can be initiated by either broker or manager involved with the invoice. A discussion is logged and becomes a part of the invoice record changing the discussion icon to indicate that a discussion exists on a particular invoice and is viewable. The qualified user logon at the manager is allowed to approve invoices. Once done, the manager user logon as well as the date and time becomes a part of the invoice record.

System settable approvals are possible for each commitment/contract. A billing account/commitment can be set in one of three manners by the manager: 1) require manager approval on all invoices, 2) automatically approve all invoices for this account, or 3) automatically approve all invoices to this account if the amount is equal to previous invoices—otherwise manager approval is required.

Mixed-User Invoice Handling 155

A manager can not only use phone, letter or email to notify the broker about a mixed use invoice but also the discussion feature for each invoice can be used. The manager is provided a means to either enter the ineligible amount or percentage and have the NBSI system calculate the remainder amounts to be paid via soft dollars.

If a manager uses the terminal feature of the NBSI system to track individual usage points of the vendor service and certain areas or cost centers within the manager are not soft dollar-eligible, the NBSI system can automatically compute a suggested ineligible percentage of the invoice based on the number of usage points in soft dollar ineligible areas.

The NBSI system provides a means to communicate which party is to pay the ineligible portion of the invoice. When this is' decided, the system sets which party is paying the ineligible portion.

The NBSI can generate payments for participating managers for their ineligible payments in addition to the ineligible portion of mixed-use payments in the same fashion as the NBSI generates payments for brokers. This provides a means for a manager to outsource their entire invoice payment with the requisite mail handling and data entry. As with brokers, the NBSI may feed back to participating manager systems their outsourced data entry.

Internal Broker Approval 165

Based on the status of the invoice, the broker can see all their invoices in the system based on the workflow status. Invoices that have manager approval shows up as an action item requiring broker action. Given that these invoices are universally visible at all logons at this broker, all staff (e.g., sales, compliance, etc.) that needs to see the invoice in order to approve it can simultaneously view the invoice. Once the broker customer service representative is able to approve the invoice, the broker logon, and date of approval becomes a part of the invoice record. Additionally, this approval step also allows the broker CSR to schedule a suggested payment date in light of the due date.

Invoices are entered into the NBSI system at the beginning of the workflow process.

Controller Approval 175/Final Scheduled Payment Date 170

Like the existing process, the broker CSR schedules a suggested payment date that is usually used by the accounting department to make the payment.

Unlike the existing process, there is no handoff of information between the soft dollar administration department and the accounting department. The appropriate personnel in the accounting department are the final link in the workflow process. They have not only the ability to override the scheduled payment date entered by the broker CSR but also they have the reporting ability from the NBSI system to schedule payments well into the future and see the cashflow demands of each day due to payment calendaring. Accounting also has a view into their banking register and sort by multiple criteria (entry date, payee, cleared date, check date, etc.) in order to plan the most optimal cashflow in light of payment due dates.

Payment Generated and Sent 180

The NBSI, working with a banking affiliate, generates the wire or check to the vendor from the broker's banking account—payment type according to vendor preference. The designated controller at each broker sets the payment date and amount in the NBSI system. Procedures are tightly followed with economies of scale. Continuous process improvement is sought. Due to economy of scale, clout with vendors is increased. The NBSI may work with vendors to seek the most automated and efficient payment methodology.

Automated Invoice Filing 185

Invoice is automatically filed online within the system with all relevant details as well as graphical image. The paper invoices that do not become more automated are returned to the brokers each month unless separate arrangements are made for archival storage.

Payment Audits 190

This information is available online in an organized manner. Participating managers and brokers have the capability to query this data in and enhanced manner through an optional reporting module.

Vendor Payment Reception and Application 195

Vendors can see directly in the system for which account a particular payment is. Vendors can see the status of all invoices in question. Due to economy of scale, vendor communication and clout is increased to seek the most efficient payment method that eliminates errors on the vendor side as well.

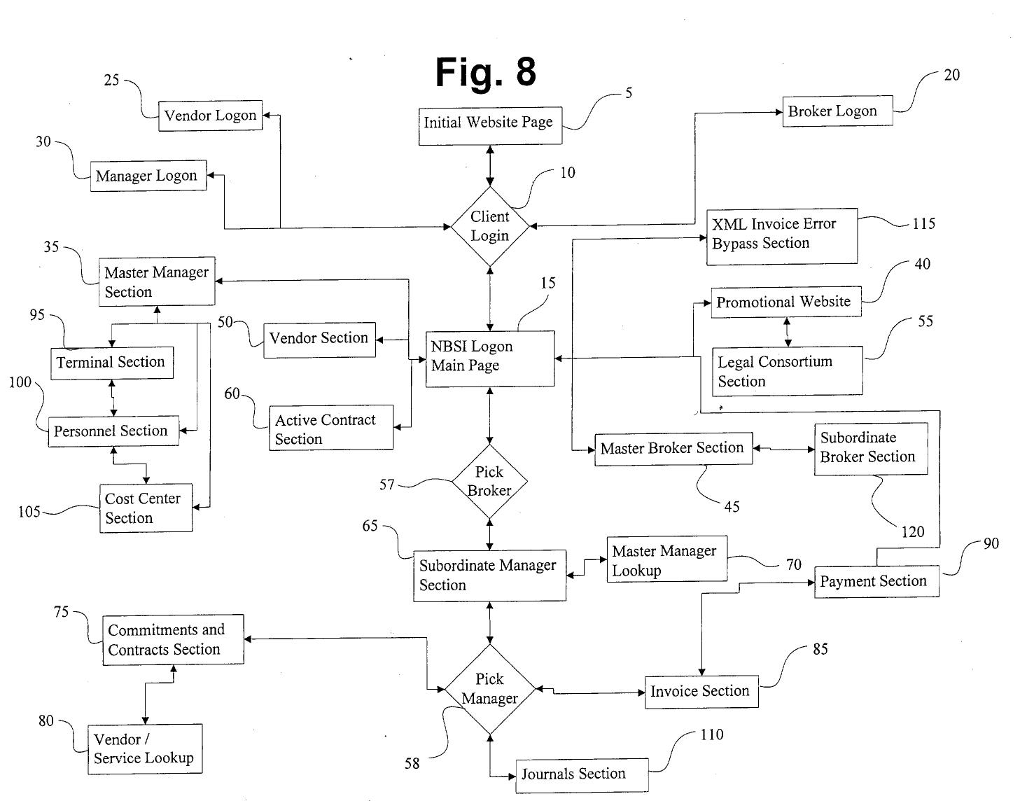

FIGS. 8-11 illustrate the general flow of screens for a user interface to support access to the NBSI 5 services. The general areas of functionality are grouped into numeric sections. The chart below notes whether that area of functionality is present within that particular user group. The detailed functions available to a section within a user logon's interface varies according to the user group as well as the particular privileges assigned to the individual user within that user group.

| | | User Group/Logon | | | |
|---|---|---|---|---|---|
| Item | Category | | Mgr | Broker | Vendor |
| 5 | Initial Website Page | X | X | X | X |
| 10 | Client Login | X | X | X | X |
| 15 | NBSI Logon | X | | | |
| 20 | Broker Logon | | | X | |
| 25 | Vendor Logon | | | | X |
| 30 | Manager Logon | | X | | |
| 35 | Master Manager Section | X | X | | |
| 40 | Promotional Website | X | X | X | X |
| 45 | Master Broker Section | X | | X | |
| 50 | Vendor Section | X | X | X | X |
| 52 | Services Section | X | | | X |
| 55 | Legal Consortium Section | X | X | X | X |
| 57 | Pick Broker | X | X | | X |
| 58 | Pick Manager | X | | X | X |
| 60 | Active Contract Section | X | X | X | X |
| 65 | Subordinate Manager Section | X | | X | |
| 70 | Master Manager Lookup | X | | X | |
| 75 | Commitments and Contracts | X | X | X | X |
| | Section | | | | |
| 80 | Vendor/Service Lookup | X | X | X | |
| 85 | Invoice Section | X | X | X | X |
| 90 | Payment Section | X | | X | |
| 95 | Terminal Section | X | X | | |
| 100 | Manager Personnel Section | X | X | | |
| 105 | Manager Cost Center Section | X | X | | |
| 110 | Journals Section | X | | X | |
| 115 | XML Invoice Bypass Section | X | | | |
| 120 | Subordinate Broker Section | X | X | | |
| 125 | Management Reporting Section | | X | X | X |
| 130 | Payment/Receivable | | | X | X |
| | Calendaring Section | | | | |

Each of the following Figs. illustrates the general flow of screens for a particular user group.

FIG. 8 NBSI User Logon

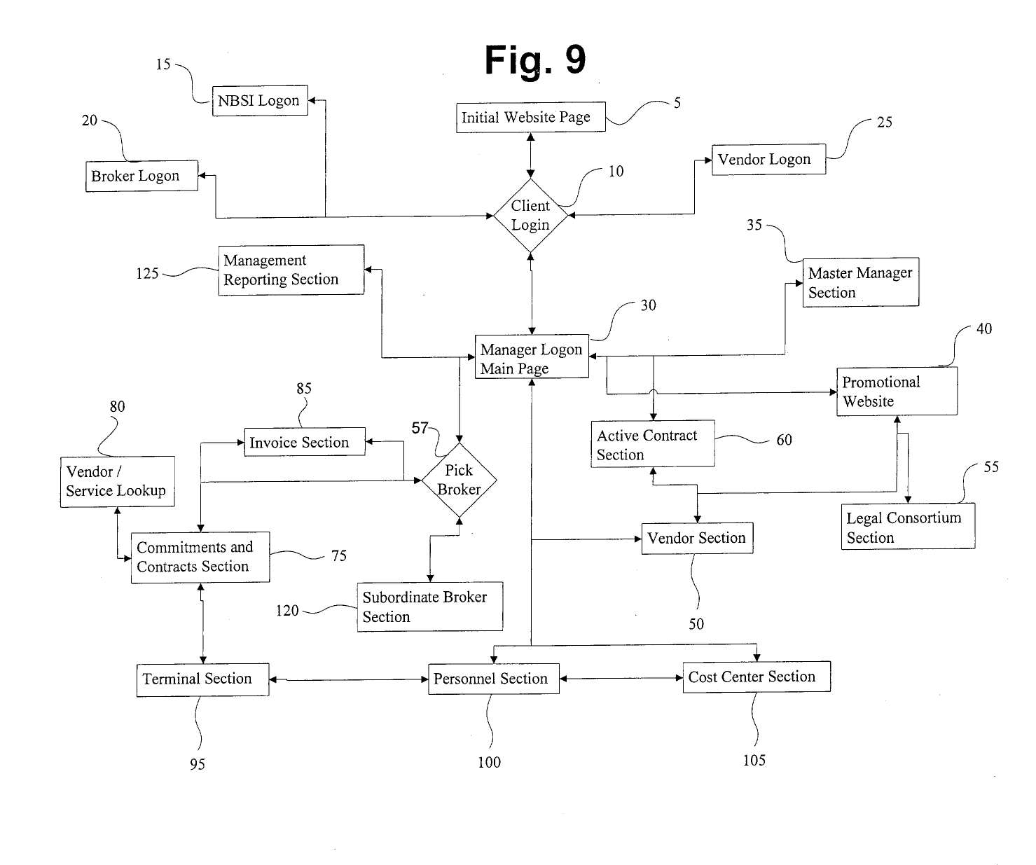

FIG. 9 Manager User Logon

FIG. 10 Broker User Logon

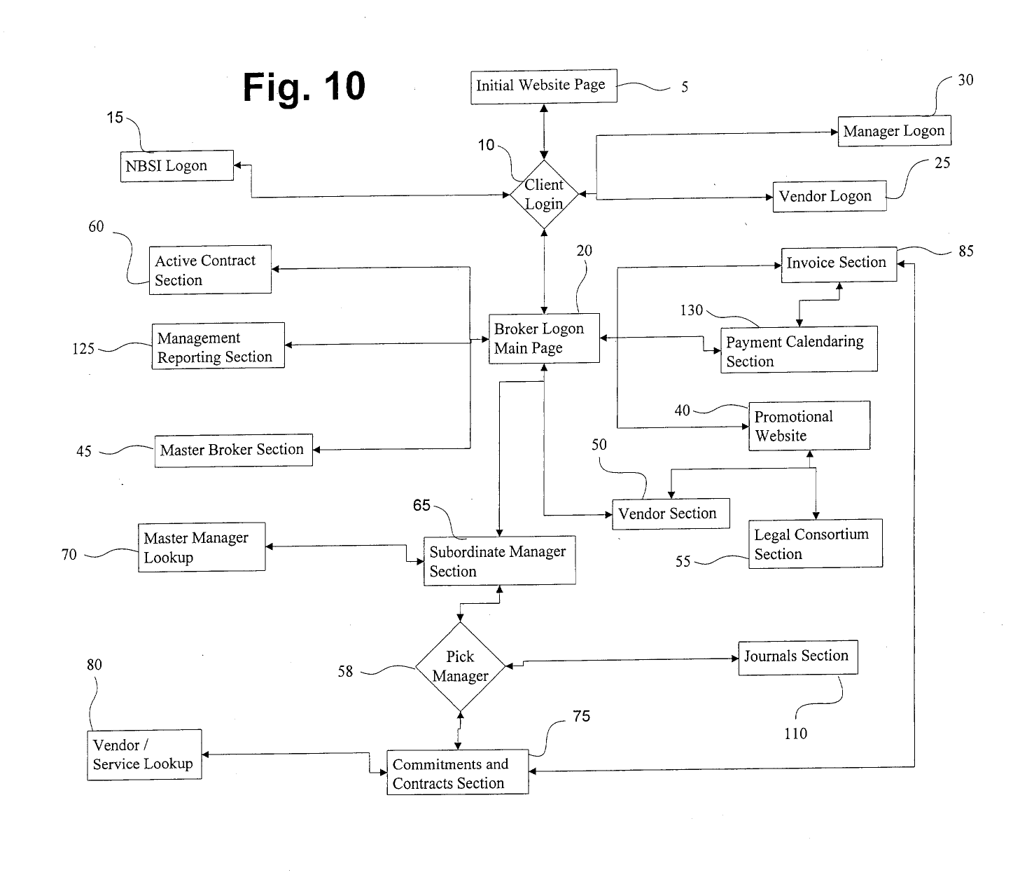

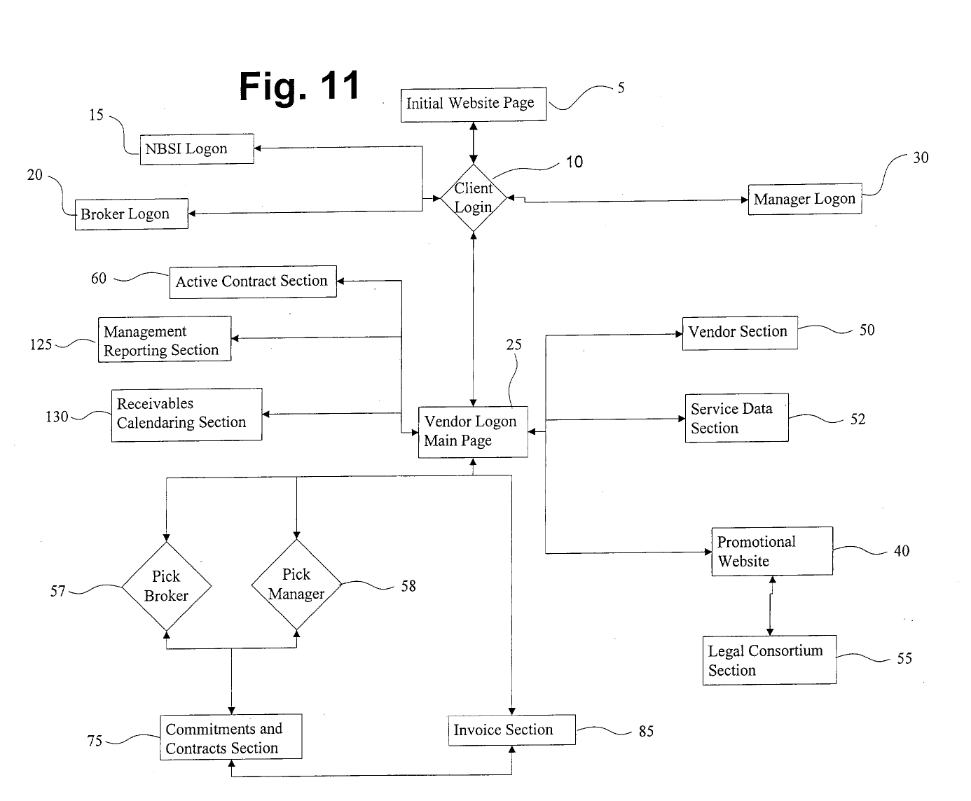

FIG. 11 Vendor User Logon

What follows is a brief description of each user logon by screen flow and the unique functionalities that is possessed by each of the sections according to that user group.

NBSI User Logon (FIG. 8)

The NBSI User Group is the logon that will likely perform the most amount of work, and contains the most functionality.

The Initial Website Page 5 is the start page for all persons accessing the site.

At the Client Logon 10, each user in the system may be required to enter their user id and password in order to access the system. According to the unique user id's categorization, the user will be automatically brought to their correct environment, user group and level of permissions.

The NBSI Logon Main Page 15 is the first page presented to the user of the NBSI user group. The goals of all initial user pages are two-fold: 1) to alert the user to workflow issues whereby an action item is newly required of the user by virtue of being in a collaborative environment, 2) feature easily navigated means to commonly used features of the system.

Two workflow issues that are unique to the NBSI logon are payments and system maintenance.

Once an invoice has completed its lifecycle and the broker controller has scheduled the payment date, the NBSI should generate a payment on that date from the broker's banking account. NBSI personnel should monitor the execution of these activities to insure quality control. One of the potential problems of this area of activity is a scheduled payment by a broker exceeding the balance within the broker's banking account. In this case, the broker preferably has been contacted to insure that adequate funds are present in the account or payment is preferably made later. It is possible that our affiliate banking partner may choose to offer to brokers and other similar payers short-term lending arrangements while funds are being transferred in order to insure timely payments. This type of workflow problem may require NBSI personnel oversight and action to insure the optimal outcome for all parties involved.

Routine system maintenance is another workflow issue specific to NBSI personnel and may be ongoing. This may include dealing with the XML invoice bypass section 115 for XML invoices that failed to properly enter the system. This may show the XML invoices in a tabular and form view with as much information as possible as to the reason the invoice failed to enter the system. Usually this would entail the NBSI completing the missing information in parent table(s) to allow the invoice to be properly classified. In a similar situation, a vendor attempting to enter and route invoices using the “Vendor ASP” invoice submission could have been unable to do so because of missing parent table records—most probably the commitment and contract was not yet setup. The vendor's request for commitment setup may be featured as an action item for the NBSI to create the needed information and alert the vendor that the action was competed.

Another system maintenance item may be maintaining the parent tables for the manager, broker and vendor. To insure the best information, this may be an ongoing task. Much of this work may be delegated to the individual client. For example, a manager and broker may be responsible for the contents of their records in the respective master table regarding address and primary contact information. Vendors may likewise control their information in the vendor table as well as the information concerning their one or multiple services. It may be the NBSI 5, with input from the vendor, who may control the classification of each service according to SEC Guideline categories as well as SIC code designations for with industry the service is related to. This vendor and service information maintenance may be done in the Vendor section 50 and its child area of services 52. Another input item from the NBSI regarding services is whether it would be listed on the promotional website 40.

One of the most important items of maintenance is the content of the broker and manager master tables. With the far fewer broker entities in the industry the broker master table maintenance 45 is less dynamic. The manager master table and the associated subordinate manager table are critical to be maintained properly. Brokers do not interact directly with manager master data but instead with manager data contained in a subordinate table. This allows brokers to have multiple instances of a single manager for reporting purposes with different name variations and different address and contact information. Nevertheless, these “child” manager records must be mapped back ultimately to the correct master manager record. This ensures that a manager can see and work with all of their activity at their brokers despite how many instances of each manager is maintained at each broker.

The user interface is responsible for enabling this mapping transparently to the user. Most of this is done via the user interface in 65 and 70 throughout the system. A broker (with the NBSI's assistance) maintains their listing of active managers as displayed in 65. When a new manager record is needed in their active listing, the broker is routed to 70 for a master manager lookup. The managers in this lookup have been verified in the system with the proper mailing and contact address. Selecting a manager from this picklist would fill the edit fields automatically with information from the master manager table. The broker is then free to change the manager name information to whatever variant is needed as well as any different contact and address information. If a particular manager is not found in the master manager picklist, the broker is able to add an “unverified” master manager record and then use that record for subsequent subordinate manager additions. As an unverified manager, that master manager is only visible to personnel at that broker.

Two types of maintenance by NBSI personnel are important on these two tables:

The first type of maintenance that may appear as an action item in the NBSI workspace is a listing by broker of all unverified managers. It is important to verify with the new manager in the NBSI system that their information is correct in the master table 35 in order to transition this manager to a verified status where it will be visible to all other brokers in the system looking to add this manager to their working listing of managers. Additionally, this manager needs to receive a logon id and password enabling them to at least approve invoices online.

The second type of maintenance is to correct mistakes whereby a subordinate manager is mapped to an incorrect master manager. This is possible due to users improperly adding subordinate managers by cloning from an incorrect master manager 70 or from a new, unverified master manager that is visible to one broker being identical to another unverified master manager at another broker. The first mistake is due to user error and the latter due to unavoidable timing delays. Correction for both may entail remapping the subordinate manager records to a correct, verified master manager. Subject to proper operational controls this remapping may be possible from the NBSI logon as the data changed is trivial. Allowing improperly mapped subordinate managers to persist in the system may present a manager invoices that are not associated with it as well as omitting these invoices from view to the correct manager.

This area of the NBSI system is vital to be correct. Additionally, this is one area within the system where data (manager master) from outside of the particular broker is shared for the sake of accuracy and standardization. Controls are also possible in this area. For brokers who either a) troll the picklist to spuriously add an abusive number of unused subordinate managers in order to obtain the manager information or who b) generate a certain level of improperly cloned subordinate managers forcing a large data cleanup job on the NBSI, these brokers can be prohibited from this area and the NBSI may completely control this broker's manager listing.

In order to correctly implement the practice of commission recapture payments, which involves making payments to the manager's clients (plans) as well as providing these plans with statements of their activity, the master/subordinate relationship just described for managers needs to be provided also for those plans that have commission recapture agreements with brokers. This involves creating a modular user interface for brokers to maintain not only their listing of managers but also their listings of plans in the fashion just described. By extension, this also entails the provision for plans to interact with the NBSI system not unlike a manager with the same capability of viewing balances and activity across multiple brokers.

An important area of the NBSI logon is the manual entry of invoices 85. In order to enter invoices, the user may be required first to choose the particular broker 57 and then the manager 58 from the broker's subordinate manager listing 65. Once the invoice is entered, the user may be required to associate the invoice with a commitment or associate the invoice with multiple commitments and enter the amount that each commitment participates to the total invoice amount. In conjunction with entering the invoice data, the user interface may allow the user to associate the graphical image of the invoice to the data record.

From the invoice area 85, the user can also create payments 90 with our banking affiliates once the broker's controller has entered the scheduled payment date. This payment area 90 is also accessible from the main logon screen 15 so that scheduled payments are presented as workflow items to be acted upon.

From the broker's subordinate manager listing 65, the user can also maintain and add commitments in the commitments and contracts area 75. It is these commitments that serve as the overarching agreement information under which invoices are sent. In order to setup commitments, a lookup 80 to vendors and their associated services is necessary.

Manager User Logon (FIG. 9)

The manager first page provides on the main logon page 30 a mixture of workflow action items as well as navigable means to other areas. The main page provides a listing of their associated brokers and a tabular count of invoices that are in various stages of progression within the workflow at each broker. By selecting the broker 57, the manager can see a tabular listing of all invoices 85 with that broker by workflow status. In that same invoice section, the manager can open a form view of an invoice to see all data entered for that invoice as well as the scanned view of the actual invoice. The invoice section allows for managers to approve invoices for payment. Additionally, this section allows for managers to initiate or respond to discussions on individual invoices.

Managers can view the contracts and commitments in the commitments and contracts section 75 associated with a particular invoice. This commitment section can also be directly accessed by choosing the broker and seeing all contracts under each broker in a sorted and tabular view. Contracts can be treated much like invoices as all commitment information can be viewed in a form view from the tabular view including a copy of the scanned invoice if one exists. If a forms-based contract template was used to generate the contract online, this contract form may be visible from the commitment form view. Discussions are possible for individual commitments in the same manner as for individual invoices.

Managers 1 can view alerts, by broker 2, of expiring contracts. For each of these contracts, the manager 1 is presented with three choices: 1) renew contract, 2) terminate contract and 3) move contract. A choice of renewal alerts the broker 2 to contact the vendor 3 to renew the contract. A choice of “terminate” alerts the broker 2 to have the vendor 3 end the service to that manager 1. A choice of move would mean that the manager 1 wishes to move the billing for that contract to a different broker 2. Following this choice, the manager 1 would be presented with a listing of the brokers in the NBSI system. Following a confirmation step, the new broker 2 is alerted to the new, incoming contract; skeletal data elements of the contract would be available to the new broker 2 to aid in setting up the new contract while preserving confidentiality for the previous broker 2. The broker 2 losing the contract would be alerted that the contract is being moved to a different broker 2 and they require no action step.

If a manager 1 chooses, they can use the NBSI system to track their activity in greater detail by adding the individual terminals or “usage points” associated with a commitment. This may be done in the terminal section 95. The personnel at the manager can be tracked 100 as well as the various cost centers that a manager uses 105. With the combination of “usage points”, manager personnel and manager cost centers, a complete picture of a manager's expenditures is possible. These accounting features can also be used to provide the background data to accurately calculate a suggested ineligible percentage of each invoice associated with a particular commitment. This not only removes the present uncertainty in present-day billings at brokers and managers but also provides a documented background for substantiating mixed-usage percentages.

Managers are allowed to maintain individual broker contact information by way of subordinate broker data section 120. While this information is less important to the system operation, it gives managers a means to hold information on the brokers that is specific to that manager.

Managers may be provided the ability to control and maintain their own information in the master manager section 35.

Managers may be the primary beneficiaries of the promotional website 40 for vendor services. It is from this website that a manager can navigate to informational areas for legal services 55 as well as vendor services 50. Managers and brokers are allowed to initiate a 3-way active contract 60 between a manager, broker and vendor. With the forms template provided by the vendor, the manager and broker can complete the contract information and use electronic signatures to complete the contract.

As a workflow item, the NBSI system can list the invoices that a manager may be required to pay the ineligible portions of. Another workflow item is invoice aging and alerts for invoices in the system for a period of time lacking approval.

Into this wealth of data, the manager has the ability to use the management reporting section 125. This may be an optional portion of the manager user logon. There may be a series of canned reports as well as the ability to customize an individual report. The information may be available for printing or download to spreadsheets.

Broker User Logon (FIG. 10)

The broker logon main page 20 has a mixture of workflow action items and commonly navigable sections. Expiring commitments are listed as alert items. Active contracts that are in a workflow process of being setup online are listed as action items.

One of the primary workflow items is entered and manager-approved invoices pending broker approval and payment scheduling. The invoices are presented in a tabular, sortable view segregated by workflow status. The full invoice details are visible from a form view including the associated commitments and the scanned image of the invoice. Individual discussions are visibly associated with invoices as well and can be initiated by the broker as well as the manager.

As described in FIG. 8, the broker as well as the NBSI personnel maintains the broker's listing of subordinate managers 65. It is from this listing of managers that the broker as well as the NBSI personnel view and maintain associated commitments and contracts 75. Similarly, the broker maintains their listing of plans with which the broker has commission recapture agreements. As with invoices, these commitment records are visible in a tabular and form view along with any scanned or forms template presentation of the contract in the form view. Also as with invoices, individual discussions are possible on these commitments.

If the broker is using the Broker ASP functionality as described elsewhere, the broker can also maintain any journal entries 110 associated with a particular manager.

There is a payment calendaring section 130 available to the broker controller whereby the future payments can be scheduled to optimize cashflow in light of payment due dates, bank account balances and future transfers to the bank account.

Against this data, the broker has the management reporting module provided standard to all brokers. The broker has available to them canned reports as well as customizable reports of their activity.

Vendor User Logon (FIG. 11)

Vendors have workflow items and navigable sections from their main page 25. Vendors have the ability to control their information in the vendor and service tables via the associated vendor 50 and service sections 52. From the service section 52, vendors are able to add additional services. These service record additions may then appear in the NBSI logon as workflow action items requiring categorization and whether the vendor wishes to list that service on the promotional website.

The primary workflow item that vendor participate in are active contracts 60 requiring vendor signatures and participation in discussions.

Vendors are able to navigate to a tabular view of all contracts in the commitments and contracts section 75; a form view of a particular commitment is available from this tabular view. The vendor can select this view either by manager 58 or broker 57.

In addition to an optional management reporting module 125 available to vendors, vendors have an optional calendaring section 130 for future scheduled payments. By viewing detailed information on their future receivables, vendors will be able to better manage their cashflow. The following table summarizes some of the differences between the NBSI system and current practice.

| | |
|---|---|
| Present Practice | NBSI Practice |

A. Contracts

| | | |
|---|---|---|
| Contract | Requires a 3-way | The NBSI system has a |
| Setup | communication between the | collaborative means of allowing |
| | broker, manager and vendor. | 3-way setup of contracts through |
| | This communication is | the use of prepared contract |
| | manually done via phone, fax, | templates that the vendor has |
| | mail/letter and email. Paper | setup. As such, answering |
| | is circulated between the | questions online completes the |
| | vendor and broker for | electronic forms. In a workflow |
| | signatures of each's | fashion, this contract can be |
| | acceptance in order to make | routed like an invoice among the |
| | the contract legally binding. | involved parties for electronic |
| | Often processing delays cause | signatures. |
| | turnaround times for contract | |
| | setup to take 2-3 months. | |
| Inter- | The broker assembles | The NBSI system will have |
| Broker | the information from the | contract template forms that |
| Contract | manager to create a | allow collaborative transfer of |
| Transfer | communication to the vendor | contracts from one broker to |
| | to change the billing to a | another. This allows vendors to |
| | different broker for a | create addendums to existing |
| | particular service. The | contracts as needed. |
| | letter from the new broker to | |
| | the vendor should state the | |
| | name of the service that is | |
| | being provided under | |
| | regulation 28(e), that it is | |
| | being utilized for investment | |
| | decisions, the account number | |
| | if available, the terminal | |
| | number if available, the | |
| | contract time period, the | |
| | annual dollar amount of the | |
| | service, how often the | |
| | service is received, the | |
| | billing address, the manager | |
| | name, the end user of the | |
| | service and the buyout | |
| | clause. | |
| | Once the phone call, | |
| | e-mail, or letter from the | |
| | broker to the vendor is sent | |
| | with all requisite manual | |
| | paperwork needed in addition | |
| | to the letter, the vendor | |
| | begins the process of | |
| | changing the billing to the | |
| | new broker usually a copy of | |
| | this letter is sent to the | |
| | manager for filing purposes. | |
| | This is a very manual process | |
| | whereby the turnaround time | |
| | is approximately 2-3 months. | |
| | Often, the vendor creates an | |
| | addendum to the present | |
| | contract stating the new | |
| | broker responsible for | |
| | payment of the invoices. | |
| | This allows for the account | |
| | number of the transferred | |
| | contract to remain unchanged. | |
| Contract | The paper contract | Brokers can request the |
| Filing | is preferably held on file at | NBSI to scan into their system |
| | the broker. It is possible | the broker contracts and |
| | that the contract can be | associate them with the |
| | misfiled or lost due to poor | commitment level data. This may |
| | procedures. This is a | allow for an organized filing of |
| | management and compliance | legacy contract data. |
| | problem. | Contracts completed via |
| | | the online form templates are |
| | | automatically filed in the NBSI |
| | | system. |
| Invoice | Vendor can create | Vendors can create and |
| Generation/ | and send invoices one of | send invoices in one of five |
| Sent | three ways at present: 1) | ways: 1) paper invoices, 2) non |
| | paper invoices, 2) non- | machine-readable electronic |
| | machine-readable electronic | invoices, 3) faxed invoices, 4) |
| | invoices, and 3) faxed | machine-readable XML-based |
| | invoices: | invoices and 5) Vendor ASP |
| | 1) Paper invoices are | directly entered invoices: |
| | preferably printed, placed | 1) Paper invoices may be |
| | in envelopes and mailed. | mailed from the vendor |
| | Paper, processing and | directly to postal lockboxes |
| | postage costs are incurred | controlled and accessible by |
| | in addition to the costs | the NBSI. The NBSI is |
| | of time delay through the | located near a postal hub |
| | postal system. | eliminating postal sorting |
| | 2) Some vendors send | and routing delays. |
| | electronic invoices via e- | 2) Non-machine-readable |
| | mail. These text invoices | electronic invoices may be |
| | are usually in HTML | emailed either directly from |
| | format. From the vendor | the vendor or forwarded from |
| | perspective, it avoids the | the broker to a broker- |
| | costs of paper and postal | specific email address at the |
| | delivery however the | NBSI. |
| | invoices are not machine | 3) Brokers and vendors can |
| | readable, leading to | fax invoices to the NBSI. |
| | processing delays after | 4) Vendors can send XML |
| | reception. | invoices to and email address |
| | 3) The last means of | at the NBSI. |
| | delivery is faxed | 5) Vendors can enter invoices |
| | invoices. Usually this | directly into the system and |
| | mode of delivery is for | route the invoice to the |
| | late invoices to expedite | correct parties and account |
| | payment and a paper copy | number. |
| | often follows for filing. | |

B. Invoice Data Entry

| | | |
|---|---|---|
| Invoice | Invoices are | Labor is outsourced to |
| Received | received in the following | NBSI from broker. Invoices may |
| | manners: | be received in the following |
| | 1) Paper invoices are first | manners: |
| | received in the mailroom | 1) Paper invoices are received |
| | where they are routed to | in broker-specific postal |
| | the soft dollar | lockboxes near the mail hub. |
| | administration department. | All mail received to that |
| | Because invoices arrive | address are invoices for a |
| | with all other mail for | specific broker, thus there |
| | the broker, there is the | are no mailroom routing |
| | possibility of misrouting | errors. Paper invoices are |
| | the invoice to other areas | then opened and stamped with |
| | in the brokerage. Other | the day's date. |
| | mail processing delays are | 2) Non-machine-readable |
| | possible as well. Paper | electronic invoices arrive in |
| | invoices are then opened | the broker specific email |
| | and stamped with the day's | address either directly sent |
| | date to insure that if the | from the vendor or forwarded |
| | vendor sends the invoice | from the broker. The working |
| | late, late fees are not | team responsible for that |
| | incurred. Late fees do | broker checks the email |
| | not qualify for soft | address regularly. If |
| | dollar eligibility and | originating from the broker, |
| | therefore the broker is | the same email delays are |
| | liable for late fee | possible as described |
| | payments. | earlier. The invoice may be |
| | 2) Non-machine-readable | converted to the graphical |
| | electronic invoices arrive | file format used for scanned |
| | via email. These invoices | paper invoices. |
| | are then be printed out | 3) Faxed invoices may be |
| | and treated as regular | converted to the graphical |
| | paper invoices from that | file format used for scanned |
| | point on. If the | paper invoices. |
| | recipient is away from the | 4) XML invoices arrive via a |
| | office for any reason, | central email address. The |
| | this e-mailed invoice can | data is automatically loaded |
| | be delayed from continuing | to the database and the |
| | in the workflow process at | visual representation of the |
| | this point. | invoice is either represented |
| | 3) Faxed invoices are | natively in the system or |
| | printed from the fax | converted to the graphical |
| | machine and also treated | file format used for scanned |
| | as a paper invoice from | paper invoices. |
| | this point onward. | 5) Vendor entered invoices via |
| | | the Vendor ASP service is |
| | | automatically loaded to the |
| | | system with the attached |
| | | image. |
| Invoice | Not commonly done at | Arriving invoices have |
| Graphically | present except when faxed | an image file of the vendor- |
| Scanned | back to manager for approval. | intended representation of the |
| | Whatever scanning presently | invoice. Paper invoices may be |
| | done on a routine basis is | scanned in the scanning |
| | specific to a particular | operations in order to obtain |
| | broker. | this graphic file. HTML and fax |
| | | invoices may be converted by the |
| | | system to graphic files without |
| | | scanning. XML and Vendor ASP |
| | | obtained invoices may also be |
| | | converted if needed. |
| Invoice | Once the approval of | Labor is outsourced to |
| Data Added | this bill is received both by | NBSI from broker. |
| to System | the manager and the customer | Invoice types of mail, |
| | service representative at the | HTML and fax require data entry. |
| | broker, it is manually | Mail invoices may be data |
| | entered into the internal | entered from paper. HTML and |
| | broker's reporting system. | fax invoices may be data entered |
| | Brokers need different | from computer screens to |
| | information to be posted onto | eliminate paper. The NBSI may |
| | their systems. In some cases | expend considerable effort to |
| | the broker then enters it | work with vendors to move toward |
| | onto their system prior to | XML and Vendor ASP provided |
| | the approval process. If the | invoices. Neither of these |
| | approval for the invoice is | invoices requires data entry. |
| | not met, it is deleted from | The broker has a choice |
| | the system at month end so as | to accept the NBSI invoice data |
| | to not be reported to the | onto their internal system via a |
| | manager as having been paid. | data feed during different |
| | | points of the workflow cycle. |
| | | When the invoice is: 1) first |
| | | entered into the system, 2) |
| | | approved by the broker CSR, 3) |
| | | scheduled for payment by the |
| | | controller, 4) paid to the |
| | | vendor. If the broker chooses |
| | | steps prior to actual payment, |
| | | provisions must be made to |
| | | resend the invoice back to the |
| | | broker after payment in order to |
| | | send the check date and check |
| | | number. |
| Broker ASP/Client | No ability at | The NBSI has the |
| Reporting | present in industry. All | ability to service start-up soft |
| Outsourcing | brokers must build or buy | dollar desks through a “Broker |
| | internal client reporting | ASP” service. This allows |
| | systems. | brokers to avoid the costly |
| | | capital expense of building from |
| | | scratch or buying a soft-dollar |
| | | reporting system. The NBSI |
| | | system allows brokers to upload |
| | | an aggregate summary of their |
| | | monthly-reconciled trading |
| | | activity. The broker is |
| | | responsible for maintaining |
| | | their desired payment ratio that |
| | | controls a manager's soft dollar |
| | | purchasing power along with any |
| | | necessary journal data. Given |
| | | that their payment data is |
| | | already present in the system |
| | | due to payment outsourcing, the |
| | | NBSI can generate customized |
| | | client statements that represent |
| | | each client's credit or debit |
| | | balance with the broker. The |
| | | NBSI can distribute electronic |
| | | copies of these statements to |
| | | the broker's clients via |
| | | supplied email addresses if |
| | | desired. |
| | | As an added benefit, |
| | | brokers utilizing this feature |
| | | allow the NBSI to provide a far |
| | | richer set of data for managers |
| | | to query and report online. |

C. Invoice Workflow

| | | |
|---|---|---|
| Manager | When a manager's | All invoices are |
| Approval | explicit approval is needed | presented to the manager in both |
| Process | for an invoice, gaining this | a sortable tabular data format, |
| | manager's approval is | a form view of all of the |
| | presently a manual process. | invoice information as well as |
| | Phone, fax or email can be | the graphical image of the |
| | used to get their approval. | invoice. This presents to the |
| | Usually, lacking a visual | manager all information possibly |
| | representation of the | needed on the invoice. |
| | invoice, managers wish to see | Discussions concerning the |
| | a faxed copy of the invoice. | invoice can be initiated by |
| | Often the manager's approval, | either broker or manager |
| | once granted, can be lost | involved with the invoice. A |
| | when later needed for billing | discussion is logged and becomes |
| | discussions. | a part of the invoice record |
| | Managers employ many | changing the discussion icon to |
| | different types of approval | indicate that a discussion |
| | criteria that a broker must | exists on a particular invoice |
| | follow. Depending on the | and is viewable. The qualified |
| | manager, approval is needed: | user logon at the manager is |
| | a) if the dollar amount | allowed to approve invoices. |
| | exceeds a certain threshold, | Once done, the manager user |
| | b) if it is a “one time fee” | logon as well as the date and |
| | instead of a regularly | time becomes a part of the |
| | occurring invoice, c) if it | invoice record. |
| | is a monthly bill and the | System settable |
| | dollar amount is different | approvals are possible for each |
| | from prior months for that | commitment/contract. A billing |
| | particular account number, d) | account/commitment can be set in |
| | for all invoices whatsoever | one of three manners by the |
| | and the broker needs to | manager: 1) require manager |
| | manually contact the manager | approval on all invoices, 2) |
| | on a periodic basis (i.e., | automatically approve all |
| | daily, weekly, bi-weekly, | invoices for this account, or 3) |
| | monthly, etc.) via phone, fax | automatically approve all |
| | or email to get approval for | invoices to this account if the |
| | each invoice. Some managers | amount is equal to previous |
| | request that copies of the | invoices - otherwise manager |
| | invoices paid are included | approval is required. |
| | each month with the monthly | |
| | statement. | |
| Broker CSR | The officer in | Based on the status of |
| Approval | charge of a broker's soft | the invoice, the broker can see |
| | dollar department requires | all their invoices in the system |
| | internal approvals on some or | based on the workflow status. |
| | all invoices for a particular | Invoices that have manager |
| | manager. These internal | approval shows up as an action |
| | approvals may be based on | item requiring broker action. |
| | dollar thresholds, past due | Given that these invoices are |
| | amounts, the type of service | universally visible at all |
| | used by the manager, etc. A | logons at this broker, all staff |
| | broker's sales and compliance | (e.g., sales, compliance, etc.) |
| | staff also contributes to | that needs to see the invoice in |
| | these approval criteria as | order to approve it can |
| | well as the accounting | simultaneously view the invoice. |
| | controller. | Once the broker customer service |
| | Often this internal | representative is able to |
| | approval is done by the | approve the invoice, the broker |
| | broker customer service | logon, and date of approval |
| | representative having to walk | becomes a part of the invoice |
| | around the office to seek out | record. Additionally, this |
| | the necessary parties. This | approval step also allows the |
| | can easily lead to delay. | broker CSR to schedule a |
| | It is often the | suggested payment date in light |
| | practice at brokers to enter | of the due date. |
| | the invoice into the internal | Invoices are entered |
| | system at this point of | into the NBSI system at the |
| | having obtained internal | beginning of the workflow |
| | approval. | process. |
| Payment | The broker customer | Like the existing |
| Scheduled | service representative | process, the broker CSR |
| | schedules a desired payment | schedules a suggested payment |
| | date that is usually used by | date that is usually used by the |
| | the accounting department. | accounting department to make |
| | The scheduling of the payment | the payment. |
| | date is often part of the | |
| | broker customer service | |
| | representative approval | |
| | process. This payment | |
| | scheduling is then subject to | |
| | the internal controls of the | |
| | accounting department. | |

D. Payment Generation

| | | |
|---|---|---|
| Accounts | The handoff of | Unlike the existing |
| Payable/ | information from a broker's | process, there is no handoff of |
| Controller | soft dollar administration | information between the soft |
| Approval | department to the accounting | dollar administration department |
| | department can be delay and | and the accounting department. |
| | error prone. Accounting | The appropriate personnel in the |
| | personnel can be absent | accounting department are the |
| | delaying the final approval | final link in the workflow |
| | needed to have the payment | process. They have not only the |
| | generated. A difference in | ability to override the |
| | the dollar amount on the | scheduled payment date entered |
| | check versus the invoice | by the broker CSR but also they |
| | amount due to clerical error | have the reporting ability from |
| | can cause delays. | the NBSI system to schedule |
| | | payments well into the future |
| | | and see the cashflow demands of |
| | | each day due to payment |
| | | calendaring. Accounting also |
| | | has a view into their banking |
| | | register and sort by multiple |
| | | criteria (entry date, payee, |
| | | cleared date, check date, etc.) |
| | | in order to plan the most |
| | | optimal cashflow in light of |
| | | payment due dates. |
| Mixed Use | If an invoice is | A manager can not only |
| Invoice | partial payment due to mixed | use phone, letter or email to |
| Handling/ | use, the manager communicates | notify the broker about a mixed |
| Manager | this notification to the | use invoice but also the |
| Ineligible | broker via phone, letter, or | discussion feature for each |
| Invoices | e-mail. | invoice can be used. The user |
| | There are two | interface provisions allow |
| | manners in which mixed usage | managers to input the ineligible |
| | invoices can be managed: a) | percentage or amount to permit |
| | the broker pays the entire | the system to calculate the |
| | amount and then creates a | remainder amounts. |
| | receivable for the ineligible | If a manager uses the |
| | portion and bills this back | terminal feature of the NBSI |
| | to the manger or b) the | system to track individual usage |
| | manager pays the ineligible | points of the vendor service and |
| | portion of the invoice | certain areas or cost centers |
| | directly to the vendor while | within the manager are not soft |
| | the broker only pays the | dollar eligible, the NBSI system |
| | eligible portion of the | can automatically compute a |
| | invoice. The latter type of | suggested ineligible percentage |
| | mixed usage scenario is very | of the invoice based on the |
| | difficult to manage as the | number of usage points in soft |
| | vendor is receiving two | dollar ineligible areas. |
| | checks for one invoice at | The NBSI system |
| | different times. | provides a means to communicate |
| | There lacks a | which party is to pay the |
| | reliable means to document | ineligible portion of the |
| | which party is paying the | invoice. When this is decided, |
| | ineligible portion. This can | the system sets which party is |
| | lead to duplicate payment and | paying the ineligible portion. |
| | non-payment of the ineligible | The NBSI can generate |
| | portion. As like all other | payments for participating |
| | invoices, the mixed usage | managers for their ineligible |
| | approval and payment may be | payments in addition to the |
| | done on a monthly, quarterly, | ineligible portion of mixed-use |
| | or annual basis. | payments in the same fashion as |
| | Manager lack any | the NBSI generates payments for |
| | means at present to outsource | brokers. This provides a means |
| | their non 28(e) eligible | for a manager to outsource their |
| | invoice payments in an | entire invoice payment with the |
| | integrated fashion with their | requisite mail handling and data |
| | soft dollar invoice payment. | entry. As with brokers, the |
| | | NBSI may provide feedback to |
| | | participating manager systems |
| | | their outsourced data entry. |
| Broker | Brokers lack any | The NBSI is capable of |
| Ineligible | means at present to outsource | handling soft dollar ineligible |
| Invoices | their non-soft dollar invoice | invoices for the brokers as well |
| | payments in an integrated | as partially eligible (mixed- |
| | manner with their soft dollar | use) invoices. Receivable |
| | invoice payment. | tracking for funds owed by |
| | | managers is possible. As such, |
| | | a broker could outsource their |
| | | entire bill payment to the NBSI |
| | | reducing the paper mail to their |
| | | offices substantially. |
| Payment | Including the | Labor is outsourced to |
| Generated/ | correct invoice stub with the | NBSI from broker. |
| Mailed | check is essential to enable | The NBSI, working with |
| | the vendor to apply the | a banking affiliate, generates |
| | payment correctly. Sending a | the wire or check to the vendor - |
| | check with the wrong or | payment type according to |
| | missing invoice stub can | vendor preference. Procedures |
| | cause payment delays. | are tightly followed with |
| | Accounts payable can cause | economies of scale. Continuous |
| | delays in the payment process | process improvement is sought. |
| | due to: the absence of | Due to economy of scale, clout |
| | checks, changed wire | with vendors is increased. Work |
| | information, employee | with vendors to seek the most |
| | turnover, vacations, external | automated and efficient payment |
| | meetings or loss of the paper | methodology. |
| | invoice. The payment can be | |
| | lost en route to the vendor | |
| | due to mailroom errors. | |
| Vendor | Clerical errors can | Vendors can see |
| Payment | be made at the vendor as | directly in the system for which |
| Reception | well. The invoice stub can | account a particular payment is |
| | become separated from the | for. Vendors can see the status |
| | check sent preventing the | of all invoices in question. |
| | vendor from correctly | Due to economy of scale, vendor |
| | applying the payment or | communication and clout is |
| | accepting payment at all. | increased to seek the most |
| | Payment could be applied to | efficient payment method that |
| | the incorrect account. | eliminates errors on the vendor |
| | | side as well. |
| Payment | Vendors and managers | Vendors and managers |
| Status | have no means of knowing the | can view all invoices in the |
| | status of unpaid invoices | system in which they are |
| | still in the workflow. As a | involved parties and see the |
| | result, the brokers must | present status of the invoice as |
| | constantly field calls from | well as all invoice workflow |
| | both vendors and managers | information such as manager id |
| | inquiring about payment | approving, manager approval |
| | status. This consumes a | date, Broker CSR approving, |
| | meaningful percentage of a | Broker CSR approval date, |
| | broker customer service | scheduled payment date, check |
| | representative's workload. | number, check date. |
| | | Not only is vendor |
| | | uncertainty replaced with |
| | | information but also the vendor |
| | | has optional supplemental |
| | | reporting available in the NBSI |
| | | system. Once the broker's |
| | | controller has scheduled the |
| | | payment to a vendor, this future |
| | | payment can be used for cash |
| | | flow planning by the vendor. |
| | | This allows vendors to manage |
| | | their finances with greater |
| | | ease. |
| Invoice | Once payment is | Invoice is |
| Filing | made, the paper invoice must | automatically filed online |
| | be properly filed for later | within the system with all |
| | retrieval. The broker can | relevant details as well as |
| | possibly lose the paper | graphical image. The paper |
| | invoice or misfile the | invoices that do not become more |
| | invoice due to procedural | automated are returned to the |
| | errors and employee turnover. | brokers each month unless |
| | | separate arrangements are made |
| | | for archival storage. |
| Audits | During an audit of a | This information is |
| | manager by the SEC or a | available online in an organized |
| | manager's internal audit, | manner. Participating managers |
| | multiple invoices need to be | have the capability to query |
| | retrieved and mailed to the | this data in and enhanced manner |
| | manager. This manual invoice | through an optional reporting |
| | retrieval is necessary also | module. |
| | for internal broker audits | |
| | and by independent auditors. | |
| Multi- | A manager's soft | By being an impartial |
| Broker | dollar activity is spread | intermediary, the NBSI is able |
| Reporting | over multiple (sometimes over | to be a central outsourcer to |
| to Managers | 30) brokers. The quality of | the brokerage community. |
| | reported data from individual | Therefore, managers (as well as |
| | brokers is of varying | vendors) are able to report |
| | completeness, accuracy and | their entire soft dollar |
| | format. While an individual | activity for all brokers |
| | broker may have excellent | participating with the NBSI. |
| | data to report to a manager, | Through a reporting module, the |
| | this broker is one of many | manager can report across |
| | brokers to this manager. The | multiple brokers in a |
| | manager is forced to collate | standardized and complete |
| | these “data silos” manually | format. Having the vendor |
| | often from paper statements | services classified by |
| | in order to have a complete | categories enhances this |
| | record of this manager's soft | reporting ability. |
| | dollar activity for SEC and | |
| | internal reporting purposes. | |
| | Often managers are forced to | |
| | manually maintain an internal | |
| | reporting system for this | |
| | purpose resulting in | |
| | duplicate data entry expense | |
| | and errors. | |
| Vendor | Vendor services are | All vendor services are |
| Services | not presented in a | classified according to |
| Classified | standardized format according | standardized suggested SEC |
| in | to suggested SEC Guideline | Guideline product categories, |
| Categories | product categories nor | general soft dollar eligibility |
| | according to SIC codes. If | of the category, and SIC codes. |
| | any product categorization is | Additionally, these |
| | done at present, it is unique | classifications can be used to |
| | to that listing agency. | enhance management reporting for |
| | | brokers and managers reporting |
| | | their activity from the system. |
| Promotional | There are presently | Vendor services |
| Website | several services that have a | listings are already present in |
| | directory listing of vendors, | the NBSI system with confirmed |
| | managers and brokers in the | addresses given that these |
| | industry. These services' | services are continually |
| | sole raison d'être is to be | receiving payments from the |
| | directory listings. | NBSI. Minimal additional data |
| | Therefore all data present is | maintenance is needed outside of |
| | data entered as contact | ongoing operational data |
| | management. These listing | maintenance used to run the core |
| | services do not focus on | focus of the NBSI in order to |
| | aiding managers and brokers | present service listings for |
| | to find vendor and legal | willing vendors. |
| | services but instead to aid | In addition, these |
| | salespersons at managers, | services are classified in a |
| | brokers and vendors pursue | standardized manner according to |
| | their client bases of funds, | suggested SEC Guideline product |
| | managers and managers | categories. Therefore, it is a |
| | respectively. | natural use to present these |
| | | services in a classified and |
| | | searchable manner to facilitate |
| | | managers and brokers to find the |
| | | services that they need to |
| | | purchase. |
| | | Aiding the NBSI's |
| | | client base and promoting vendor |
| | | services is the primary focus of |
| | | this website. This information |
| | | is only available to |
| | | participating entities already |
| | | using the NBSI system for |
| | | operational purposes to prevent |
| | | unsecure access to data. |

II. Network and User Interface Description

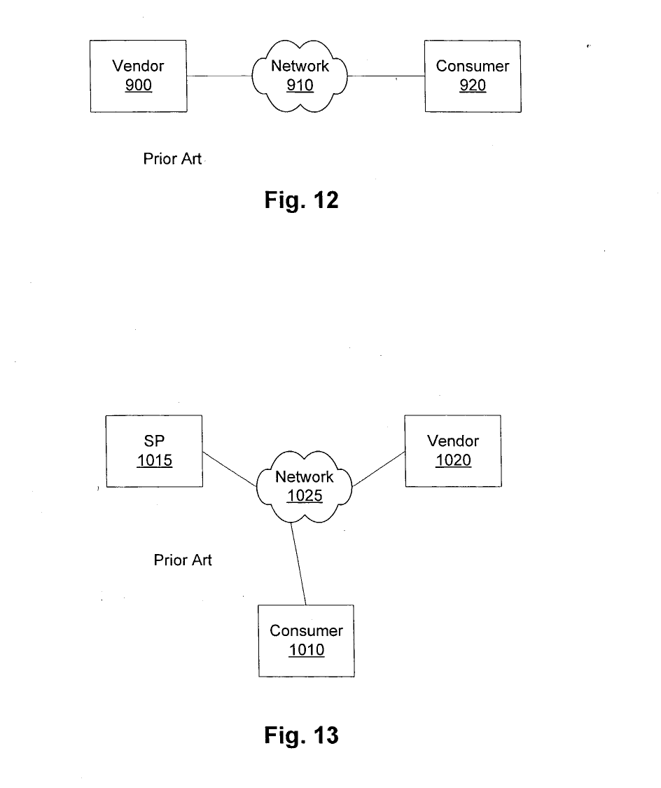

Referring now to FIG. 12, a vendor 900 and consumer 920 are linked by a network 910 in a client/server environment for purposes of generating, reviewing, approving, and paying invoices (not shown). The vendor 900 may generate bills and provide software at the vendor 900 location to allow the consumer 920 to review and approve the bills for payment. The network 910 provides a medium for transfer of data according to known client-server processes and techniques. Referring now to FIG. 13, bill or invoice presentment and authorization for payment may be provided in an environment that includes a service provider 1015. Here, a vendor 1020 provides a service or product, and bills from the vendor are sent to the service provider 1015 who presents them for payment to the consumer 1010 by means of a software system, for example, a client-server system over a network 1025. Examples of bill payment systems can be found in U.S. Pat. No. 6,292,789 to Schutzer, issued Sep. 18, 2001; U.S. Pat. No. 6,385,595 to Kolling, et al. issued May 7, 2002; U.S. Pat. No. 6,408,284 to Hilt, et al., issued Jun. 18, 2002; U.S. Pat. No. 6,285,991 to Powar, issued Sep. 4, 2001; and U.S. Pat. No. 6,052,671 to Crooks, et al. issued Apr. 18, 2000, each of which is hereby incorporated by reference as if fully set forth in its entirety herein.

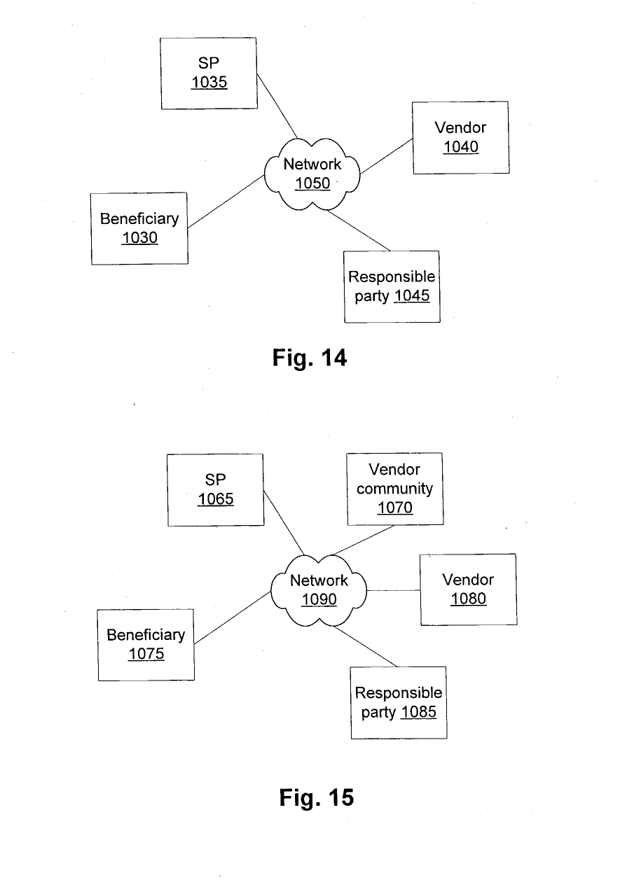

Referring now to FIG. 14, in a more complex environment, a three-way relationship exists between a responsible party (e.g., a consumer) 1045, a vendor 1040 and a beneficiary 1030. The beneficiary 1030 receives at least some portion of a benefit of services or products delivered by the vendor 1040. The responsible party 1045 has at least some obligation to pay for the products or services of the vendor 1040. The beneficiary 1040 may not receive all of the benefit of the products or services but may receive only part of them. A service provider 1035 may be involved for storing and organizing information pertaining to obligations of the various parties (vendor 1040, beneficiary 1030, and responsible party 1045). The service provider 1035 may provide functions similar to those described, for example, in U.S. Pat. No. 6,385,595 incorporated by reference above.

Referring to FIG. 15, in a more elaborate environment, a vendor community 1070 competes for the business of the responsible party 1085 and the beneficiary 1075 by participating in bargaining or simply advertising of services or products to either the beneficiary 1075, the responsible party 1085, or both. For example, the service provider 1065 may provide a web site function such as a content aggregator that allows vendors in the vendor community 1070 to advertise their products and services according to known practices. For example, such a content aggregator may allow the responsible party 1085 or beneficiary 1075 to filter based on product categories, price, user-satisfaction as indicated by ratings, product or service features, geographic local, size of vendor, resources used, etc.

The beneficiary 1075 may be related to the responsible party 1085 in a variety of ways. One example is described at length in the foregoing description of the soft-dollar industry, where the beneficiary 1075 represents a fund manager and the responsible party 1085, the broker. Another example is a more explicit relationship where the responsible party 1085 is a creditor of the beneficiary 1075 such as a bank, credit card company, caretaker, internal accounts payable department of a large, geographically dispersed company or some other agent-type entity which may have sole decision-making authority in the relationship or may share decision-making authority with the beneficiary 1075 or may leave all decision-making to the beneficiary. In shared decision-making, as in the model of the soft-dollar industry described above, the approval of both the beneficiary 1075 and responsible party 1085 may be required for payment of invoices. Alternatively, approval of one or the other may be required for payment of invoices.

The service provider 1065, in the embodiment of FIG. 15, may host a network system 1090 that generates a client-server-type software system akin to one or more World Wide Web sites (collectively: “web site”). Each entity in any of the embodiments of FIGS. 12-15 may log into the web site and participate in a variety of transactions. For example, the web site may display information provided by the service provider 1065, the information being periodically updated or somewhat permanent. The web site may also display information according to templates provided by the service provider 1065 at the initiation of one of the other parties. For example, either the beneficiary 1075 or the responsible party 1085 may fill in a proposal template provided on the web site in the form of an online form and submit it. The web site would then provide the ability, depending on permissions, which may be defined in the template, to view the proposal via a search facility. Other information may be defined by parties and made available to other parties using such web site facilities according to known techniques. The web site may aggregate information from various parties such as the vendor community 1070 or multiple responsible parties 1085 and allow the aggregated and summarized data (e.g., statistics of the data provided) to be viewed by other entities according to security guidelines set forth by the service provider 1065. The web site may provide approval and user-authentication processes, to be described by way of examples below, as well. The web site may also be capable of sending messages from particular entities to particular entities or groups of entities according to known web processes such as providing a list of messages from entities subscribing to the service provider 1065 system or by way of email. Another facility that may be provided by web sites is user profiles and preference settings that may be stored in connection with users. These settings may pertain to user interface features or process steps and persist indefinitely until changed, for example by a user. Such features are common in web sites and the details need not be discussed in detail presently.

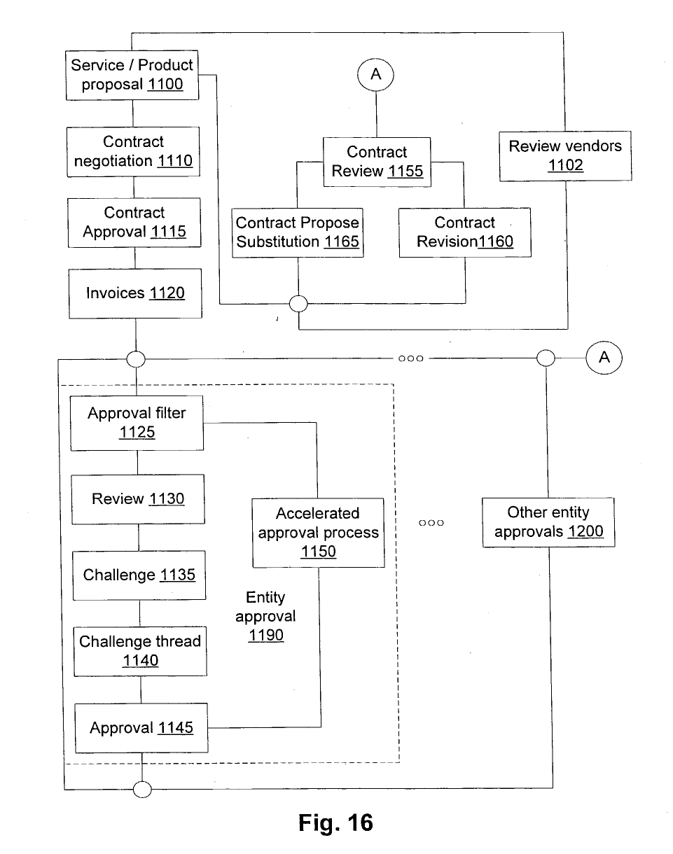

Referring now to FIGS. 15 and 16, a user interface supporting the approval process may be used with any of the environments illustrated in FIGS. 12-15. Vendors of products and services may be added, replaced, and eliminated by forming and relinquishing contracts, in a client-server process that begins with a proposal 1100. The proposal 1100 may include a set of terms and be made available to one 1080 or more 1070 vendors. (Note that although the discussion refers to FIG. 15 in particular, it is contemplated that the embodiment of FIG. 16 is applicable to the embodiments of FIGS. 12-14 as well). The proposal may or may not be generated by either a responsible party 1085 or beneficiary 1075 (or even service provider 1065) in response to a search of vendor information made available through the web site. The latter step is indicated at 1102.

The proposal 1100 may be made available by means of a web site that can be searched by members of the vendor community 1070. For example, a search engine may provide particular filters to allow vendors 1070 to view proposals for services by entities of a certain size. Alternatively, messages may be directed by the originator of the proposal 1100 to specific vendors 1070, 1080 through a messaging system provided by the web site.

Once a contract is finalized 1120, one or more invoices may be generated 1120 by a subject vendor 1180 and submitted for approval in one or more entity approval processes 1190, 1200. In a preferred embodiment, the entity approval process 1190, 1200 may involve a large number of invoices over a period of time, each deserving varying levels of scrutiny. To discriminate among invoices they may be classified according to predefined rules provided in a preference. For example, one rule may be to automatically approve an invoice if the amount is substantially unchanged from an approved invoice that preceded it by a regular interval (e.g., a monthly invoice). For this purpose, a range of acceptable change may be set. Alternatively, a rule may define a range of amounts (or upper limit) such that if the range is exceeded, the invoice will not be automatically approved but will be automatically approved if it is not exceeded.

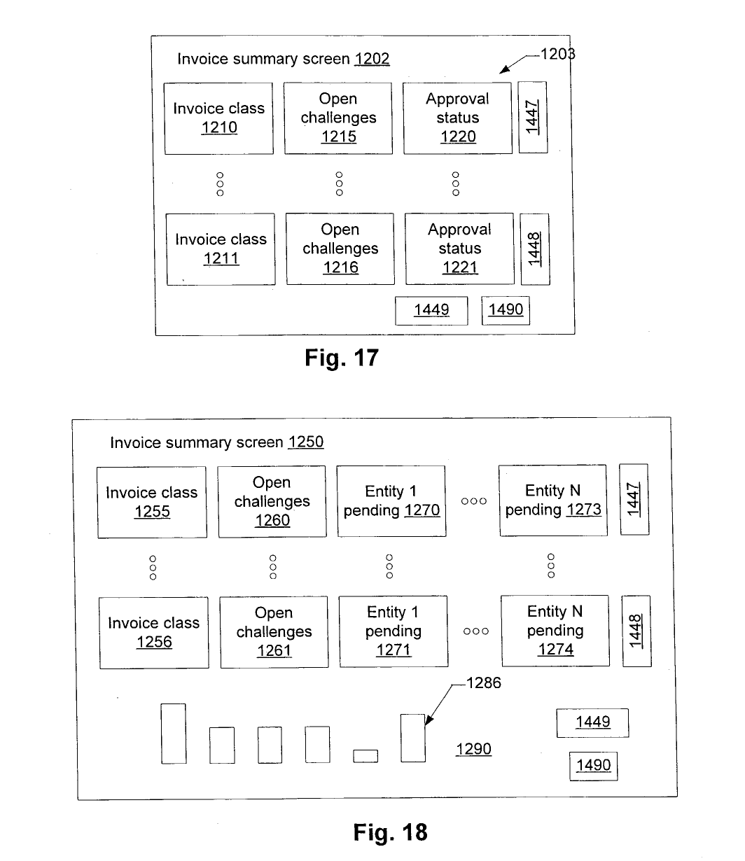

The accelerated approval process 1150 may provide various mechanisms from automatic approval for payment of an invoice to a different display format for an invoice or filtering for review by different entities. Alternatives are discussed below. A normal invoice approval process begins with presentation of invoices for review by all relevant and involved parties within an entity (entities, again, being any entities in the environments of FIGS. 12-15 or others). For example, the entity may be the responsible party 1045 in the environment of FIG. 14. Invoices may be displayed in a variety of different formats for review and approval. Examples of user interface screens are shown in FIGS. 17 and 18.

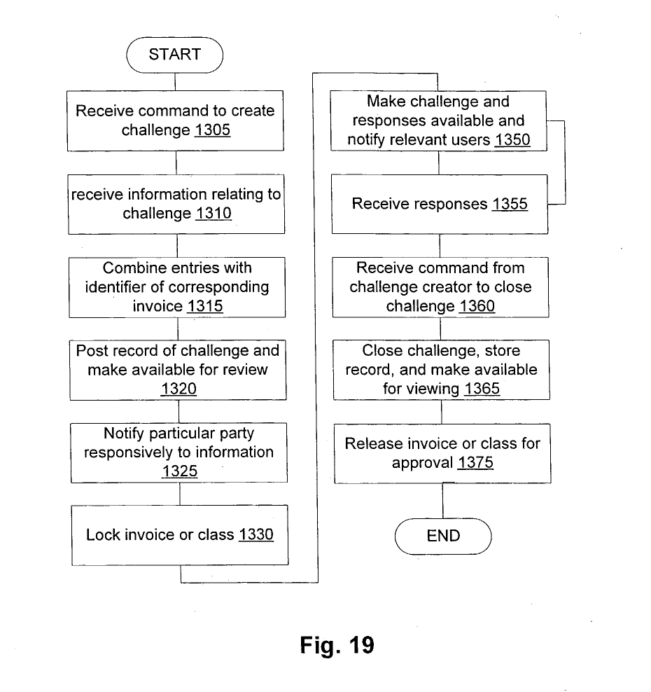

A facility of the web site may be provided to allow negotiations 1110 between a proposer (e.g., responsible party 1085) and a responding vendor 1080. This permits contract terms to be modified until some set is approved 1115 in the form of a final contract. Approval and negotiations may be provided as in the example system for the soft-dollar industry described below, as described in U.S. Pat. No. 6,141,653, incorporated by reference above, or any other suitable mechanism that facilitates the exchange of information in any of the environments of FIGS. 12-15. Review 1130 involves the selective viewing of detail or general information about invoices or classes of invoices and the entering of information in the web site to indicate approval or challenge. Challenge 1135 may simply be a threaded discussion system such as commonly employed in web sites which includes at least an ability for one user to enter information indicating some issue and the ability for others to respond. Preferably, the challenge system provides a link to a subject invoice or class of invoices. Also, preferably, a mechanism for “closing” an issue opened by the posting of a challenge is provided and final approval of an invoice is prevented while a an issue is opened. For example, referring to FIG. 19, a challenge may begin with the activation of a control indicating a command to create a challenge 1305. The web site may then receive information relating to the challenge such as a question by a user as to a particular issue relating to the invoice or class of invoices 1310. The challenge creator may also indicate a particular user whose attention is requested regarding the matter, indicate restrictions as to who may view the challenge, etc.

To complete a challenge, the entered information may be combined with other data identifying the invoice or class 1315. A record of the challenge may be formed and made available for review by authorized users 1320. A message or control may be generated to notify a particular user indicated at step 1310 whose response is desired 1325. The invoice or class 1330 may be locked to prevent approval until closure of the challenge 1330.

The challenge may be made visible to other users or selected ones and one or more particular users notified 1350 as indicated in the information provided in step 1310 or other information indicated in step 1355, below. The web site may receive responses 1355 and, steps 1350 and 1355 may be repeated indefinitely as new responses are generated each in reply to another. These are made available to users in step 1350. A command to close a challenge may be received at 1360. The web site may allow this command to be responded to only if presented by the entity creating the challenge in step 1305. The challenge may be closed, stored, and a record made available for viewing by users 1365. Finally, the invoice or class locked in step 1330 may be released to allow acceptance of a command to approve the invoice for payment to be accepted 1375.

Referring now to FIG. 17, an invoice summary display 1202 displays a list of invoice groups each row 1203 (typ.) corresponding to a class of invoices indicated in a corresponding field as illustrated 1210 and 1211. Each row 1203 has a field indicating a number showing the number of open challenges 1215 to approval for the corresponding invoice class. Challenges may simply be discussion threads annotating one of the invoices in the class identified at 1210, 1211. A third field indicates approval status 1220, 1221 for each subject class. The latter may indicate the latest step of a sequence of approvals that is required. For example, the sequence of approval may be responsible party 1045 (FIG. 14) clerk, responsible party 1045 controller, beneficiary 1030 (FIG. 14) clerk. If the first two parties approved the subject class of invoices but the final has not yet, the approval status field may indicate, for example, “pending beneficiary approval.” In a situation where approval is applied to individual invoices and not approval classes, a user interface such as illustrated at FIG. 18 may be preferable.

Referring now to FIG. 18, a summary screen 1250 shows a list indicating a number of invoices pending approval in each of a set of invoice classes, as indicated at 1255 and 1256. For each invoice class, a number of open challenges 1260 and 1261 is indicated. Since approval in the current context is by individual invoice, the number of invoices at each stage of approval are indicated separately. For example, in an approval sequence in which an Entity 1 must approve an invoice, then an Entity 2, and so on. Then the number of invoices at each level of approval may be shown in fields 1270, 1271 through 1273, 1274. A graphic histogram representation 1290 may be shown to indicate the current pending status of all invoices. The height of each histogram bar 1286 (typ.) may indicate the number of invoices pending at the particular level of approval.

Note that preferably, the fields in the lists of FIG. 18 or a similar type of display are arranged in order of an approval process or hierarchy. Also, preferably those fields indicating approval or other status are grouped together. For example, as shown in the invoice summary screen 1250, the controls 1270 . . . 1273 may represent a sequence or order that reflects an underlying approval protocol. Also, the same controls are grouped together.

Each quantity figure shown in either of the embodiments of FIGS. 17 and 18 may be hyperlinked to a detail list showing the invoices contributing to the corresponding quantity figure. Detail lists may be as shown in various prior art systems, such as in references incorporated by reference above or in the specific example of the soft-dollar system discussed above.

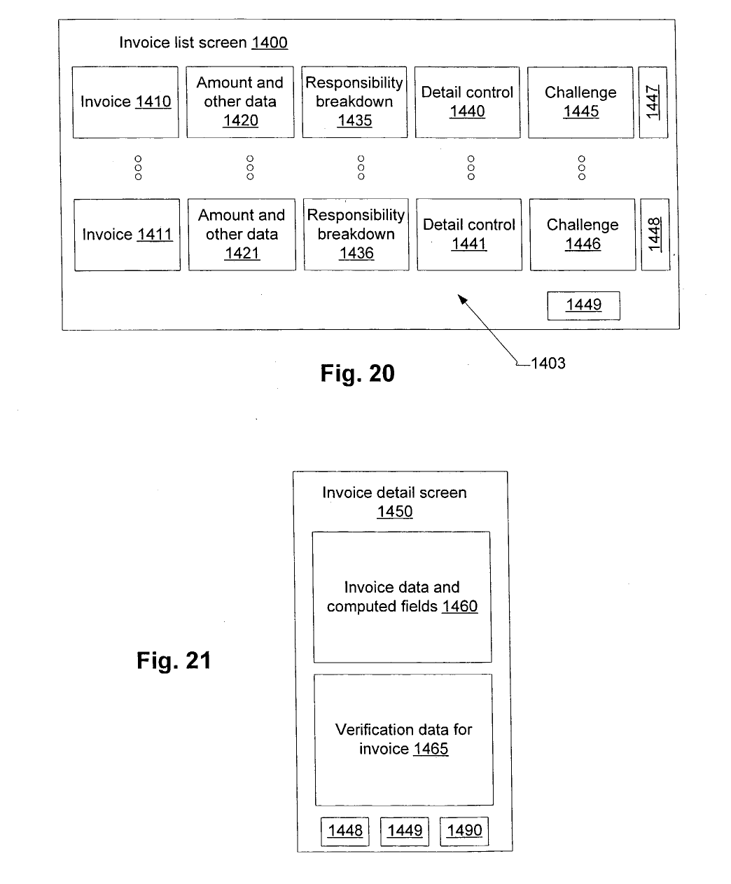

Referring now to FIG. 20, an invoice list screen 1400 shows all invoices in a defined range and filtered by defined rules in list form. The range and rules may be provided by user preferences, by controls applied before displaying the list, by fixed definitions, or by selection of a field in a summary screen such as 1202 and 1250 in FIGS. 17 and 18. In the latter case, as mentioned earlier, only a subset of the invoices corresponding to the field selected in the invoice summary screen 1202 or 1250 is shown. Each row 1403 in the invoice list screen 1400 corresponds to an individual invoice. Various fields may be shown, for example, a key identifier 1410, amount of invoice and other information 1420, a breakdown of the invoice to show shared responsibility for payment 1430 as discussed below, a detail control 1440 to allow the user to view more details on the invoice, and a control relating to any existing challenges pending 1445 in connection with the invoice.

Referring to FIG. 21, a detail screen 1450 shows invoice data in two forms, computed or alphanumeric data displayed in a formatted field area 1460 and validation data 1465 which can take a variety of forms. The formatted field area 1460 is a typical way for invoice data to be displayed in software systems. The verification data 1465 is supplemental information for the user to verify the accuracy or authenticity of the invoice data. In an embodiment, this may be a scanned image of an invoice received by the service provider (e.g., 1065 in FIG. 15). If the service provider 1065 used a clerk to enter data by hand from a printed invoice, incorrect data may be entered and this would appear in the invoice data and computed fields area 1460. An image would provide a convenient means by which the wrong data could be corrected or correct data verified quickly and easily without an exchange between entities such as a user representing the beneficiary 1075 and a user representing the service provider 1065.

One means of virtually eliminating incorrect data entry due to the mistyping of data is to employ dual data entry of invoice data. In such a scenario, one employee would enter the invoice into a staging area within the system either from a paper invoice of a scanned image of the invoice. A second employee would then enter the same data into the staging area. Provided that the invoice data from both employees match, the system incorporates the data via a process for the approval processes. In the cases where the data does not match, a tie-breaking third employee must enter the data to create a valid invoice record for the approval processes. Preferably, the unique filename of the invoice image is used to associate the staged invoice records prior to their culmination in a valid invoice record.

Another alternative for verification data 1465 may be authentication key data or bioauthentication data which would serve to authenticate the party originating the invoice. For example, a public key-private key may encrypt a message containing a copy of the invoice and that data made available and verifiable through actuation of a control, the field 1465 representing a control in that case. The verification data 1465 could include source information relating to the invoice such as a trail of individuals involved in the generation of the invoice and amounts corresponding to transactions cumulating to the total of the subject invoice.

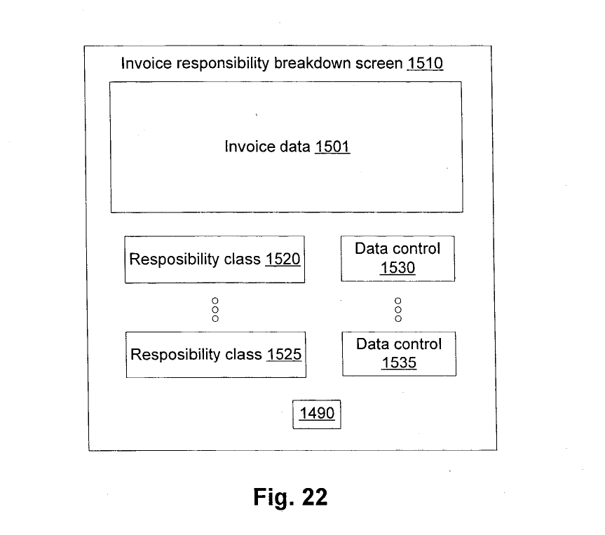

Referring to FIG. 22, responsibility for an invoice may be distributed by department, entity, expense class or other demarcation. For example, in the soft-dollar industry case, only a portion of an invoice may be eligible as a soft-dollar expense. This may be determined automatically by rules stored in connection with invoice classes, such as originating vendor and stored in a preference database residing on the web server generating the web site. The breakdown may be adjusted or entered by means of a breakdown screen, which may be a stand-alone screen corresponding to an invoice and entered via a separate control in the invoice detail screen 1450 (FIG. 21) or the invoice list screen (1400, FIG. 20). In the latter case, the control bringing up the breakdown screen 1510 could be a corresponding one of the responsibility fields 1435, 1436, which may be rendered as hyperlinks.

In the invoice responsibility breakdown screen 1510, invoice data is summarized in a corresponding field area. Each of a number of responsibility classes 1520, 1525 may be defined and shown in list form. Each responsibility class may be associated with a data control 1530, 1535. The responsibility classes may be different entities, different expense classes, accounts for payment by a single entity, eligibility for payment under a particular classification such soft-dollar eligible in ineligible, etc. The data controls 1530, 1535 may provide text fields for entry of amounts in terms of absolute quantities (e.g., dollars) or percentages of the total. The number of classes 1520, 1525 is arbitrary. The controls 1530, 1535 may include spin-controls, drop-down lists, text boxes, or any suitable screen controls.

Note that each of the displays shown in FIGS. 17, 18, 20, and 21 may be provided with screen controls 1447, 1448 to allow particular row items (invoices or classes thereof, respectively) and a command control 1449 to allow the user to indicate an approval for payment of an invoice. Thus, one or a class of invoices may be selected by activating a corresponding control 1447, 1448, for example, a check-box type control. Then the command control 1449, which could be a button type control may be activated to cause the indicated invoices or classes to be marked for payment approval. The corresponding controls 1447, 1448 may be modified in color or highlighting or otherwise to indicate the approved status. In addition, another superclass control 1490 may be provided to allow the user to navigate to superclass information relating to an invoice or class thereof. For example, a user could mark an invoice using a control 1447, then activate the superclass control 1490 to be brought to a screen displaying information about a governing contract relating to the selected invoice. Alternatively, a preferences database relating to the vendor issuing the invoice, rules data relating to the how the approval filter 1125 is applied to the class of which the subject invoice or class is a member, or any superclass information.

Referring again to FIG. 16, a number of alternative embodiments of an accelerated approval process 1150 may be provided. For example, invoices filtered in the approval filter 1125 and determined to warrant less vigilance than others, may be marked for approval of payment without being displayed, as in step 1130. Alternatively, such invoices may be displayed in a different format from the others or grouped together and capable of being approved as a group while non-accelerated invoices are approved individually. Another alternative is simply to display the invoices in the accelerated approval process 1150 in a manner that is highlighted differently so that a different degree of attention can be selectively applied according to the user wishes. For example, the accelerated invoices (or classes) could be ghosted, but otherwise formatted in a similar manner as other invoices or classes of invoices.

III. User Interface Screen Features

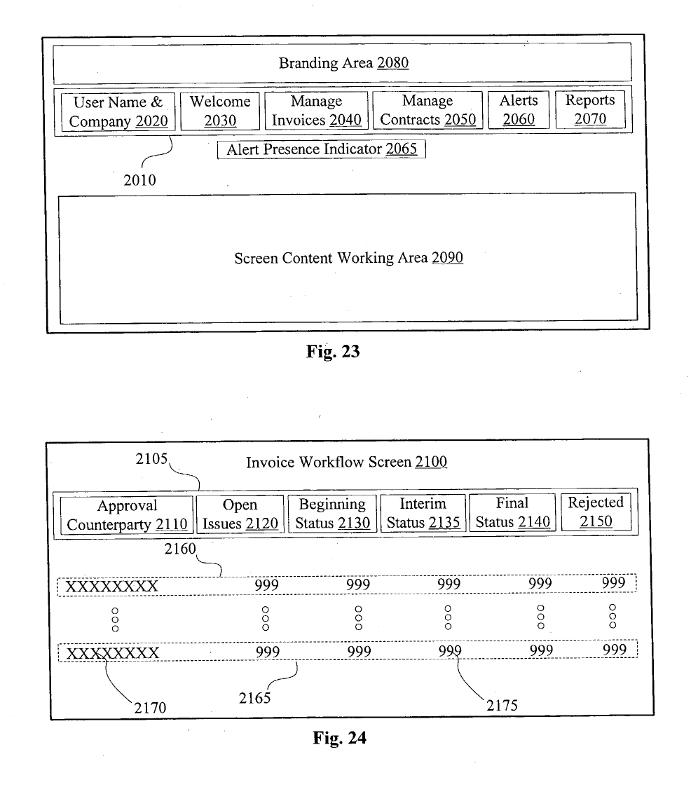

FIG. 23 represents the standard screen heading for all user interface screens. In this example, the navigation buttons contained within the navigation bar 2010 are specific to a customer service representative at a manager 1. The first area 2020 within the bar 2010 displays the present user logged on as well as the company name. A manager's customer representative has a targeted range of activity and thus the range of buttons available is similarly limited. The Welcome button 2030 delivers the user to the top level of the user logon. To manage invoices described in greater detail beginning in FIG. 24, the user would choose the manage invoices button 2040. The manage contracts button 2050 would allow the manager to see and maintain the overlying contracts or commitments under which one or multiple invoices arrive at the broker 2 for the benefit of the manager 1. The Alerts button 2060 brings the user to the area where relevant workflow alerts are displayed. If there are recent workflow events that triggered alerts whereby the manager 1 must perform a task to assist the workflow, these alerts' presence are signified by the Alert Presence Indicator 2065. Clicking on this indicator 2065 brings the user to these pending alerts. When the user wishes to view various reports on the system activity that is relevant to that organization, the Reports button 2070 brings the user to the reports area.

Above the navigation bar 2010 and possibly in other areas of the user screen, is a branding area 2080. Certain screens and portions of the NBSI system is specific to a particular broker 2 and may be offered as a “plug-in” to that broker's website. Therefore, to preserve the branding experience of that broker, this branding area may display logos and color schemes other than those of the NBSI 5 and specific to a certain broker 2 when broker-specific areas are entered.

With different buttons in the navigation bar 2010 as relevant, FIG. 23 represents the standard format of heading in all user interface screens. Below this format is the working area for each screen 2090. All subsequent figures discussed assume that the contents of FIG. 23 are additionally present.

The manage invoices button 2040 leads the user to the invoice workflow screen 2100 in FIG. 24. This screen has a title bar 2105 for the tabular date contained below it. The first column of the screen is for the approval counterparty name 2110. When a manager 1 uses this screen, the counterparty name 2110 would be a listing of that manager's brokers. Conversely, when a broker 2 uses this screen, the counterparty name 2110 would be a listing of that broker's managers. Boxes 2160 and 2165 represent the first and last lines of tabular data, respectively. For example, where a manager has 10 brokers, 2160 would represent the first broker and 2165 would represent the 10^{th} broker. These lines may vary in sort arrangement according to criteria set in the title bar 2105. Therefore, the listings of the exemplar 10 brokers could be in ascending or descending alphabetical sort or by count of a particular workflow status count. Following the counterparty column are multiple columns according to an invoice's particular status within the invoice's lifecycle within the workflow. Items 2120 through 2150 represent these different columns. Within each column is numerical count of the invoices for each particular counterparty having that status. Clicking on a number 2175 will lead the user to a list view of all the invoices for that counterparty having that status. Clicking on the counterparty's name 2170 will provide the user with a list view of all invoices under that counterparty. The title bar 2105 offers additional navigational assistance: clicking on a certain status column within the bar 2105 such as Beginning Status 2130 will provide a list view of all invoices having that status across all listed counterparties. The status columns 2130 through 2150 may vary according to whether a broker 2 or manager 1 is using this screen in order to segregate the invoices in the most meaningful manner for that user.

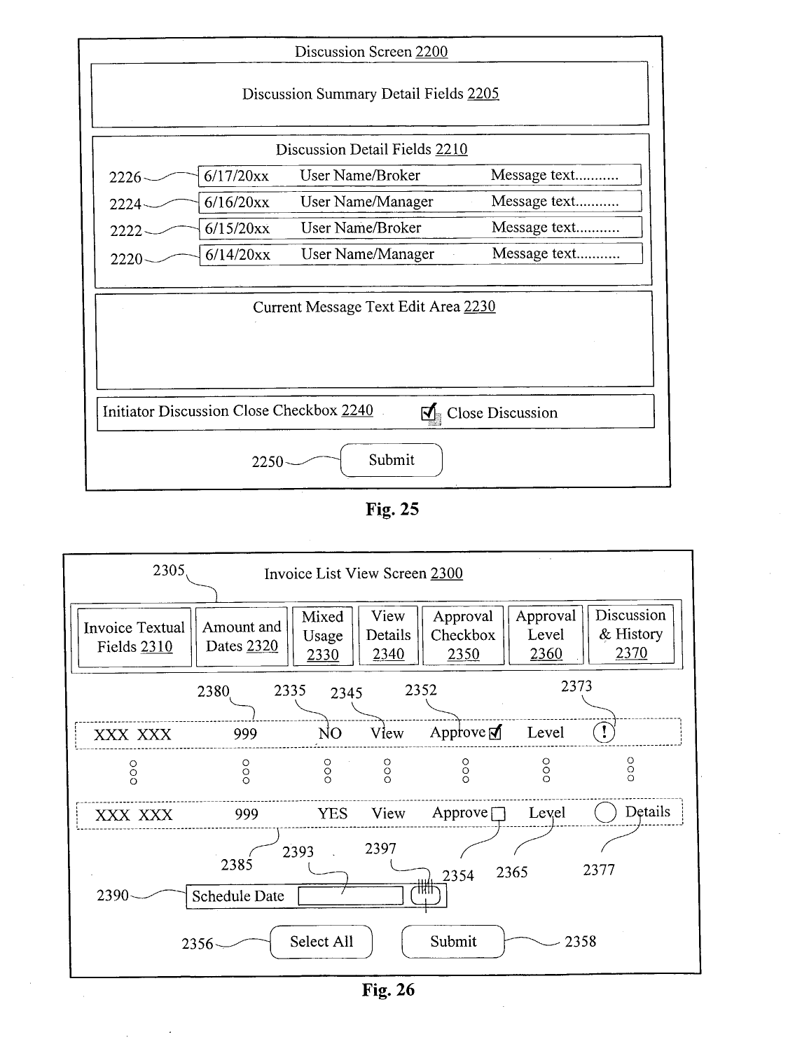

One status column that will remain constant is the listing of invoices having open issues 2120. These are invoices that have open discussions pending and therefore cannot progress in the lifecycle until the issue is closed. This is represented from a flowchart perspective in FIG. 19. FIG. 25 is a representation of a discussion screen 2200 for a particular topic. At the top of the screen is the area for summary fields 2205 concerning the invoice and discussion. Within the discussion detail fields 2210, are the various lines of discussion. In FIG. 25, this screen is being used by a manager 1 who initiated the discussion that is presently open. Line 2220 is the first message created by the manager. This line will have the date, time, name of the user, the company and the text of the message. Because a soft dollar invoice involves always a broker 2 and a manager 1, the discussion is automatically routed to the counterparty opposite to the initiator. This is an example of an event that would trigger an alert activating the alert indicator 2065 in FIG. 23 on the broker's workspace. Therefore, line 2222 represents the broker's response to the initial discussion. Once the broker 2 enters this response, 2065 would be retired on the broker's workspace but activated on the manager's workspace. To illustrate that a discussion can iterate many times between counterparties, lines 2224 and 2226 show an additional iteration between manager and broker. At this point in FIG. 25, the manager is entering the final message text in 2230 and is choosing to close the discussion by checking the close checkbox 2240 prior to pressing the submit button 2250. By closing the discussion, no alert will be triggered at the counterparty and the invoice will reenter the workflow into the status that it had prior to the discussion. For memo notes to be filed with an invoice or contract, an initiator of a discussion may close the discussion at the same time in order to have a permanent note attached to the invoice or contract.

Depending on the navigational criteria used in FIG. 24, the user is delivered to a list view of the appropriate invoices 2300 as illustrated by FIG. 26. Being a tabular view, there is a title bar 2305 with various columns. The textual fields 2310 represents multiple fields such as the vendor name, service name, counterparty name, account number, invoice number, etc. Additionally this list view may have amount and date columns 2320 such as the invoice amount, due date, etc. The view details column 2340 delivers the user to the invoice detail screen 1450 as illustrated in FIG. 21 if the view hyperlink 2345 is selected.

If a manager, the user may approve the invoice from the invoice detail screen 1450. From the invoice list screen 2300, the user may approve the invoice from the approval checkbox column 2350. By selecting the approval hyperlink 2352, the individual invoice is approved. In order to approve multiple invoices, the user can toggle the approval checkbox 2354 to select the invoices to be affected and then select the submit button 2358. If the list is extensive, the user may choose to have the system first toggle on or off all listed invoices by using the select all button 2356. If and only if the user is a broker 2, the payment date box 2390 is visible. The broker customer service representative and the broker controller users approve invoices by applying payment dates in the course of approval. The user may either type directly into the date edit field 2393 or use the calendar widget activated by a button 2397 to choose a date from the calendar.

For some managers, having to approve all invoices for a service is an unnecessary burden. If and only if the user is a manager, the approval level column 2360 is available whereby a level hyperlink 2365 is selectable. This brings the manager to a subscreen to set, at the contract/commitment level, the degree of manager approval needed for future invoices entering the system for this contract. As discussed in FIG. 7 Item 150, a manager can set the system to 1) flag all invoices under this contract to be flagged for their approval, 2) automatically approve all future invoices, 3) automatically approve the invoice if the amount is the same as a previous invoice.

Open and historical discussions associated with invoices are accessible from the discussion and history column 2370. Boxes 2380 and 2385 represent the first and last invoices in the tabular list respectively. Invoice 2380 shows that there is an open discussion by the appearance of the discussion icon 2373. This icon 2373 also functions as a hyperlink to the discussion screen 2200 as discussed in FIG. 25. Conversely invoice 2385 indicates that there is no open discussion but there is instead one or more closed historical discussions as represented by the discussion details hyperlink 2377. This hyperlink 2377 first presents the user with a listing of the different closed discussion topics. By selecting which topic to view, the user is presented with a modified discussion screen 2200 whereby the edit area 2230, close checkbox 2240 and submit button 2250 are absent due to the closed status of the discussion topic.

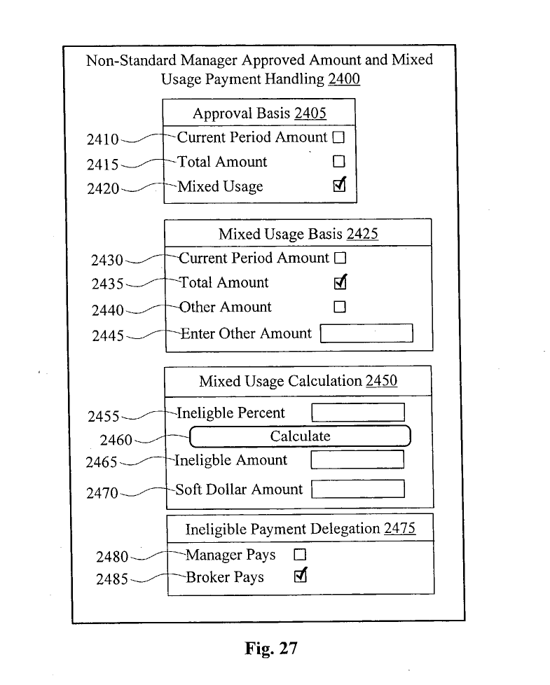

The mixed usage column 2330 is a certain type of approval performed by the manager user discussed in greater detail in FIG. 27. In invoice 2380, it is indicated that there is no mixed usage allocation set by the manager. Invoice 2385 indicates that there has been mixed usage allocation and approval set by the manager. Within the mixed usage column 2330, the text 2335 is available to the manager user as a hyperlink leading to the mixed usage approval screen 2400 discussed in FIG. 27.

Referring now to FIG. 27 accessed by the hyperlink 2335, the manager has the ability to set the approval basis 2405. By default, invoice approvals are based on the total amount 2415 of the invoice. In this screen, one of the choices presented to the manager is to approve the invoice based on the current amount 2410 only less any previous charges. If this is done, none of the areas pertaining to mixed usage represented by 2425, 2450 and 2475 are active. If the manager intends to approve the invoice based on mixed usage whereby a portion of the invoice is ineligible for soft dollar payment, the manager instead selects to the mixed usage radio checkbox 2420 in the approval basis box 2405 thus activating the mixed usage areas. The behavior of radio checkboxes is that only one box within a series is allowed to be selected and selection of one box deselects another.

By default, the basis for mixed usage computation determined in 2425 is the total amount of the invoice 2435. The manager can base mixed usage approval also on either the current amount 2430 of the invoice or on a different amount 2440. If the different amount radio button 2440 is selected, this amount must be entered in the edit box 2445.

Once the basis is determined for mixed usage, the manager must determine either the ineligible amount 2465 or the ineligible percentage 2455 of the basis. Once either the amount or percentage is entered, clicking on the calculate button 2460 will calculate the soft dollar amount 2470 and the ineligible field that was left blank—either the ineligible percentage 2455 or ineligible amount 2465.

At this point the manager user has determined both the ineligible amount 2465 and the soft dollar amount 2470. The last step is to delegate which party is to pay the ineligible amount 2465. In the ineligible payment delegation area 2475, the manager has radio buttons for either delegating the manager to pay the ineligible 2480 or the broker to pay the ineligible 2485. If the manager 1 is to pay the ineligible portion of the invoice, two payments will be sent to the invoice's vendor 3: one payment from the manager 1 for the ineligible portion and one payment from the broker 2 for the soft dollar portion. The NBSI system can assist the vendor 3 in associating these partial payments. If the manager 1 delegates the broker 2 to pay the ineligible portion, the NBSI system can allow the broker 2 to track that portion as a receivable from the manager 1.

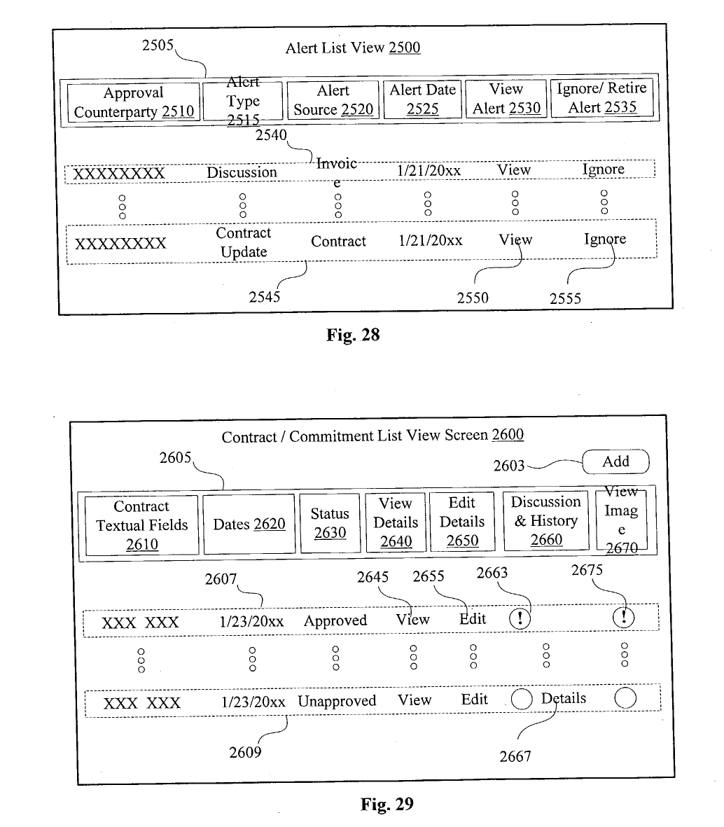

Referring now to FIG. 28, the alert list view 2500 is accessed either from the navigation bar's 2010 alerts button 2060 or from the alert presence indicator 2065 if workflow alerts are present as discussed in FIG. 23. This alert list view 2500, being tabular in nature, has a title bar 2505 with multiple columns. The first column would be the approval counterparty 2510 as defined in FIG. 24. The next column may be the type of alert 2515 indicating the activity or reason that is giving rise to the alert. Another informative column may be the alert source 2520 showing the type of entity that is giving rise to the alert such as the invoice, contract, counterparty, etc. Another informative column for the list view may be the alert date 2525 for when the alert began. Two possibilities of control columns are the view alert 2530 whereby a user can click on the view hyperlink 2550 to see the full details of the alert and the ignore/retire alert 2535. The user is able to maintain an alert line as an action item reminder until some needed step is completed; once this task is done, the user can click on the ignore hyperlink 2555 to make the action line disappear.

Referring now to FIG. 29, the contract list view 2600 is navigated to by first choosing the manage contracts button 2050 and then choosing which counterparty's contracts to view. Further narrowing of the list view is possible by choosing a list view for only a particular vendor, service or other criteria. The list view will preferably have textual columns 2610 such as the name of the commitment, service name, vendor name, counterparty name, etc. Additional columns will preferably display dates 2620 such as the start date and end date. The status of the contract 2630 is another column available to the list view. With online contract creation, unapproved contracts will pertain to contracts not yet ratified by the appropriate parties.

As in other list views, there is the view details column 2640 with its associated hyperlink 2645 leading to the contract detail screen 2680 discussed in FIG. 30 and the edit contract record column 2650 with its associated hyperlink 2655 leading to the edit contract screen. In a fashion similar to invoices, contracts may have discussions as displayed in a discussion column 2660. In such a column, there is the control object for each contract indicating the presence of open discussions 2663. Clicking on the control object leads to the open discussion. In this same column, there is the control object 2667 for closed, historical discussions associated with the contract. The list view may also offer a column 2670 for scanned images of the contract whereby each contract record has a control object 2675 indicating the presence or absence of a scanned image. Clicking on the control object 2675 will present the scanned image of the contract. In FIG. 29, contract record 2607 shows at a glance that there is a scanned image available and there is an open discussion with no historical, closed discussions. Contract record 2609 has no scanned image available to view and no open discussions but one or more closed discussions are present concerning this contract. If the commitment list view 2600 is used by the appropriate broker user, the add button 2603 will be visible to allow the user to add an additional commitment/contract for a particular manager, vendor, service combination.

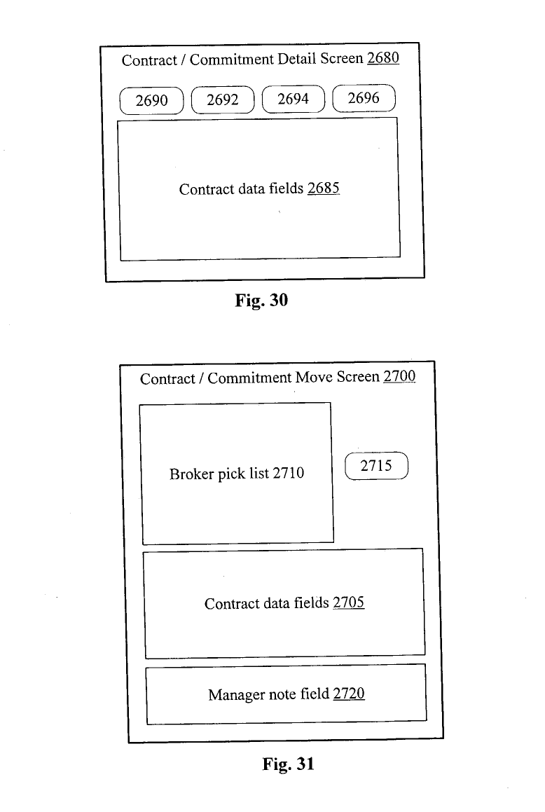

Referring now to FIG. 30, the contract detail screen presents the full detail of the contract/commitment record in the data field area 2685. From this screen the user is presented with one or multiple control buttons according to that user's role. All users may use the view contract list button 2690 to navigate back to the contract list screen 2600. The view invoices button 2692 presents the user with an invoice list view screen 2300 of all the invoices associated with that contract. If the user has the appropriate role, the edit contract/commitment button 2694 is available to present the user a contract edit screen similar in layout to the contract detail screen except that certain appropriate fields are editable. Depending on whether the user is a broker 2 or a manager 1 determines which fields are editable when in edit mode. The move contract button 2696 is only available to appropriate manager users. This button leads the manager user to the contract/commitment move screen 2700 in FIG. 31.

Referring to FIG. 31, the contract/commitment move screen 2700 is a means for a manager 1 to indicate a desire to transfer a contract and the associated invoices from one broker 2 to another. The manager 1 is presented with a picklist 2710 of the brokers available as recipients of the contract. Once a broker is selected, the manager may also enter a note in the available field 2720 as to the reasons for movement. As in the contract detail screen 2680, the contract data fields 2705 are available for viewing. By clicking on the submit button 2715, skeletal details of the contract being moved are sent as an alert to the recipient broker 2. From the alert list view the broker can navigate to the detail view via the hyperlink 2550. Within this detail view of the alert, the broker 2 may reject or accept the incoming contract. If online contract creation is available for this vendor, the existing contract can be retained with an addendum noting the changed broker. With tri-party confirmation between the manager 1, broker 2, and vendor 3 the contract can be negotiated online. Until the broker 2 has accepted the incoming contract, such a contract record would appear in the list view 2600 as unapproved in 2630. Additionally, the submit button 2715 triggers an alert to the broker 2 losing the contract to terminate the service with the vendor. Referring to the contract status field 2630 in the list view, such terminated commitments would appear as a status in the contract list view 2600 as well as the detail screen 2680.

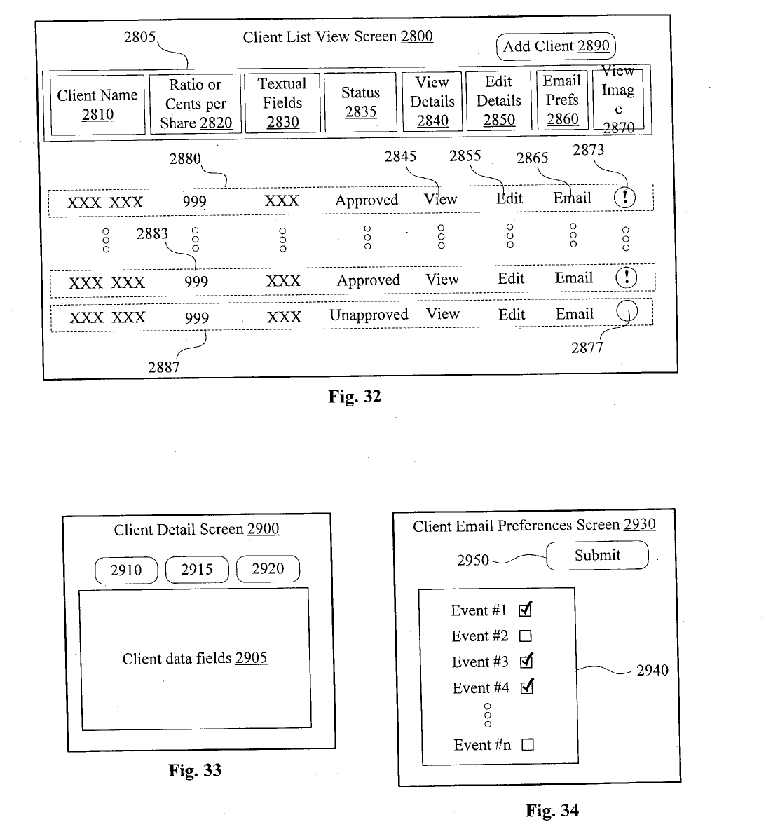

FIGS. 32 through 38 discuss the user interface for working with a broker's client records. These figures apply interchangeably to a broker's manager and plan sponsor clients. While specific field contents may vary according to whether a manager or plan sponsor, the overall screen flow and user interface methodologies are identical. Referring now to FIG. 32, the client list screen 2800 is available to broker users. From a broker's navigation bar 2010, a manage broker clients button is available. The broker then chooses whether to manage their manager or plan sponsor clients. This results in the list screen view 2800 of the selected client type.

Since the client list view 2800 is tabular, there is a title bar 2805 containing the titles for the various columns. The first column would logically be the client name 2810. Another column could optionally be the payment ratio, trade ratio or cents per share credit 2820 a client has allowing for balance computations necessary for client statement production. Additional textual columns 2830 such as contact name and address information are desirable fields in a client list view 2800. Another column displayed in the list view is the client status 2835. The reason for such a status field at the client level will be explained in subsequent figures.

Control columns are also present in the client list view 2800. Like many other list views, the view details 2840 column and the associated view hyperlink 2845 lead to the client detail screen described in FIG. 33. The edit details column 2850 and the associated edit hyperlink 2855 leads the user to the client edit screen for the client record. The view image column 2870 with the associated control object 2873 shows that an image is available for that client. This image reference is only a link to the image or multiple images residing at the master record preferably controlled and maintained by the manager or plan sponsor. For a manager 1 this image could represent documents such as a hedge fund charter or other legal documents. For a plan sponsor client, this image could be the plan sponsor letter or other legal documents. Another control column is email preferences 2860 with the associated hyperlink 2865 to customize these settings for each client as described in detail in FIG. 34.

Referring now to FIG. 33, the client detail screen 2900 is accessed via the view details hyperlink 2845 for each data record in the client list view 2800. The client detail screen 2900 has an area for all of the data fields of the client record 2905. Available to all broker users is a navigation button 2910 to return the user to the client list view 2800. According to the broker user's role, two additional buttons may be available for altering NBSI system data. The edit button 2915, leads the user to the client edit screen in the same function as the edit hyperlink 2855 performs for each data record in the client list view 2800. The client edit view has the same appearance as the client detail screen in FIG. 33 except that within the data field area 2905, many data fields are editable and changes can be effected via a submit button. The add commitment/contract button 2920 primarily pertains to a broker's manager clients however the analogous function for a broker's plan sponsor client would be to add the commission recapture agreement. This add commitment/contract button 2920 leads the user to the add commitment screen in the same fashion as button 2603 from the commitment list view 2600.

Referring now to FIG. 34, the client email preferences screen 2930. As mentioned in FIG. 32, each client's email preferences are accessed via the email hyperlink 2865. This screen is a means of setting alert thresholds to manager and plan clients based on system events. Within the event notification checklist area 2940, the various candidate events are listed with their associated checklists. If a broker wishes for a particular manager to be automatically notified by the NBSI system of a particular action, that event can be checked off. As a result, a system alert could be routed to the manager as a notification or action item. Alternatively, for certain events, the manager client may receive an email. Examples of events that are candidates for this function are invoices scheduled for payment by the broker 2 without the approval of the manager 1, expiring contracts, modified contract information by the broker 2, new contracts/commitments added by the broker 2, etc. Once the correct events are checked off for notification by the system, the broker user sets this information via the submit button 2950.

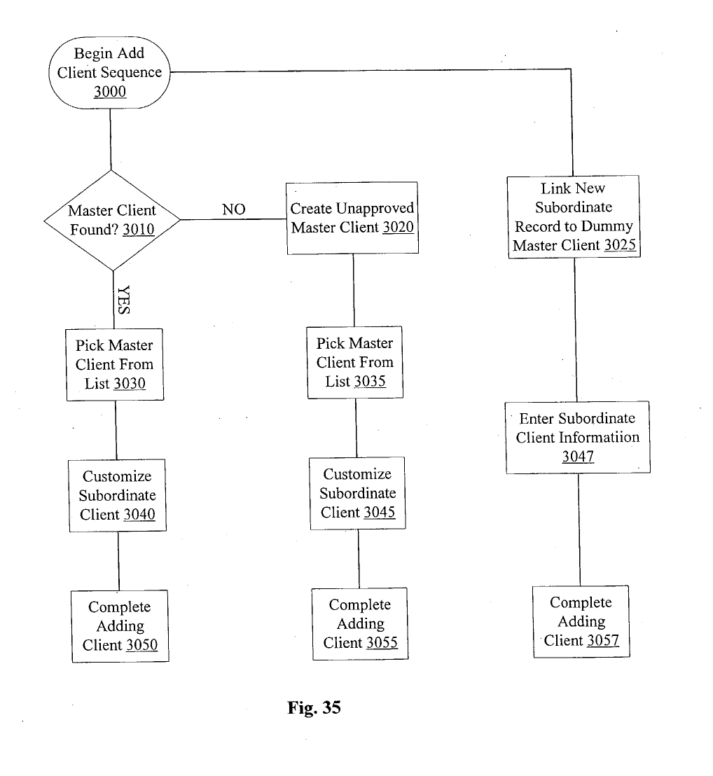

Referring again to FIG. 32, the client list view 2800 does not display the actual master record of the manager or plan sponsor client. Instead, this list view displays a subordinate record maintained in a separate database table. It is these subordinate manager and plan sponsor records that the broker is actually working with from their workspace. By virtue of these subordinate records being linked to master manager and plan sponsor records, the managers and plan sponsors are allowed the critical multi-broker views from their respective workspaces. The add client button 2890 leads to a mechanism, described in FIGS. 35 through 38, for providing the broker workspace with the client listings needed for viewing and maintaining their workflow while maintaining this linkage to the manager and plan sponsor master tables.

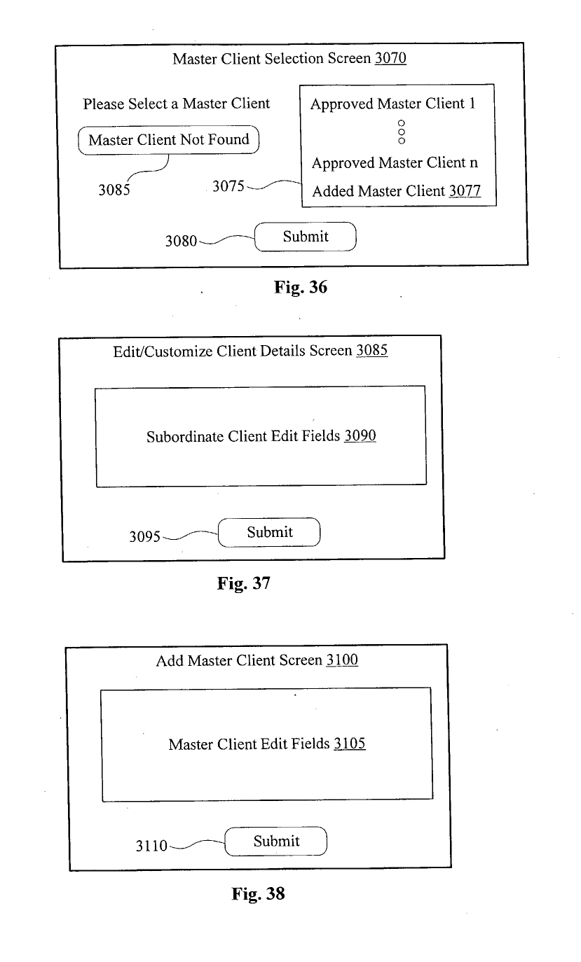

Once the add client button 2890 is selected, the flowchart on FIG. 35 depicts the steps and decision process used to create a new client listing as shown in 2800. The master client selection screen in FIG. 36 is used to accomplish the steps 3010, 3030 and 3035 in the flowchart of FIG. 35. Following the initiation of the add sequence 3000, the user at the broker 2 or personnel at the NBSI 5 arrive at the master client selection screen 3070 illustrated in FIG. 36. The user is presented with a picklist 3075 of available master clients within the NBSI system. These would only be those master clients that have been verified by the NBSI personnel to be a valid record and not also a duplicate of another record. If the desired master client is not found in the picklist 3075, the user can then select the master client not found button 3085. Within the flowchart of FIG. 35, the decision step 3010 of whether the master client exists is accomplished.

Assuming that the master client is found in the picklist 3075, it is selected and the submit button 3080 leads to the completion of the master client pick of 3030 in the process. If the master client is not found in the picklist 3075, and the not found button 3085 is selected, the create unapproved master client process 3020 is invoked as illustrated in FIG. 38. The add master client screen 3100 allows the user to create an unapproved master client record. This screen has an area for the edit fields 3105 whereby an adding user enters the relevant information for this client. Following completion of this information, the submit button 3110 is selected to write a new master client record. Returning to FIG. 36, within the picklist 3075, available within the picklist only to this broker the newly added master client record 3077 is available for selection. This allows the user to accomplish step 3035 within the flowchart by selecting the submit button 3080 from this point.

Following the selection of a master client either in step 3030 or 3035, the user is led to FIG. 37 whereby certain information from the master client record is written to edit fields within the subordinate client field area 3090. This gives the broker the opportunity to enter information for their subordinate client record specific to their business such as certain addresses, contact names and even varying client names. Once done, the submit button is selected 3095 leading to the accomplishment of steps 3040 and 3045 in FIG. 35. As such a broker may have multiple instances of a certain master client such as a manager for different purposes (e.g., domestic equity, fixed income, international equity, etc.). However many instances a broker has of a master client for their own purposes does not interfere with the master client's ability to have a consolidated view of that broker's activity from their workspace.

Returning to the client list view screen 2800 in FIG. 32, the box 2883 could represent the penultimate data record added from an approved master client. As such, the status column 2835 for the record would be shown as approved and, if the master client had a scanned legal document for display, the control object in the view image column 2870 would indicate this. Were a subordinate record added from an unapproved client following step 3020 in FIG. 35, the subordinate client record as represented by 2887 would indicate the client as being unapproved until the master linkage was approved. Additionally, there could be no scanned document at the master record for viewing as indicated by the empty image indicator 2877.

If the broker user community were resistant to creating their subordinate clients via the process depicted in FIG. 35, it would be due to the display of the master client picklist 3075 in FIG. 36 necessary for step 3010. The charge would be that this picklist presents a broker's client list for shared viewing by other brokers. The avoidance by the broker user of step 3010 is possible by a substitution of step 3025 whereby all added subordinate client records by the broker user are linked to a dummy master client for proper linkage later to the proper master client record by the NBSI personnel. This would lead to the elimination of the screens in FIGS. 36 and 38 to the broker user. The subordinate client information would be entered in FIG. 37 to accomplish step 3047.

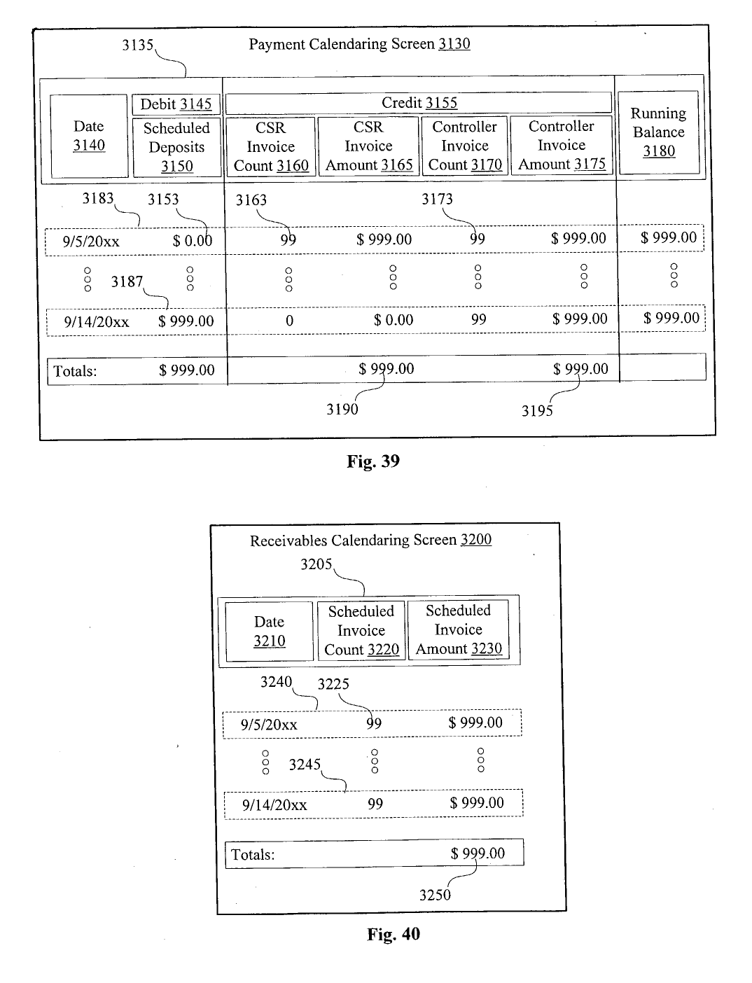

Referring now to FIG. 39, the payment calendaring screen 3130 is available to the controller user at the broker 2 to assist in final payment scheduling. As a tabular view, there is a title bar 3135 with data records below as represented by 3183 and 3187 representing the first and last data records respectively in such a list view. In the payment workflow, an invoice is scheduled for payment first by the broker's customer service representative and finally by the broker's controller role. In the credit section 3155 of the columns, scheduled invoices are grouped by what date they are scheduled for payment first by the customer service representative and then by the controller.

Invoices scheduled to be paid on a certain date as indicated in the date column 3140 by the customer service representative (CSR) are grouped and displayed by the count of these invoices 3160 as well as the total amount of these invoices 3165. The count of these invoices for that date is a hyperlink 3163 leading to an invoice list view 2300 for these selected invoices. The controller has the ability to either accept the scheduled payment date as set by the CSR or enter a different date. The controller can check the different approve boxes 2354 and select the submit button 2358 to accept the CSR scheduled date. In so doing, the list view in the payment calendaring screen 3130 would move the count and amount totals from the columns 3160 and 3165 to the columns 3170 and 3175 to reflect the controller's approval and scheduling. As such the totals represented 3190 and 3195 would reflect this movement. If the controller wishes to override the payment date set by the CSR, the approve boxes 2354 for the desired records would be set and the new payment date can be entered into the date box 2390 either directly into the edit field 2393 or via the calendaring widget called from a button 2397. This changed payment date is then entered by the controller via the submit button 2358. With a changed payment date entered by the controller, not only would the scheduled invoices move their count from columns 3160 and 3165 to 3170 and 3175 but these counts and totals would move to a different data record associated with a different date. For example the invoices represented under the CSR count 3160 and amount total 3165 fields in record 3183 could move to the controller count 3170 and amount total 3175 fields in record 3187. The count of invoices scheduled by the controller is a hyperlink 3173 leading to an invoice list view 2300 for those selected invoices.

Preferably the controller can schedule future debits as well as see past debits to the account in the form of transfers from other accounts or deposits. As such, these debits are shown in the deposits column 3150. Deposit amounts for a particular dates are hyperlinks 3153 leading to a list view of these individual debits. With both the debits and credits present for an account, preferably a running balance column 3180 can be computed to allow a controller to see the combined effects of invoice payment scheduling and debit scheduling on the balance.

Referring to FIG. 40, the receivables calendaring screen 3200 is available to the vendor workspace as a simplified version of the broker's payment calendaring screen. This screen is reached via the navigation buttons 2010 contained at the top of the screens that vary according to the type of organization using the NBSI system as well as the privileges of that particular user type. As such, invoice payments scheduled by broker controllers (and therefore finalized payment instructions) across the multiple brokers using the NBSI system can be viewed in this receivables calendaring screen 3200 in the same fashion as the brokers' more complex payment calendaring screen 3130. Therefore payments from the multiple brokers to a particular vendor on a particular date are grouped on that date record whereby the count of these invoices is presented in the count column 3220 and the sum total amounts of these invoices are presented in the amount column 3230. As such, a vendor can see how much they will receive or did receive on a particular date as shown by the date column 3210. The invoice count number is a hyperlink 3225 leading the vendor user to a list view of the invoices for that date. The list view does not contain the view hyperlinks 2345 available to broker and manager users preventing the vendor to see the invoice workflow dates and names. Within the invoice detail screen in FIG. 21, there are fields logging the person at the manager approving the invoice as well as the date of the manager user's approval. Additionally, the broker customer service representative's name, approval date and tentative scheduled payment date are visible in this detail screen as well as those of the broker controller's. Nevertheless, the invoice list view presented to the vendor contains sufficient information such as invoice number, check number, account number, broker name, manager name, service name, etc. Additionally, the scanned image of the vendor's invoice is available to the vendor. A search function is also available to the vendor to find a payment for a particular invoice or an invoice for a particular check number, etc.

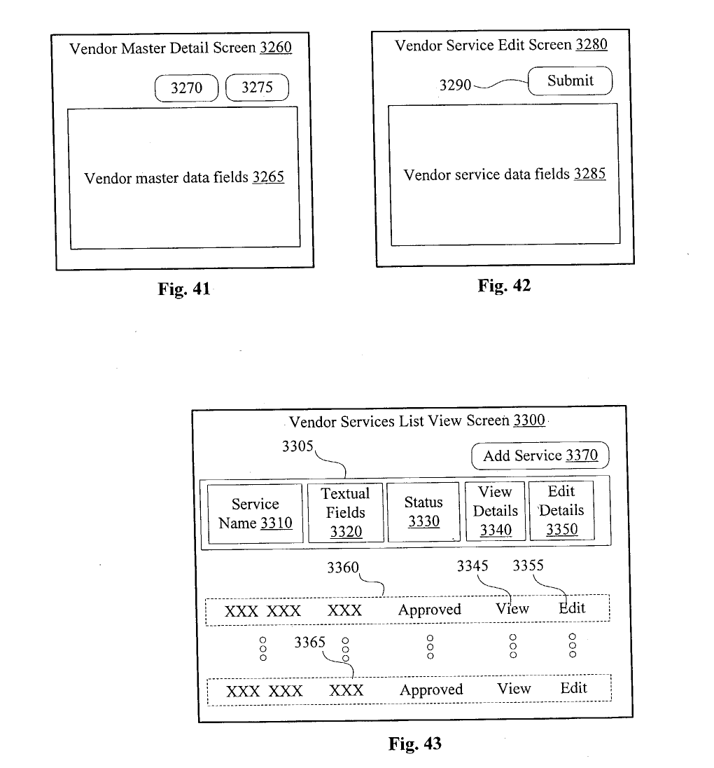

Referring now to FIG. 41, the vendor master detail screen 3260 displays the complete information for the vendor's master record within the data field's area 3265. Provided that the user has sufficient privileges, the edit vendor record button 3270 and the add service button 3275 will be present. The edit vendor record button 3270 will lead the user to a screen similar in layout to the detail screen 3260 and the date field area 3265 however with the fields being editable and changes able to be logged via a standard submit button. Such updates to the master record are real-time and are visible to all other users at the broker and manager working with that vendor. Regarding modification of the master record at the manager and broker, this capability is also available to appropriate user roles at that organization. Therefore managers and brokers changing their address and contact information can effect these changes to their master records. Using the alert system contained within the NBSI system, organizations having an involvement with the organization modifying their master record may preferably receive an alert notifying them of this change.

In FIG. 41, the other button available to the appropriate user is the add service button 3275. This leads the user to an add/edit screen for the service information as illustrated in FIG. 42. The service record fields are displayed as editable within the data fields area 3285 and the addition of the service record can be effected via the submit button 3290.

Referring to FIG. 43, the vendor services list view 3300 is available to the vendor user as a button within the screen navigation bar 2010 as a means to manage their services. Like all tabular views, there is a title area 3305 with one or multiple lines of listed services as represented by 3360 and 3365. The list view will logically have a column for the service name 3310, other textual fields 3320 and the status of the service 3330. Additionally, the list view will have two control columns to view the service details 3340 and edit the service record information 3350. There are view hyperlinks 3345 for each record leading to a detail view of the service as well as edit hyperlinks 2255 for each record that allow appropriate users to see the vendor service edit screen 3280 as illustrated in FIG. 42.

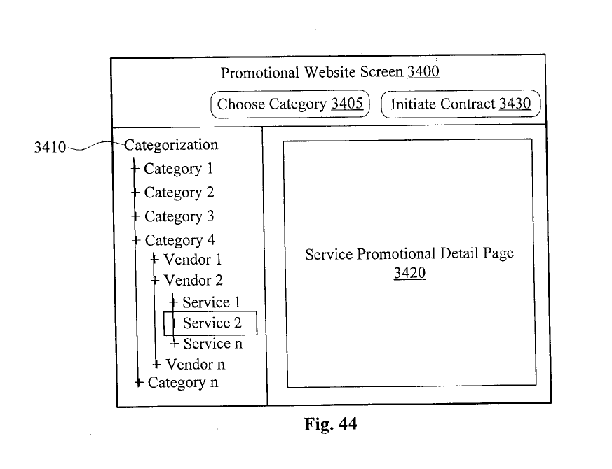

The information kept on these vendors and their one or multiple services can be classified in multiple fashions. Certain services can be classified by US SIC codes according to their industry focus. In 1998, the SEC issued suggested guideline categorizations for services offered within the soft dollar industry. The vendor of the services has the ability to maintain these different categorizations for their services offered to the soft dollar industry. Referring now to FIG. 44, the promotional website screen 3400 is available to all users within the NBSI system as a helpful guide to the services contained within the system. Within FIG. 44, the user can use a button or picklist 3405 to choose the type of categorization of the services such as SEC suggested guideline categories, alphabetical sort of vendor name, alphabetical sort of service name, etc. Once done, this categorization type is used to display a hierarchical listing of these services in the categorization window 3410 of the screen. By drilling down to the service, the individual service's details are displayed to the user in the detail section 3420 as well as the link to whatever website address the vendor wishes to direct the user to for further information. Depending on the user's level of privilege, there may be a button 3430 to allow the user to initiate a contract for that service. This would direct the user to subsequent pages to determine the desired counterparty and trigger the NBSI system to generate alerts to the appropriate parties to ratify and put into effect such a contract. This contract initiation process may also involve the use of vendor supplied contract templates whereby questions and data supplied by the initiator are used to populate the contract “boilerplate” and, with use of electronic signatures, create a legal contract online between the three involved parties: manager 1, broker 2, and vendor 3.

1. A computer program comprising program code for implementing steps of a process when said program is run a computer system, said process being one for managing payments to sellers by obligors and providing for the automated sharing and updating of data, acceptance and management of approvals, via interconnected computers and computer terminals, said steps comprising:
presenting, at a user terminal, contract data, stored on a computer data store, at least partially defining a sales contract between sellers and obligors;
presenting, at a user terminal, invoice data, stored on a computer data store, reflecting transactions between said sellers and said obligors;
prompting for and accepting, at a user terminal configured to permit access to a first obligor, an offer command to present terms defined by a first sales contract defined in said contract data said first contract being one between a first seller and said first obligor to a second seller;
prompting for and accepting, at a user terminal configured for access by said second seller, an acceptance command to accept said terms;
modifying said contract data, stored on a computer data store, such that said terms correspond to a contract between said first obligor and said second seller responsively to said first and second steps of accepting and storing a result of said step of modifying on a data store.

2. A computer implemented process as defined in claim 1, said steps further comprising:
prompting for and accepting, at a user terminal, a modify command prior to either of said first and second steps of accepting to modify terms of said first sales contract such that said terms identified in said first step of accepting include said modifications.

3. A computer implemented process as defined in claim 2, said steps further comprising:
prompting for and accepting, at a user terminal, an invoice command to store invoice data of said second seller in a computer readable data store;
prompting for and accepting, at a user terminal configured to permit access to said first obligor, a payment command to pay invoices corresponding to said invoice data and generating a payment command to automatically pay said invoice responsively thereto.

4. A computer implemented process as defined in claim 1, wherein said steps of presenting occur at terminals of a network.

5. A computer implemented process as defined in claim 1, wherein said obligors include securities brokers.

6. A computer implemented process as defined in claim 1, wherein said sellers include service vendors.

7. A computer implemented process as defined in claim 1, wherein said sellers include providers of market research services paid for, at least in part, by soft dollars.

8. A computer implemented process as defined in claim 1, wherein said obligors include securities brokers and said sellers include providers of market research services paid for, at least in part, by soft dollars.

9. A computer implemented process as defined in claim 1, said steps further comprising prompting for and accepting, at a user terminal configured for access by a beneficiary, an approve command of a product or service of said second seller to pay said invoices, said payment command being further responsive to said approve command.

10. A computer implemented process as defined in claim 9, wherein said beneficiary is a fund manager.

11. A computer program comprising program code for implementing steps of a process when said program is run a computer system, said process being one for managing payments to sellers by obligors and providing for the automated sharing and updating of data, acceptance and management of approvals, via interconnected computers and computer terminals, said steps comprising:
inputting detail invoice data reflecting transactions between said sellers and said obligors data from sellers and storing said invoice data in a computer readable data store;
presenting, at a user terminal, display invoice data responsive to said detail invoice data;
presenting, at a user terminal configured to provide access to said first obligor, selected display invoice data relating to said invoices and prompting for and accepting, at a user terminal configured to permit access to said first obligor, a first command indicating approval to pay one or more of said invoices;
prompting for and accepting, at a user terminal, selection commands to select payable invoices of said invoices;
prompting for and accepting, at a user terminal, payment commands to pay selected ones of said invoices;
prompting for and accepting, at a user terminal, challenge data effective to block payment of said selected ones of said invoices;
said display invoice data including high level group data resulting from a first grouping of invoices, said high level group data further including challenge display data responsive to said challenge data.

12. A computer implemented process as defined in claim 11, wherein said step of presenting selected display invoice data includes generating a list including high level grouping data and lower level detail data.

13. A computer implemented process as defined in claim 11, wherein said step of presenting selected display invoice data includes generating a list including high level grouping data and lower level detail data, said lower level detail data including further invoice data including a graphical image of a paper invoice displayed on a screen.

14. A computer implemented process as defined in claim 11, wherein said high level grouping data are grouped by approval status, said approval status including data responsive to said first and second steps of accepting.

15. A computer implemented process as defined in claim 11, wherein said high level grouping data are grouped by approval status, said approval status including data responsive to said third step of accepting.

16. A computer implemented process as defined in claim 11, wherein said high level grouping data are grouped by approval status, said approval status including data responsive to said third step of accepting.

17. A computer implemented process as defined in claim 16, wherein said high level grouping data are grouped by approval status, said approval status including data responsive to said third step of accepting.

18. A computer program comprising program code for implementing steps of a process when said program is run a computer system, said process being one for managing payments to sellers by obligors, said steps comprising:
inputting detail invoice data reflecting transactions between said sellers and said obligors data from sellers and storing said invoice data in a computer readable data store;
presenting, at a user terminal, display invoice data responsive to said detail invoice data;
presenting, at a user terminal configured to provide access to said first obligor, selected display invoice data relating to said invoices and prompting for and accepting, at a user terminal configured to permit access to said first obligor, a first command indicating approval to pay one or more of said invoices;
prompting for and accepting, at a user terminal, selection commands to select payable invoices of said invoices;
prompting for and accepting, at a user terminal, payment commands to pay selected ones of said invoices;
said display invoice data including high level group data resulting from a first grouping of invoices, said high level group data further including accuracy verification data;
wherein said step of presenting selected display invoice data includes generating a list including high level grouping data and lower level detail data, said lower level detail data including further invoice data including said accuracy verification data.

19. A computer implemented process as defined in claim 18, wherein said accuracy verification data includes a graphical image of a paper invoice displayed on a screen.

20. A computer implemented process as defined in claim 19, wherein said high level grouping data are grouped by approval status, said approval status including data responsive to said first and second steps of accepting.

21. A computer implemented process as defined in claim 19, wherein said high level grouping data are grouped by approval status, said approval status including data responsive to said third step of accepting.

22. A computer implemented process as defined in claim 19, wherein said high level grouping data are grouped by approval status, said approval status including data responsive to said third step of accepting.

23. A computer implemented process as defined in claim 22, wherein said high level grouping data are grouped by approval status, said approval status including data responsive to said third step of accepting.

24. A computer program comprising program code for implementing steps of a process when said program is run a computer system, said process being one for managing payments to sellers by obligors and providing for the automated sharing and updating of data, acceptance and management of approvals, via interconnected computers and computer terminals, where payments are at least partly for the benefit of certain beneficiaries, said method being implemented on a server accessible for administration by a third party payment supervisor other than either of said sellers and obligors, said steps comprising:
(a) at a terminal configured for limited access by users including said service provider, inputting detail invoice data reflecting transactions between said sellers and said obligors data from sellers and storing said invoice data in a computer readable data store;
(b) at a terminal configured for limited access by users including at least one of said sellers, said obligors, and said beneficiaries, presenting, at a user terminal, display invoice data responsive to said detail invoice data;
(c) at a terminal configured for limited access by users including at least one of said sellers, said obligors, and said beneficiaries, presenting, at a user terminal configured to provide access to said first obligor, selected display invoice data relating to said invoices and prompting for and accepting, at a user terminal configured to permit access to said first obligor, a first command indicating approval to pay one or more of said invoices;
(d) at a terminal configured for limited access by users including at least one of said sellers, said obligors, and said beneficiaries, accepting selection commands to select payable invoices of said invoices;
(e) at a terminal configured for limited access by users including at least one of said sellers, said obligors, and said beneficiaries, accepting payment commands to pay selected ones of said invoices.

25. A computer implemented process as defined in claim 24, wherein step b is performed at a terminal configured for limited access by users including said beneficiaries.

26. A computer implemented process as defined in claim 24, wherein step c is performed at a terminal configured for limited access by users including said beneficiaries.

27. A computer implemented process as defined in claim 24, wherein step d is performed at a terminal configured for limited access by users including said beneficiaries.

28. A computer implemented process as defined in claim 24, wherein step e is performed at a terminal configured for limited access by users including said beneficiaries.

29. A computer implemented process as defined in claim 24, wherein at least one of said steps b, c, d, and e is performed at a terminal configured for limited access by users including said beneficiaries.

30. A computer implemented process as defined in claim 24, wherein at least one of said steps b, c, d, and e is performed at a terminal configured for limited access by users including said beneficiaries and also at respective terminals configured for limited access by users including said obligors and said sellers.

31. A computer implemented process as defined in claim 30, wherein said obligors include securities brokers.

32. A computer implemented process as defined in claim 30, wherein said beneficiaries include fund managers.

33. A computer implemented process as defined in claim 30, wherein said service provider is neither a securities broker nor a fund manager.

34. A computer implemented process as defined in claim 24, wherein said service provider is neither a securities broker nor a fund manager.
